(19) United States
(12) Patent Application Publication
(10) Pub. No.: US 2026/0122416 A1
(43) Pub. Date: Apr. 30, 2026

(54) MICROPHONE ASSEMBLY AND SYSTEM ADAPTED TO FORM CONTINUOUSLY VARIABLE POLAR PATTERNS

(71) Applicant: Logitech Europe S.A., Lausanne (CH)

(72) Inventors: Clayton Christopher WILLIAMSON, Moorpark, CA (US); Tzyy-Woei Richard SUNG, Los Angeles, CA (US); Darrell Robert HAYES, Westlake Village, CA (US); Sal Gregory GARCIA, Moorpark, CA (US); Aron Michael ROSENBERG, Lafayette, CA (US)

(21) Appl. No.: 18/957,340

(22) Filed: Nov. 22, 2024

Related U.S. Application Data
(63) Continuation-in-part of application No. 18/930,962, filed on Oct. 29, 2024.

(51) Int. Cl. H04R 3/00; H04R 1/40

(52) U.S. Cl. CPC H04R 3/005; H04R 1/406

(57) ABSTRACT

A first electrical signal is received from a first cardioid microphone capsule of a microphone assembly. The first cardioid microphone capsule is oriented to face in a first direction. A second electrical signal is received from a second cardioid microphone capsule of the microphone assembly. The second microphone capsule is oriented to face in a second direction that is opposite the first direction. A polar pattern is formed for the microphone assembly by converting the first electrical signal into a first audio signal and converting the second electrical signal into a second audio signal. A first weight is applied to the first audio signal and a second weight is applied to the second audio signal. The polar pattern is generated for the microphone assembly by summing the first audio signal and the second audio signal.

### CROSS-REFERENCE TO RELATED APPLICATIONS

This application is a continuation-in-part of co-pending U.S. patent application Ser. No. 18/930,962, filed Oct. 29, 2024, which is herein incorporated by reference.

### BACKGROUND

### Field

Embodiments of the present disclosure generally relate to a microphone assembly and a microphone system.

### Description of the Related Art

A polar pattern of a microphone defines the microphone's sensitivity to sounds arriving from different directions around the microphone. In many sound capture scenarios, the sounds include both desirable sounds to capture such as the voice of a person speaking into the microphone and also undesirable sounds to capture (i.e., noise) such as clicks from the person's keyboard or voices of other people that are not speaking into the microphone. Accordingly, the polar pattern of the microphone should be sensitive in arrival directions of the desirable sounds and insensitive in arrival directions of the noise.

Microphones are available that have different polar patterns such as patterns that are equally sensitive in all directions, patterns that are sensitive in the front and the back and insensitive from the sides, patterns that are only sensitive in the front, and other patterns. Some microphones even have multiple different/selectable polar patterns. Regardless of whether a microphone has one or many polar patterns, these patterns are pre-defined and fixed. However, arrival directions of the desirable sounds and arrival directions of the noise are not fixed and can change such that the arrival directions may not correspond to one of several available pre-defined polar patterns.

Therefore, there is a need for an improved microphone system that overcomes the deficiencies described above.

### SUMMARY

Embodiments of the disclosure provide a method that includes receiving a first electrical signal from a first cardioid microphone capsule of a microphone assembly. The first cardioid microphone capsule is oriented to face in a first direction. A second electrical signal is received from a second cardioid microphone capsule of the microphone assembly. In some embodiments, the second microphone capsule is oriented to face in a second direction that is opposite the first direction. A polar pattern is generated for the microphone assembly by converting the first electrical signal into a first audio signal and converting the second electrical signal into a second audio signal. A first weight is applied to the first audio signal to form a first weighed signal. A second weight is applied to the second audio signal to form a second weighted signal. The polar pattern is formed by summing the first weighted signal and the second weighted signal.

Embodiments of the disclosure may also provide a microphone assembly that includes a first microphone capsule oriented to face in a first direction within a first plane and configured to generate a first audio signal. A second microphone capsule of the microphone assembly is oriented to face in a second direction that is opposite the first direction in a second plane and configured to generate a second audio signal. A third microphone capsule is oriented to face in the first direction within the first plane and configured to generate a third audio signal. A microphone control system is configured to generate multiple polar patterns for the microphone assembly based on at least one of the first audio signal, the second audio signal, or the third audio signal.

Embodiments of the disclosure may also provide a method that includes receiving a first electrical signal from a first cardioid microphone capsule of a microphone assembly, receiving a second electrical signal from a second cardioid microphone capsule of the microphone assembly, converting the first electrical signal into a first audio signal, converting the second electrical signal into a second audio signal, and generating, by use of components within the microphone assembly, a polar pattern. Generating the polar pattern comprises applying a first weight to the first audio signal to form a first weighted signal, applying a second weight to the second audio signal to form a second weighted signal, and summing the first weighted signal and the second weighted signal to form the polar pattern. In some embodiments, the first cardioid microphone capsule is oriented to face in a first direction and the second cardioid microphone capsule oriented to face in a second direction that is opposite the first direction.

Embodiments of the disclosure may also provide a method that includes receiving a first electrical signal from a first cardioid microphone capsule of a microphone assembly, receiving a second electrical signal from a second cardioid microphone capsule of the microphone assembly, converting the first electrical signal into a first audio signal, converting the second electrical signal into a second audio signal, and generating, by use of an external electronic device, a polar pattern. Generating the polar pattern comprises applying a first weight to the first audio signal to form a first weighted signal, applying a second weight to the second audio signal to form a second weighted signal, and summing the first weighted signal and the second weighted signal to form the polar pattern. In some embodiments, the first cardioid microphone capsule is oriented to face in a first direction and the second cardioid microphone capsule oriented to face in a second direction that is opposite the first direction.

Embodiments of the disclosure may also provide a microphone system that includes a first microphone capsule of a microphone assembly configured to generate a first electrical signal, a second microphone capsule of the microphone assembly configured to generate a second electrical signal, and a microphone control system that is configured to generate one or more polar patterns based on at least one of the first electrical signal or the second electrical signal. A first portion of the microphone control system comprises one or more analog-to-digital converters (ADCs) disposed within the microphone assembly, wherein the one or more ADCs are configured to generate a first audio signal based on the first electrical signal and a second audio signal based on the second electrical signal. A second portion of the microphone control system comprises one or more components of an external electronic device configured to digitally add the first and second audio signals to generate the one or more polar patterns.

Embodiments of the disclosure may also provide a microphone system that includes a first microphone capsule oriented to face in a first direction within a first plane and configured to generate a first electrical signal, a second microphone capsule oriented to face in a second direction and is configured to generate a second electrical signal, and a microphone control system that is configured to generate one or more polar patterns based on at least one of the first electrical signal or the second electrical signal. A first portion of the microphone control system includes one or more analog-to-digital converters (ADCs) disposed within a microphone assembly, wherein the one or more ADCs are configured to generate a first audio signal based on the first electrical signal and a second audio signal based on the second electrical signal. A second portion of the microphone control system comprises one or more components of an external electronic device configured to digitally add the first and second audio signals to generate the one or more polar patterns.

Embodiments of the disclosure may also provide a microphone system that includes a first microphone capsule oriented to face in a first direction within a first plane and configured to generate a first electrical signal, a second microphone capsule oriented to face in a second direction and is configured to generate a second electrical signal, and a microphone control system that is configured to generate one or more polar patterns based on at least one of the first electrical signal or the second electrical signal. A first portion of the microphone control system comprises one or more components selected from a group consisting of analog-to-digital converters (ADCs) and programmable-gain-amplifiers (PGAs) disposed within a microphone assembly, wherein the one or more components are configured to generate a first audio signal based on the first electrical signal and a second audio signal based on the second electrical signal. A second portion of the microphone control system comprises one or more components of an external electronic device configured to digitally add the first and second audio signals to generate the one or more polar patterns.

Embodiments of the disclosure may also provide a method comprising: receiving a first electrical signal from a first cardioid microphone capsule of a microphone assembly, the first cardioid microphone capsule oriented to face in a first direction; receiving a second electrical signal from a second cardioid microphone capsule of the microphone assembly, the second cardioid microphone capsule oriented to face in a second direction; converting the first electrical signal into a first audio signal; converting the second electrical signal into a second audio signal; and generating, by use of an external electronic device, a polar pattern. The generation of the polar pattern by the external electronic device may comprise: applying a first weight to the first audio signal to form a first weighted signal; applying a second weight to the second audio signal to form a second weighted signal; and summing the first weighted signal and the second weighted signal to form the polar pattern.

Embodiments of the disclosure may also provide a microphone system, comprising: a first microphone capsule of a microphone assembly configured to generate a first electrical signal; a second microphone capsule of the microphone assembly configured to generate a second electrical signal; and a microphone control system that is configured to generate one or more polar patterns based on at least one of the first electrical signal or the second electrical signal. A first portion of the microphone control system comprises one or more analog-to-digital converters (ADCs) disposed within the microphone assembly, wherein the one or more ADCs are configured to generate a first audio signal based on the first electrical signal and a second audio signal based on the second electrical signal; and a second portion of the microphone control system comprises one or more components of an external electronic device configured to digitally add the first and second audio signals to generate the one or more polar patterns. The first and second microphone capsules may comprise a cardioid microphone capsule.

Embodiments of the disclosure may also provide a microphone system, comprising: a first cardioid microphone capsule of a microphone assembly, wherein the first microphone capsule is oriented to face in a first direction and configured to generate a first electrical signal; a second cardioid microphone capsule oriented to face in a second direction and is configured to generate a second electrical signal; a third cardioid microphone capsule oriented to face in a third direction and is configured to generate a third electrical signal; and a microphone control system that is configured to generate one or more polar patterns based on at least one of the first electrical signal, the second electrical signal, and the third electrical signal. A first portion of the microphone control system comprises one or more analog-to-digital converters (ADCs) disposed within a microphone assembly, wherein the one or more ADCs are configured to generate a first audio signal based on the first electrical signal, a second audio signal based on the second electrical signal, and a third audio signal based on the third electrical signal; and a second portion of the microphone control system comprises one or more components of an external electronic device configured to digitally add the first, second, and third audio signals to generate the one or more polar patterns.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIGS. 1A, 1B, 1C, 1D, 1E, and 1F illustrate example polar patterns according to one or more embodiments.

FIG. 1G illustrates a representation of aspects of a process of generating polar patterns using a first polar pattern and a second polar pattern according to one or more embodiments.

FIG. 2A illustrates a side view of a microphone assembly with two opposite facing cardioid microphone capsules according to one or more embodiments.

FIG. 2B illustrates a plan view of a microphone assembly that includes the two opposite facing cardioid microphone capsules illustrated in FIG. 2A, according to one or more embodiments.

FIG. 2C illustrates an overlapping polar pattern generated by an overlay of the cardioid patterns generated by each of the two opposite facing cardioid microphone capsules described in relation to FIGS. 2A-2B, according to one or more embodiments.

FIG. 2D illustrates a user interface for a microphone having two opposite facing cardioid microphone capsules according to one or more embodiments.

FIG. 2E is a schematic view of a microphone control system for a microphone having two opposite facing cardioid microphone capsules according to one or more embodiments.

FIG. 3A illustrates a side view of a microphone assembly with a pair of opposite facing cardioid microphone capsules and an additional cardioid microphone capsule according to one or more embodiments.

FIG. 3B illustrates a plan view of the microphone assembly that includes the pair of opposite facing cardioid microphone capsules and the additional cardioid microphone capsule illustrated in FIG. 3A, according to one or more embodiments.

FIG. 3C illustrates an overlapping polar pattern generated by an overlay of cardioid patterns generated by each of the pair of opposite facing cardioid microphone capsules and a cardioid pattern generated by the additional cardioid microphone capsule according to one or more embodiments.

FIG. 3D illustrates a second order cardioid polar pattern according to one or more embodiments.

FIG. 3E illustrates a user interface for the microphone having the pair of opposite facing cardioid microphone capsules and the additional cardioid microphone capsule according to one or more embodiments.

FIG. 3F is a schematic view of a microphone control system for a microphone having a pair of opposite facing cardioid microphone capsules and an additional cardioid microphone capsule according to one or more embodiments.

FIG. 4A illustrates a side view of a microphone assembly with a first pair of opposite facing cardioid microphone capsules and a second pair of opposite facing cardioid microphone capsules according to one or more embodiments.

FIG. 4B illustrates a plan view of a microphone assembly with the first pair of opposite facing cardioid microphone capsules and the second pair of opposite facing cardioid microphone capsules illustrated in FIG. 4A, according to one or more embodiments.

FIG. 4C illustrates an overlapping polar pattern generated by an overlay of the cardioid patterns generated by each of the first pair of opposite facing cardioid microphone capsules and each of the second pair of opposite facing cardioid microphone capsules according to one or more embodiments.

FIG. 4D illustrates a second order hypercardioid polar pattern according to one or more embodiments.

FIG. 4E illustrates a second order supercardioid polar pattern according to one or more embodiments.

FIG. 4F illustrates a user interface for the microphone having the first pair of opposite facing cardioid microphone capsules and the second pair of opposite facing cardioid microphone capsules according to one or more embodiments.

FIG. 4G is a schematic view of a microphone control system for a microphone having a first pair of opposite facing cardioid microphone capsules and a second pair of opposite facing cardioid microphone capsules according to one or more embodiments.

FIG. 5A illustrates a side view of a microphone assembly with a forward facing stacked pair of capsules according to one or more embodiments.

FIG. 5B illustrates a plan view of the microphone assembly with the forward facing stacked pair of capsules illustrated in FIG. 5A, according to one or more embodiments.

FIG. 5C illustrates an overlapping polar pattern generated by an overlay of a polar pattern generated by each capsule in the forward facing stacked pair of capsules according to one or more embodiments.

FIG. 5D illustrates a user interface for a microphone having the forward facing stacked pair of capsules according to one or more embodiments.

FIG. 5E is a schematic view of a microphone control system for the microphone having the forward facing stacked pair of capsules according to one or more embodiments.

FIG. 6A illustrates a side view of a microphone assembly with a forward facing stacked pair of capsules and a side facing capsule according to one or more embodiments.

FIG. 6B illustrates a plan view of the microphone assembly with the forward facing stacked pair of capsules and the side facing capsule illustrated in FIG. 6A according to one or more embodiments.

FIG. 6C illustrates a representation of combinable polar patterns of each capsule in the forward facing stacked pair of capsules and a polar pattern generated by the side facing capsule according to one or more embodiments.

FIG. 6D illustrates a user interface for the microphone having a forward facing stacked pair of capsules and a side facing capsule according to one or more embodiments.

FIG. 6E is a schematic view of a microphone control system for a microphone having a forward facing stacked pair of capsules and a side facing capsule according to one or more embodiments.

FIG. 6F is a schematic view of an alternative configuration of a microphone control system for a microphone having a forward facing stacked pair of capsules and a side facing capsule according to one or more embodiments.

FIG. 7A illustrates a front view of a microphone assembly with a first stacked pair of capsules and a second stacked pair of capsules according to one or more embodiments.

FIG. 7B illustrates a plan view of the microphone assembly with the first stacked pair of capsules and the second stacked pair of capsules illustrated in FIG. 7A according to one or more embodiments.

FIG. 7C illustrates an overlapping polar pattern generated by an overlay of a polar pattern generated by each of the first stacked pair of capsules and a polar pattern generated by each of the second stacked pair of capsules according to one or more embodiments.

FIG. 7D illustrates a user interface for a microphone having the first stacked pair of capsules and the second stacked pair of capsules according to one or more embodiments.

FIG. 7E is a schematic view of a microphone control system for the microphone having the first stacked pair of capsules and the second stacked pair of capsules according to one or more embodiments.

FIG. 8A illustrates a side view of a microphone assembly with two pairs of opposite facing cardioid microphone capsules according to one or more embodiments.

FIG. 8B illustrates a plan view of the microphone assembly with two pairs of opposite facing cardioid microphone capsules according to one or more embodiments.

FIG. 8C illustrates a representation of polar patterns of two pairs of opposite facing cardioid microphone capsules according to one or more embodiments.

FIG. 9 is a process flow diagram illustrating a method for generating a polar pattern for a microphone assembly according to one or more embodiments.

FIG. 10 is a schematic diagram illustrating a microphone control system according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to a microphone assembly that includes microphone capsules. A first microphone capsule of the microphone capsules is oriented to face in a first direction and has a first polar pattern. The first polar pattern defines sensitivity of the first microphone capsule to sounds arriving from different directions around the first microphone capsule relative to the first direction. A second microphone capsule of the microphone capsules is oriented to face in a second direction and has a second polar pattern. The second polar pattern defines sensitivity of the second microphone capsule to sounds arriving from different directions around the second microphone capsule relative to the second direction.

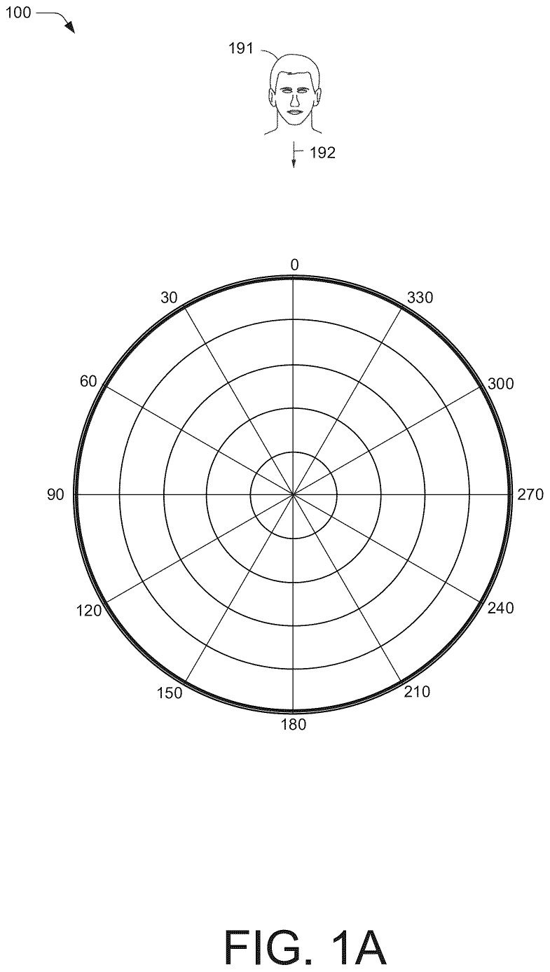

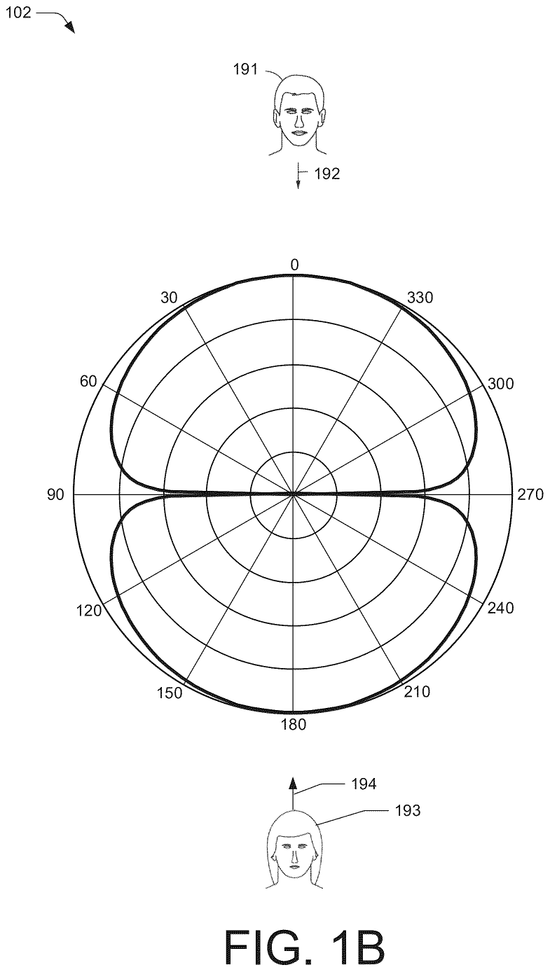

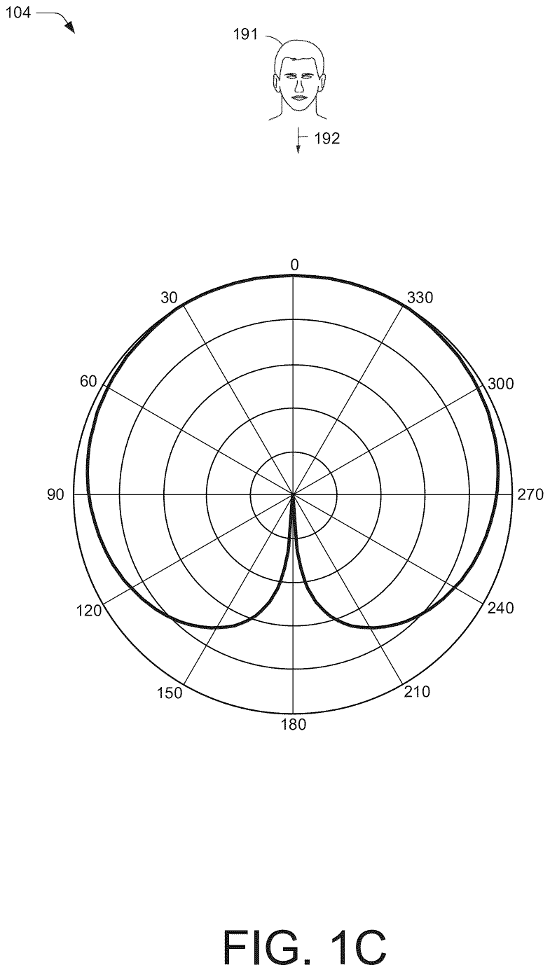

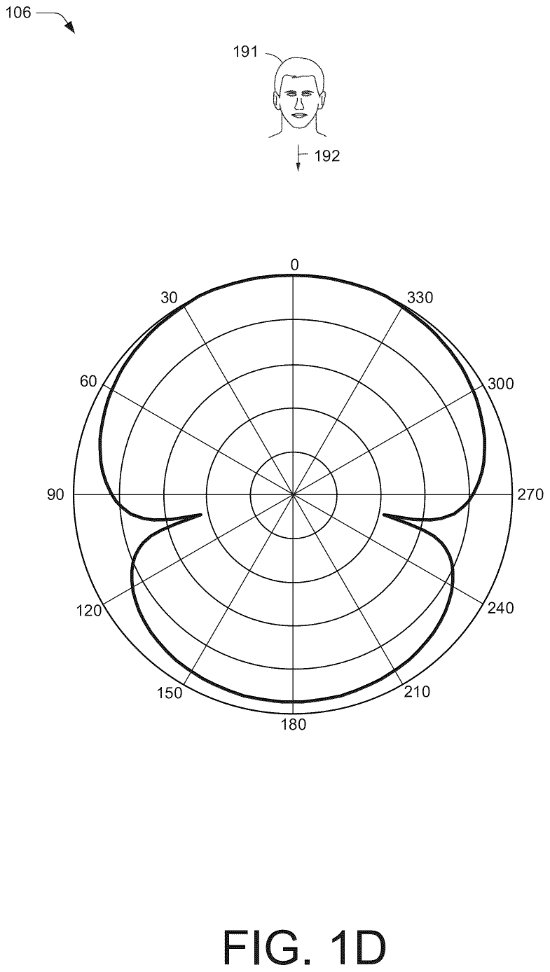

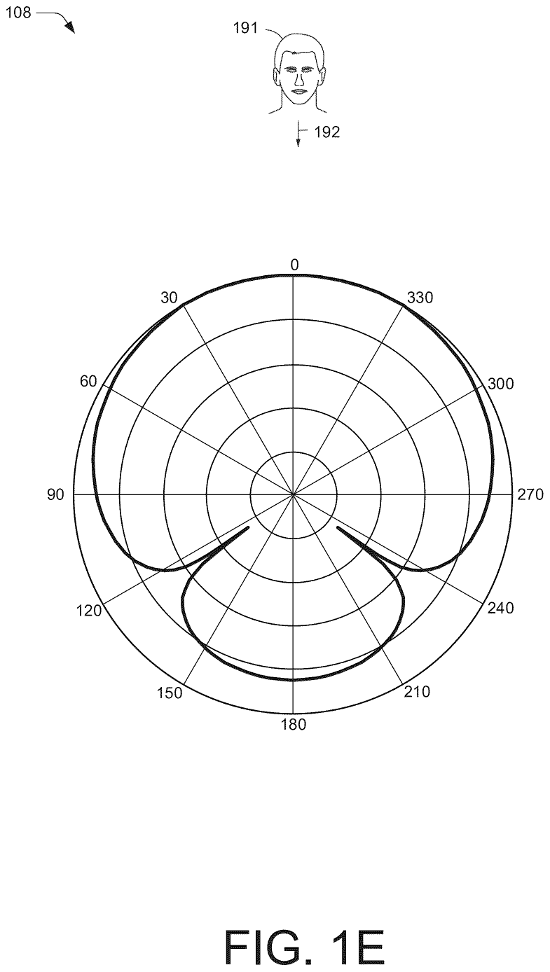

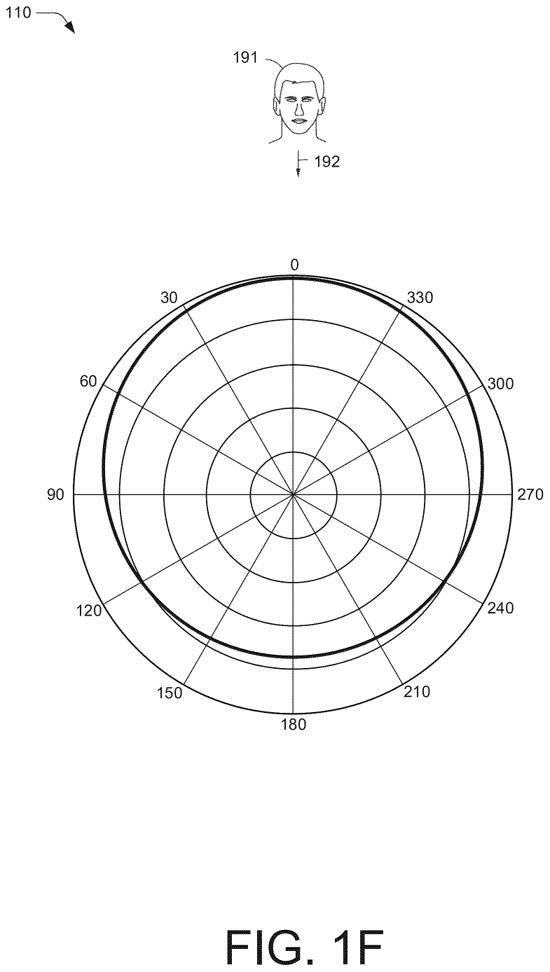

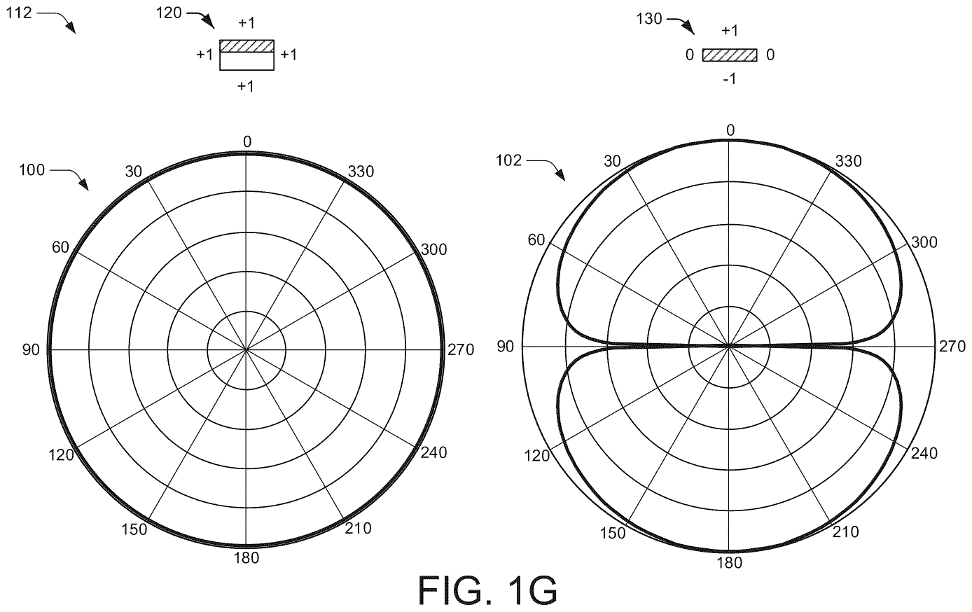

It has been found that by applying weights to one or both of the first and second polar patterns, adding the first and second polar patterns or subtracting one of the first and second polar patterns from the other, many different combined polar pattern shapes can be generated for the microphone assembly which allows the noise rejection characteristics created by the combined polar patterns to be customized and/or adjusted. For example, if the first and second microphone capsules are cardioid microphone capsules and if the second direction is opposite from the first direction, then a figure eight polar pattern (e.g., FIG. 1B) can be generated for the microphone assembly by subtracting the second polar pattern from the first polar pattern. Notably, the many different polar pattern shapes can be generated within the microphone assembly (e.g., within a microphone) and without requiring external digital signal processing and the corresponding dedicated computational/processing resources.

In some embodiments, the microphone assembly includes a third microphone capsule or a fourth microphone capsule. In these embodiments, multi-channel and stereo polar patterns can be generated for the microphone assembly. By adjusting weights and adding/subtracting polar patterns, the polar pattern for the microphone assembly can be adjusted continuously and changed to account for changes in arrival directions of desirable sounds and/or arrival directions of noise. The stereo polar patterns can be generated and the polar pattern for the microphone assembly may be continuously adjusted with minimal processing which is performed within the microphone assembly (e.g., within the microphone) and without backend digital signal processing.

The following disclosure includes embodiments that can form configurable polar patterns to meet a user's need versus fixed polar patterns commonly found in conventional microphone designs. An advantage of the microphone system(s) disclosed herein includes the reduction in noise collected by a microphone due to the ability to generate polar patterns that are not sensitive to sounds received in arrival directions that are not in the desired primary sound collection direction. A further advantage of the microphone system(s) disclosed herein includes the ability to generate continuously adjustable polar patterns for the microphone internally within the microphone using minimal processing/computational resources.

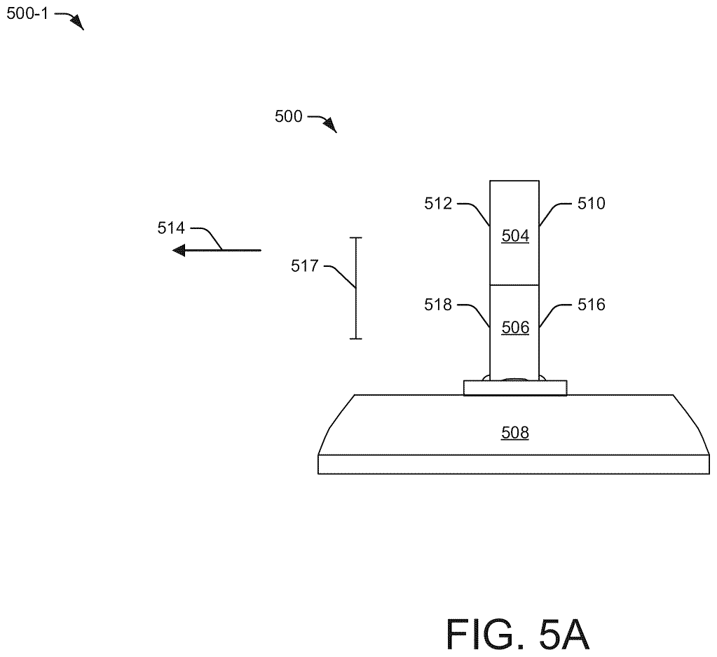

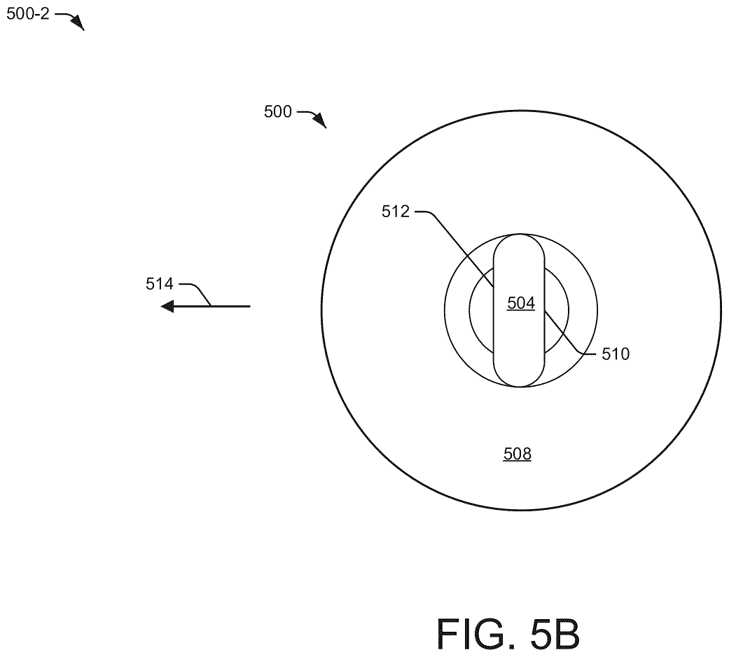

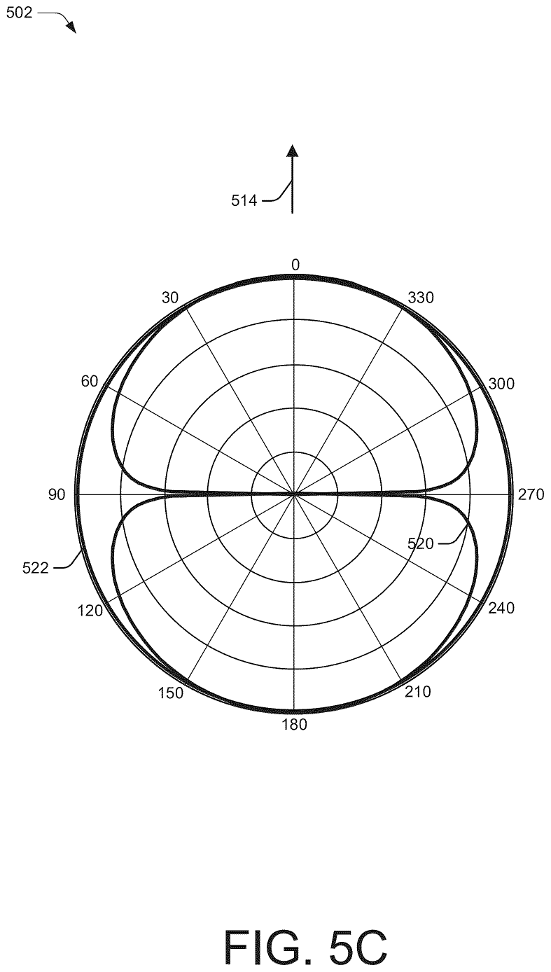

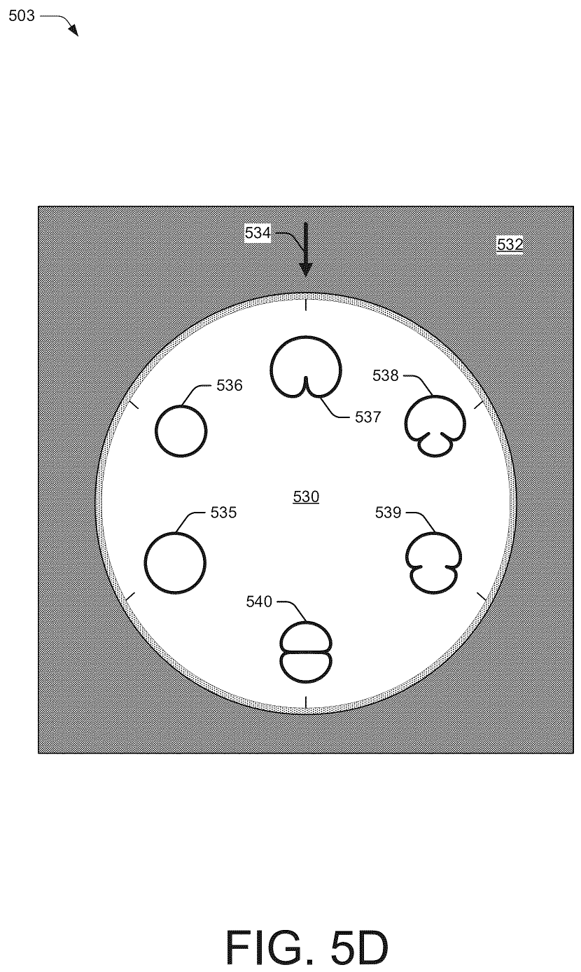

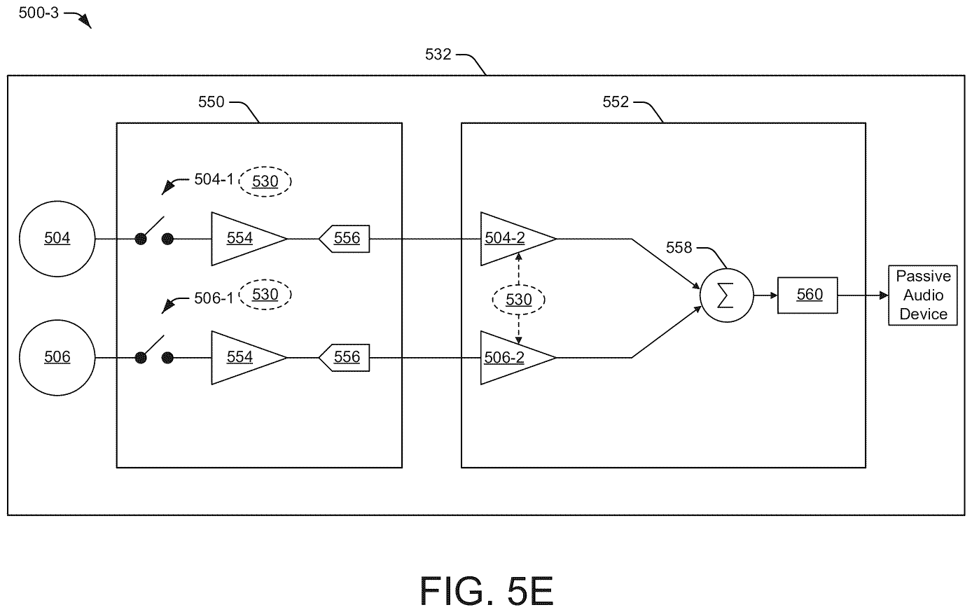

FIGS. 1A, 1B, 1C, 1D, 1E, and 1F illustrate example polar patterns that can be generated by a microphone capsule or a combination of outputs received from two or more microphone capsules according to one or more embodiments. FIG. 1A illustrates an omnidirectional polar pattern 100. The dark line indicates sensitivity to sound arrival in directions indicated by the angles around the chart. The omnidirectional polar pattern 100 is can be generated by use of an omnidirectional microphone capsule (e.g., FIG. 5A), and the omnidirectional polar pattern 100 is independent of an orientation of the omnidirectional microphone capsule. For example, changing the orientation of the omnidirectional microphone capsule does not change the omnidirectional polar pattern 100 generated by the omnidirectional microphone capsule.

For ease of discussion purposes, it is assumed herein that a desired primary sound collection direction 192 for a microphone assembly is the zero degrees (0°) direction, and thus a user 191 speaking into the microphone assembly would be positioned to face the microphone assembly in the 0° direction. In general, a portion of a radial line extending from the center of the chart corresponds to increasing levels of sensitivity and thus a portion of a polar pattern (e.g., portion of a dark line) that is closer to the center corresponds to a minimum sensitivity (e.g., complete rejection of sound at the center) and a portion of a polar pattern that is closer to the edge of the polar pattern chart will have a maximum sensitivity. Typically, five equally spaced concentric circles positioned about the center of the chart are used to specify a 10 decibel (dB) attenuation or rejection of the received sound level as the polar pattern is positioned closer to the center of the chart from the outer edge. As shown, a microphone having the omnidirectional polar pattern 100 is equally sensitive to sounds regardless of arrival directions of the sounds. In some embodiments, the microphone having the omnidirectional polar pattern 100 may be advantageously used for group recordings with many sounds arriving in many directions such as a choir or an orchestra.

FIG. 1B illustrates a figure eight polar pattern 102. As shown, a microphone having the figure eight polar pattern 102 is sensitive to sounds arriving from the front (0 degrees) and the back (180 degrees) and insensitive to sounds arriving from the sides (90 degrees and 270 degrees). The figure eight polar pattern 102 is commonly generated by a figure eight microphone capsule (e.g., FIG. 5A). In the illustrated example, the figure eight microphone capsule is either oriented to face the user 191 or oriented to face a user 193. Regardless of whether the figure eight microphone capsule is facing the user 191 or the user 193, the figure eight polar pattern 102 is sensitive in the primary sound collection direction 192 (the 0° direction) and a primary sound collection direction 194 (a 180° direction). In one or more embodiments, the microphone having the figure eight polar pattern 102 can be advantageously used to collect sound from sources that are positioned 180° apart relative to the microphone assembly, as illustrated in FIG. 1B, such as for recording interviews or vocal duets.

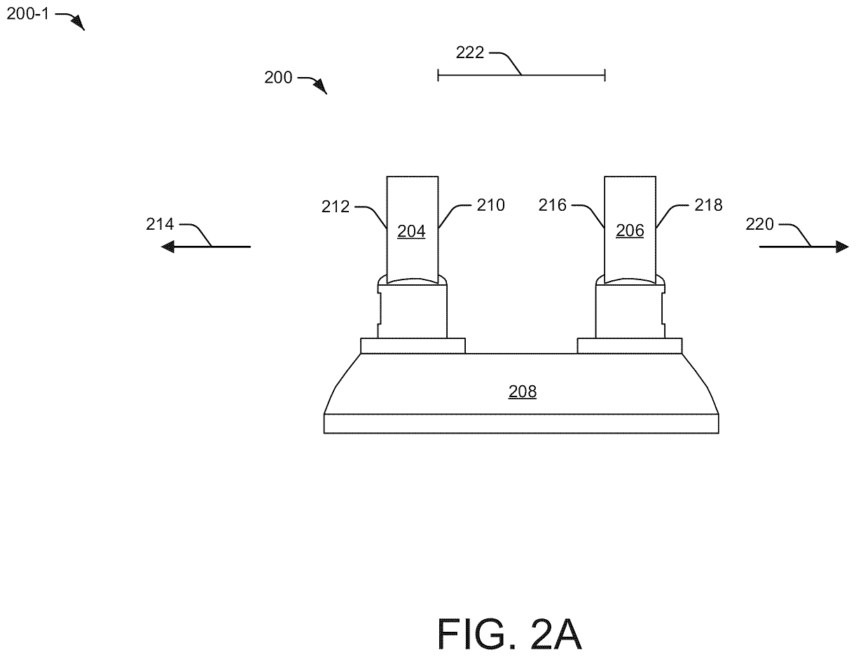

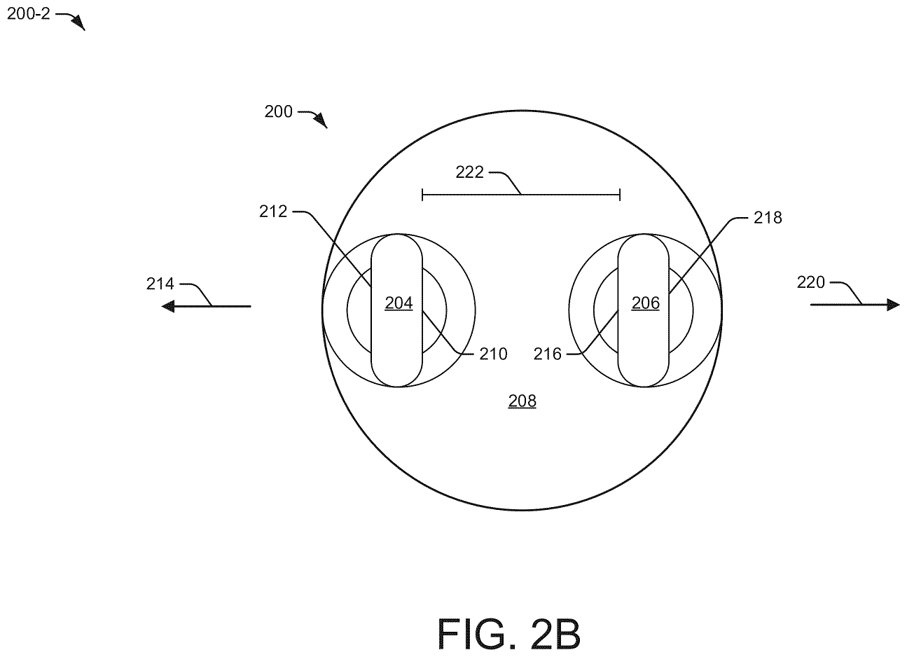

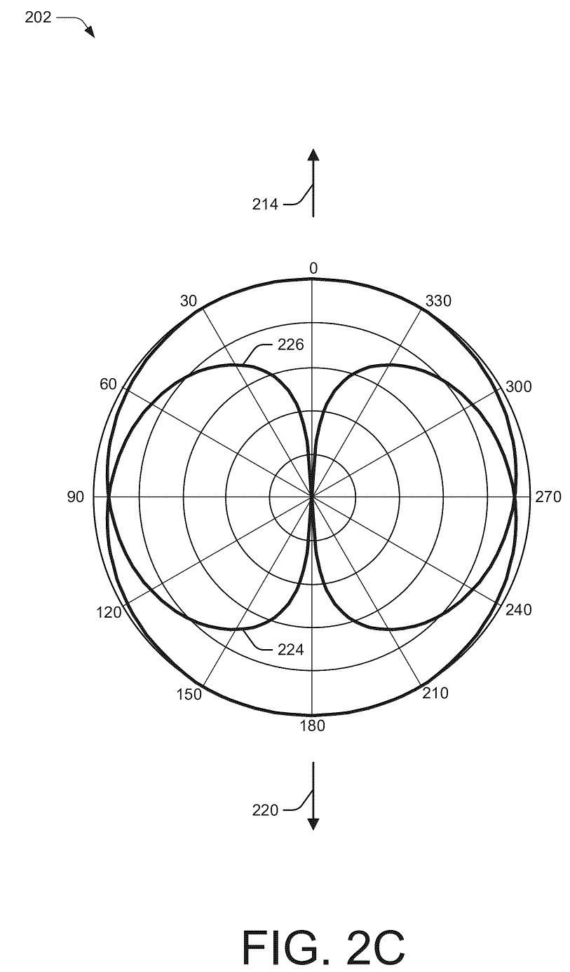

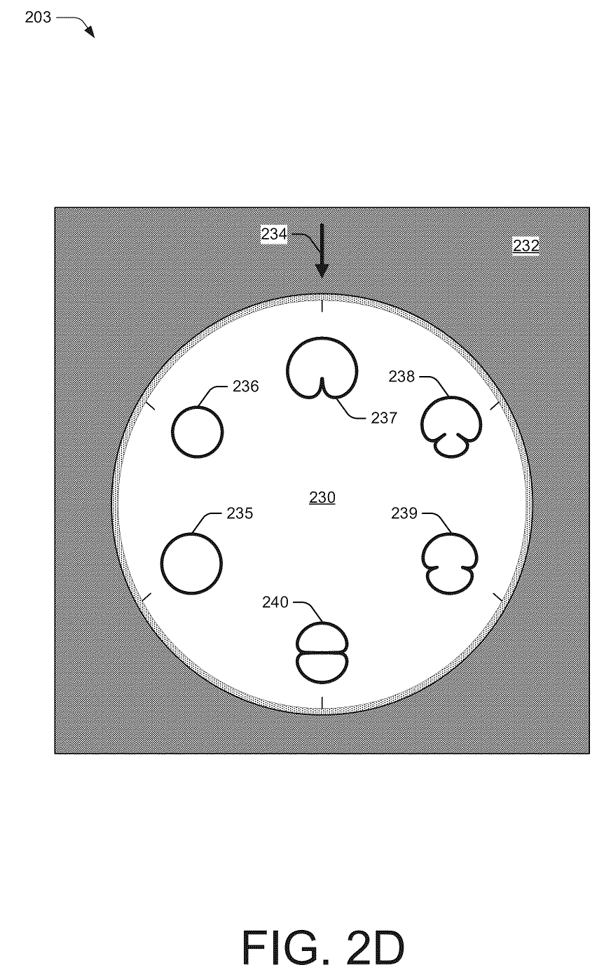

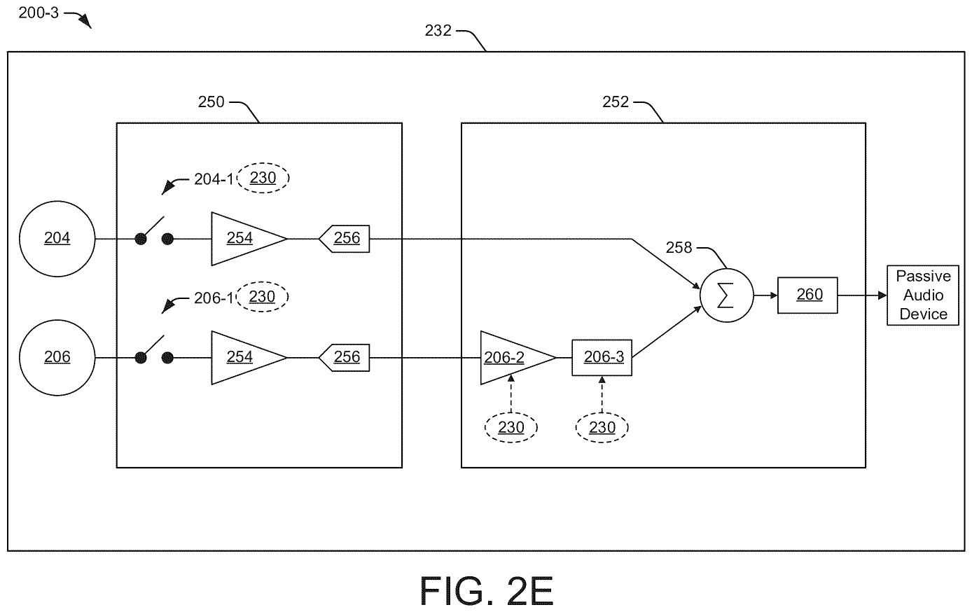

FIG. 1C illustrates a cardioid polar pattern 104. The cardioid polar pattern 104 is a commonly used polar pattern because the cardioid polar pattern 104 is directionally sensitive to sounds arriving from the front and attenuates sounds arriving from the back and sides. The cardioid polar pattern 104 can be generated by use of a cardioid microphone capsule (e.g., FIG. 2A). The cardioid polar pattern 104 generated by the cardioid microphone capsule can vary by the type and manufacturer of the cardioid microphone capsule. The cardioid polar pattern 104 generated by the cardioid microphone capsule may also vary from capsule to capsule within the same type of cardioid microphone capsule. In FIG. 1C, the cardioid microphone capsule is oriented to face the user 191. For instance, a microphone having the cardioid polar pattern 104 is sensitive to sounds arriving from the front (between about 60 degrees and about 300 degrees) and insensitive to sounds arriving from the back. In various embodiments, the microphone having the cardioid polar pattern 104 is advantageously used to collect sound from sources that are primarily positioned in the primary sound collection direction 192 (the 0° direction) relative to the microphone assembly, as illustrated in FIG. 1C, such as for recording solo vocals, single instruments, academic lectures provided from a professor, and presentations given by one presenter at a time.

FIG. 1D illustrates a hypercardioid polar pattern 106. In general, the hypercardioid polar pattern 106 has a narrower range of sensitivity to sounds arriving from the front and a greater insensitivity to sounds arriving from the sides than the cardioid polar pattern 104 and also a greater insensitivity to sounds arriving from the back than the figure eight pattern 102. The hypercardioid polar pattern 106 can be generated by use of a special hypercardioid microphone capsule such as a gradient condenser capsule or using an interference tube design. In the illustrated example, the hypercardioid microphone capsule is oriented to face the user 191. As shown in FIG. 1D, a microphone having the hypercardioid polar pattern 106 is sensitive to sounds arriving from the very front (between about 45 degrees and about 315 degrees) and insensitive to sounds arriving from the back and the sides. In some embodiments, the microphone having the hypercardioid polar pattern 106 can be advantageously used to collect sound from sources that are primarily positioned in the primary sound collection direction 192 (the 0° direction) relative to the microphone assembly and exclude noise sources that are positioned on the sides and back, such as for broadcasting, film and video production, and recording live performances (e.g., to isolate sounds from instruments and/or vocalists and reduce sounds from a stage or audience).

FIG. 1E illustrates a supercardioid polar pattern 108. Generally, the supercardioid polar pattern 108 has a similar sensitivity to sounds arriving from the front and a greater insensitivity to sounds arriving from the back than the cardioid polar pattern 104. The supercardioid polar pattern 108 also has a greater insensitivity to sounds arriving from the back than the figure eight polar pattern 102 and the hypercardioid polar pattern 106. In FIG. 1E, the supercardioid microphone capsule is oriented to face the user 191. A microphone having the supercardioid polar pattern 108 is sensitive to sounds arriving from the front (between about 45 degrees and about 315 degrees) and insensitive to sounds arriving from the back and the sides. In one or more embodiments, the microphone having the supercardioid polar pattern 108 may be advantageously used for podium speeches and recording individual instruments.

FIG. 1F illustrates a subcardioid polar pattern 110. As shown, the subcardioid polar pattern 110 has less sensitivity to sounds arriving from the back than the omnidirectional polar pattern 100 and more sensitivity to sounds arriving from the back than the cardioid polar pattern 104. The subcardioid polar pattern 110 can be generated by use of a subcardioid microphone capsule such as a capsule having multiple diaphragms. In the illustrated example, the subcardioid microphone capsule is oriented to face the user 191. A microphone having the subcardioid polar pattern 110 has similar sensitivity to sounds arriving from the front as the microphone having the cardioid polar pattern 104. In some embodiments, the microphone having the subcardioid polar pattern 110 may be advantageously used for multiple sound producing singers in a theater production and for recording wildlife sounds received from a broad number of sources.

FIG. 1G illustrates a representation 112 of a process of generating polar patterns by combining a first polar pattern and a second polar pattern according to one or more embodiments. As shown, the representation 112 includes the omnidirectional polar pattern 100 and the figure eight polar pattern 102. The representation 112 also includes an omnidirectional microphone capsule 120 having the omnidirectional polar pattern 100 and a figure eight microphone capsule 130 having the figure eight polar pattern 102. In one example in which the omnidirectional microphone capsule 120 includes a diaphragm and a casing such that a pressure of 1 unit arriving at any direction generates a pressure differential of +1 volt. In this example, the figure eight microphone capsule 130 has a diaphragm such that a pressure of 1 arriving at 0° generates a pressure differential of +1 volt, a pressure arriving at 90° does not generate a pressure differential (0 volts), a pressure arriving at 180° generates a pressure differential of −1 volt, and a pressure arriving at 270° does not generate a pressure differential (0 volts). In this example, summing the voltages generated at the arrival directions for the omnidirectional microphone capsule 120 and the figure eight microphone capsule 130 forms the cardioid polar pattern 104. At 0°, +1+1=2. At 90°, +1+0=1. At 180°, +1−1=0. At 270°, +1+0=1. Accordingly, the formed polar pattern is most sensitive to sounds arriving at 0°, less sensitive to sounds arriving at 90° and at 270°, and insensitive to sounds arriving at 180°.

Alternately or additionally, in another example in which a first weight W1 can be applied to an output from the omnidirectional microphone capsule 120, a second weight W2 may be applied to an output from the figure eight microphone capsule 130, and then the weighted outputs can be combined to form polar patterns. For example, if values of W1, W2 are 0, 1, respectively, then the figure eight polar pattern 102 is formed. If values of W1, W2 are 1, 0, respectively, then the omnidirectional polar pattern 100 is formed. If values of W1, W2 are 0.5, 0.5, respectively, then the cardioid polar pattern 104 is formed. If values of W1, W2 are 0.25, 0.75, respectively, then the hypercardioid polar pattern 106 is formed. If values of W1, W2 are 0.37, 0.63, respectively, then the supercardioid polar pattern 108 is formed.

FIG. 2A illustrates a side view 200-1 of a microphone assembly 200 with two opposite facing cardioid microphone capsules 204, 206 according to one or more embodiments. FIG. 2B illustrates a plan view 200-2 of the two opposite facing cardioid microphone capsules 204, 206 of the microphone assembly 200 according to one or more embodiments. In some embodiments, the microphone assembly 200 includes a first cardioid microphone capsule 204, a second cardioid microphone capsule 206, and a base 208. The first cardioid microphone capsule 204 and the second cardioid microphone capsule 206 are each configured to generate a cardioid type polar pattern that is similar to the polar pattern illustrated in FIG. 1C.

Since the first and second cardioid microphone capsules 204, 206 are the same type of microphone capsule (both cardioid), the first and second cardioid microphone capsules 204, 206 can be closely matched with respect to performance characteristics (e.g., amplitude and phase responses). For instance, the first and second cardioid microphone capsules 204, 206 may be selected from a group (e.g., a manufacturing lot/batch) of cardioid microphone capsules as having performance characteristics that are closely matched. As a result of the close matching, the first and second cardioid microphone capsules 204, 206 require less signal matching compensation than a pair of different types of microphone capsules such as a cardioid microphone capsule and a non-cardioid microphone capsule.

Another potential benefit of the first and second cardioid microphone capsules 204, 206 compared to the combination of different types of microphone capsules is that there is a relatively low probability of matching both amplitude and phase responses of combined different types microphone capsules, and thus the combination of different types of microphone capsules generally requires equalization prior to summing. However, if the first and second cardioid microphone capsules 204, 206 are easily matched in amplitude and phase responses the first and second cardioid microphone capsules 204, 206 do not need to be equalized prior to summing. This is beneficial because equalization is typically performed downstream of an A/D converter (e.g., on a digital signal) in order to perform the equalization efficiently. Since the first and second cardioid microphone capsules 204, 206 do not need to be equalized prior to summing, only one A/D converter is used for the first and second cardioid microphone capsules 204, 206 collectively, whereas when different types of microphone capsules are used each will require an A/D converter. Accordingly, the use of the first and second cardioid microphone capsules 204, 206 instead of the different types of microphone capsules reduces power consumption by minimizing the number of A/D converters, reduces device complexity, and also lowers manufacturing costs for the microphone assembly 200.

The first cardioid microphone capsule 204 is disposed on the base 208 and includes a backside 210 and a front face 212. In some embodiments, the first cardioid microphone capsule 204 is oriented to face in a first direction 214. The second cardioid microphone capsule 206 is also disposed on the base 208 and includes a backside 216 and a front face 218. In one or more embodiments, the second cardioid microphone capsule 206 is oriented to face in a second direction 220 that is opposite the first direction 214. As shown in FIG. 2A, the first and second cardioid microphone capsules 204, 206 are separated by a distance 222 that extends between the backsides 210 and 216 of the first cardioid microphone capsule 204 and the second cardioid microphone capsule 206, respectively. In some embodiments, the centerlines of the diaphragms of the first and second cardioid microphone capsules 204, 206 are parallel to each other in a third direction that is perpendicular to the first direction 214, if the first and second cardioid microphone capsules 204, 206 are at substantially the same vertical height, or the centerlines are even substantially collinear. The first and second cardioid microphone capsules 204, 206 may have the same vertical height (e.g., side-by-side) in a coplanar configuration. The first and second cardioid microphone capsules 204, 206 may have different vertical heights (e.g., stacked) in a coplanar configuration. In certain embodiments, properties and characteristics of the first and second cardioid microphone capsules 204, 206 may be tested and matched to form a desired noise rejection pattern (e.g., angularly balanced pattern) from the microphone assembly 200. As noted above, the first and second cardioid microphone capsules 204, 206 can be from the same manufacturing lot or manufacturing batch to match the properties and characteristics of the first and second cardioid microphone capsules 204, 206.

The distance 222 is representative of distances ranging from an ideal distance of “zero” to any distance greater than the ideal distance. In some embodiments, for operations involving first-order polar patterns, the distance 222 is set to the ideal distance of “zero.” As used herein, the term “first-order” polar pattern refers to a polar pattern that can be described mathematically with constants and coefficients from −1.0 to 1.0 and the cosine of an angle raised to the first power. As used herein, the term “second-order” polar pattern that includes the cosine of an angle raised to the second power.

For operations involving first-order polar patterns, the distance 222 should be relatively small and close to the ideal distance of “zero.” Notably, the distance 222 may be close to the ideal distance of “zero” if the first and second cardioid microphone capsules 204, 206 are coplanar. In some examples, the distance 222 may be less than about 25 percent of a highest sound wavelength intended to be captured by the first and second cardioid microphone capsules 204, 206. By way of example, at 20 kHz with a wavelength of 1.7 centimeters (cm), the distance 222 may be set to a value of less than about 0.425 cm.

For operations involving second-order polar patterns, the distance 222 is greater than the ideal distance of “zero.” For second-order polar patterns, it is believed that if the distance 222 is relatively small, then performance of the first and second cardioid microphone capsules 204, 206 may be less optimal at relatively low frequencies because a pressure difference between the first and second cardioid microphone capsules 204, 206 is also relatively small. With respect to forming second-order polar patterns, the performance of the first and second cardioid microphone capsules 204, 206 may be more optimal at relatively high frequencies if the distance 222 is relatively small.

Conversely, if the distance 222 is relatively large, then it is believed that performance of the first and second cardioid microphone capsules 204, 206 may be more optimal at relatively low frequencies because the pressure difference between the first and second cardioid microphone capsules 204, 206 is also relatively large. In examples in which the distance 222 is relatively large, the performance of the first and second cardioid microphone capsules 204, 206 may be less optimal at relatively high frequencies since the distance 222 could be greater than a corresponding sound wavelength which causes aliasing. Accordingly, for operations involving second-order polar patterns, it is believed that there is a tradeoff for the distance 222 at relatively low frequencies (e.g., a relatively large distance 222 corresponds to better performance) and at relatively high frequencies (e.g., a relatively small distance 222 corresponds to better performance).

FIG. 2C illustrates an overlapping polar pattern 202 generated by an overlay of the cardioid patterns generated by each of the two opposite facing cardioid microphone capsules 204, 206 according to one or more embodiments. As shown, the overlapping polar pattern 202 includes a first cardioid polar pattern 224 and a second cardioid polar pattern 226. The first cardioid polar pattern 224 corresponds to the polar pattern formed by the first cardioid microphone capsule 204 and is similar to or the same as the cardioid polar pattern 104. The second cardioid polar pattern 226 is also similar to or the same as the cardioid polar pattern 104 rotated by 180 degrees because the second direction 220 is rotated by 180 degrees relative to the first direction 214.

In one or more embodiments, by applying weights to (e.g., scaling) and/or inverting audio signals generated by the first and second cardioid microphone capsules 204, 206 based on the first and second cardioid polar patterns 224, 226, respectively, the weighted and/or inverted audio signals are combinable (e.g., summed) in a channel such that a desired polar pattern can be generated for the microphone assembly 200. An example of combining the audio signals generated by the first and second cardioid microphone capsules 204, 206 in a channel can include the following:

$$Microphone Assembly Polar Pattern 1 ( MAPP 1 ) = X * C 1 + Y * C 2 ,$$

where: C1 represents the audio signal generated by the first cardioid microphone capsule 204 based on the first cardioid polar pattern 224; C2 represents the audio signal generated by the second cardioid microphone capsule 206 based on the second cardioid polar pattern 226; X represents a first weight; and Y represents a second weight, where X and Y can vary from −1.0 to 1.0.

In some embodiments, the first weight X and/or the second weight Y can be less than zero or greater than zero. In one example, if the first cardioid polar pattern 224 and the second cardioid polar pattern 226 are weighted equally and summed in a channel, then the result generates a polar pattern that is similar to the omnidirectional polar pattern 100 (e.g., the overlapping polar pattern 202). Mathematically, if C1 represents the audio signal generated by the first cardioid microphone capsule 204 based on the first cardioid polar pattern 224 and C2 represents the audio signal generated by the second cardioid microphone capsule 206 based on the second cardioid polar pattern 226, then an omnidirectional polar pattern can be formed for the microphone assembly 200 (e.g., MAPP1=1.0*C1+1.0*C2).

Additionally, a cardioid polar pattern can be formed by making the first weight X equal to 1.0 and the second weight Y equal to zero (e.g., MAPP1=1.0*C1). In some embodiments, a supercardioid polar pattern can be formed by making the first weight X equal to 1.0, and making the second weight Y a negative (inverted) fraction (e.g., MAPP1=1.0*C1−0.25*C2). In various embodiments, a supercardioid polar pattern can be formed when −1<Y<0. In some examples, a subcardioid polar pattern can be formed when 0<Y<1.

In one or more embodiments, a hypercardioid polar pattern can be formed by making the first weight X equal to 1.0, and making the second weight Y a negative (inverted) fraction, (e.g., MAPP1=1.0*C1−0.63*C2). In one example, a figure eight polar pattern can be formed by making the first weight X equal to 1.0, and making the second weight Y a negative (inverted) 1.0 (e.g., MAPP1=1.0*C1−1.0*C2). By applying weights to and/or inverting the audio signals generated by the first and second cardioid microphone capsules 204, 206, it is possible to generate any of the omnidirectional polar pattern 100, the figure eight polar pattern 102, the cardioid polar pattern 104, the hypercardioid polar pattern 106, the supercardioid polar pattern 108, and/or the subcardioid polar pattern 110. Although examples of generating particular polar patterns are described herein, it is to be appreciated that, by applying weights to and/or inverting the audio signals generated by the first and second cardioid microphone capsules 204, 206, an infinite number of different polar patterns can be generated by varying the applied weights. For example, while the omnidirectional polar pattern can be formed for the microphone assembly 200 by MAPP1=(1.0*C1+1.0*C2), a first additional polar pattern can be formed for the microphone assembly 200 by MAPP1=(0.99*C1+1.0*C2); a second additional polar pattern can be formed for the microphone assembly 200 by MAPP1=(1.0*C1+0.99*C2); a third additional polar pattern can be formed for the microphone assembly 200 by: MAPP1=(0.99*C1+0.99*C2), etc.

FIG. 2D illustrates a user interface 203 for a microphone having two opposite facing cardioid microphone capsules 204, 206 according to one or more embodiments. As shown, the user interface 203 includes an input device 230 of a microphone 232, which includes the microphone assembly 200. In some embodiments, the input device 230 is rotatable relative to an indicator 234 in both a clockwise direction and a counterclockwise direction. The input device 230 includes user interface elements 235-240 which each correspond to a polar pattern for the microphone 232.

In various embodiments, the user interface element 235 corresponds to the omnidirectional polar pattern 100; the user interface element 236 corresponds to the subcardioid polar pattern 110; the user interface element 237 corresponds to the cardioid polar pattern 104; the user interface element 238 corresponds to the supercardioid polar pattern 108; the user interface element 239 corresponds to the hypercardioid polar pattern 106; and the user interface element 240 corresponds to the figure eight polar pattern 102. In some embodiments, aligning the indicator 234 with an alignment mark for a particular one of the user interface elements 235-240 causes the microphone 232 to generate the polar pattern corresponding to the particular one of the user interface elements 235-240. In the illustrated example, the indicator 234 is aligned with the alignment mark for the user interface element 237. Accordingly, the microphone 232 will utilize and/or generate a cardioid polar pattern 104, which in the microphone assembly 200 described above could be formed by mathematically applying a first weight X of 1.0 to the signal from the first cardioid capsule 204 and applying a second weight Y of zero to the signal from the second cardioid capsule 206, or in other words the mathematical summation could be represented as a microphone assembly polar pattern MAPP1=1.0*C1+0*C2=C1. In another example, if the indicator 234 is aligned with the alignment mark for the user interface element 238, the microphone 232 will utilize and/or generate a supercardioid polar pattern 108, which could be formed by mathematically applying a first weight X of 1.0 to the signal from the first cardioid capsule 204 and applying a second weight Y of −0.25 to the signal from the second cardioid capsule 206, or in other words the mathematical summation could be represented as a microphone assembly polar pattern MAPP1=1.0*C1−0.25*C2.

In some examples, rotating the input device 230 such that the indicator 234 is positioned between alignment marks for the user interface elements 235-240 varies the polar pattern of the microphone 232 from a first one of the omnidirectional polar pattern 100, the subcardioid polar pattern 110, the cardioid polar pattern 104 the supercardioid polar pattern 108, the hypercardioid polar pattern 106, or the figure eight polar pattern 102 to a second one of the omnidirectional polar pattern 100, the subcardioid polar pattern 110, the cardioid polar pattern 104 the supercardioid polar pattern 108, the hypercardioid polar pattern 106, or the figure eight polar pattern 102. In the example shown in FIG. 2C, rotating the input device in a counterclockwise direction such that the alignment mark for the user interface element 238 actuates closer to the indicator 234 may be configured to gradually vary the polar pattern of the microphone 232 from the cardioid polar pattern 104 to the supercardioid polar pattern 108 by varying the weights X, Y used to form the polar pattern. In various embodiments, rotating the input device 230 may be configured to incrementally or continuously vary the polar pattern of the microphone 232 by, for example, varying one or more of the weights. Although the input device 230 is described as a rotatable device in the above examples, it is to be appreciated that, in other examples, the input device 230 can receive user inputs via a touchscreen, a keyboard, a mouse, a stylus, etc.

FIG. 2E is a schematic view of a microphone control system 200-3 for a microphone having two opposite facing cardioid microphone capsules 204, 206 according to one or more embodiments. The microphone control system 200-3 is included in the microphone 232 and receives inputs from the first cardioid microphone capsule 204 and from the second cardioid microphone capsule 206. A passive audio device receives an output based on the inputs. In some embodiments, the passive audio device is “passive” because audio signal processing is performed by the microphone control system 200-3 within the microphone 232 and external processing (e.g., by the passive audio device) is not needed to continuously vary the polar pattern of the microphone 232. The passive audio device may include a computing device, a standalone recording device, a speaker, a device configured to charge a battery (not shown) of the microphone 232, or another type of audio device. The passive audio device is communicatively coupled to the microphone 232 and the passive audio device may be included in the microphone 232 (as illustrated in FIG. 2E) or the passive audio device can be external to the microphone 232. Accordingly, the passive audio device may be wirelessly coupled to the microphone 232. As shown, the microphone control system 200-3 includes a codec 250 and a microcontroller unit (MCU) 252.

In various embodiments, the codec 250 may be implemented in hardware, software, firmware, or a combination thereof. The MCU 252 includes one or more memories, one or more processors, and one or more input/output interfaces. The codec 250 is illustrated to include a first switch 204-1 and a second switch 206-1. In some embodiments, the first and second switches 204-1, 206-1 can be opened/closed in response to user inputs received via the input device 230.

In general, the one or more processors of an MCU can be a hardware unit or combination of hardware units capable of executing software applications and processing data, including audio data. For example, a processor may be a central processing unit (CPU), a digital signal processor (DSP), an application-specific integrated circuit (ASIC), a combination of such units, or the like. The processor is configured to execute software applications, process audio data, and communicate with I/O devices among other operations. The memory may be any technically feasible type of hardware unit configured to store data, such as a hard disk, a random access memory (RAM) module, a flash memory unit, or a combination of different hardware units configured to store data. Software application(s) within the memory may include program code (e.g., instructions) that may be executed by the processor in order to perform various functionalities associated with the microphone assembly.

Opening the first switch 204-1 decouples the first cardioid microphone capsule 204 from a programmable gain amplifier (PGA) 254, and would be effectively seen at the summation process as making the first weight equal to zero. Closing the first switch 204-1 couples the first cardioid microphone capsule 204 to the PGA 254. In some embodiments, the PGA 254 is configured to amplify an input audio signal received from a microphone capsule such as the first cardioid microphone capsule 204.

Similarly, opening the second switch 206-1 decouples the second cardioid microphone capsule 206 from a PGA 254, and would be effectively seen at the summation process as making the second weight equal to zero. Closing the second switch 206-1 couples the second cardioid microphone capsule 206 to the PGA 254. It is to be appreciated that, in one or more embodiments, the PGA 254 coupled to the first cardioid microphone capsule 204 by closing the first switch 204-1 and the PGA 254 coupled to the second microphone capsule 206 by closing the second switch 206-1 can be configured to amplify corresponding input audio signals by adjustable gains which may be the same or different for the first and second cardioid microphone capsules 204, 206, respectively.

As shown in FIG. 2E, amplified analog outputs from the PGAs 254 are input to analog-to-digital converters (ADCs) 256, and digital outputs from the ADCs 256 are inputs to the MCU 252. Although examples of digital systems are described below, it is to be appreciated that, in some embodiments, functionality described in the examples of the digital systems may be implemented by one or more analog systems. For example, the one or more analog systems can receive the amplified analog outputs from the PGAs 254 (e.g., upstream of the ADCs 256), modify the amplified analog outputs, and sum the modified amplified outputs. In this example, the one or more analog systems can output an analog result of summing the modified amplified outputs as an input to the ADCs 256.

In some embodiments, in a coupled path that includes the first cardioid microphone capsule 204, a digital output from the ADC 256 is input to the MCU 252. In one or more embodiments, in a coupled path that includes the second cardioid microphone capsule 206, a digital output from the ADC 256 is input to the MCU 252. The MCU 252 passes the digital output from the coupled path the includes the first cardioid microphone capsule 204 to a digital adder 258 while the digital output from the coupled path that includes the second microphone capsule 206 is input to a polar pattern level 206-2.

In some examples, the polar pattern level 206-2 is configured to apply a weight to the digital output from the coupled path that includes the second microphone capsule 206 as described above and based on user inputs received via the input device 230. In certain embodiments, the weight applied to the digital output from the coupled path that includes the second microphone capsule 206 modifies the digital output based on the user inputs received via the input device 230. In some embodiments, the user inputs received via the input device 230 specify a characteristic of a polar pattern for the microphone 232, and the weight applied to the digital output from the coupled path that includes the second microphone capsule 206 modifies the digital output based on the characteristic of the polar pattern for the microphone 232. The microphone control system 200-3 may generate the polar pattern for the microphone 232 as having the characteristic based on the modified digital output from the coupled path that includes the second microphone capsule 206 in some examples. In one or more embodiments, the weight applied to the digital output from the coupled path that includes the second microphone capsule 206 can be any value and is not limited to weights corresponding to the user interface elements 235-240. For example, a magnitude of a weight applied to the digital output from the coupled path that includes the second microphone capsule 206 can be adjusted relative to a magnitude of a weight (e.g., 1.0) applied to the digital output from the coupled path that includes the first microphone capsule 204 to implement a continuously variable polar pattern.

In various embodiments, an output of the polar pattern level 206-2 is input to a digital inverter 206-3. The digital inverter 206-3 is configured to apply a negative or a positive sign to the output of the polar pattern level 206-2 based on user inputs received via the input device 230. An output of the digital inverter 206-3 is input to the digital adder 258. The digital adder 258 is configured to sum received inputs and output a result of summing the inputs to a Universal Serial Bus (USB) 260 in some examples. As shown, the passive audio device (e.g., a recording device) which is coupled to the microphone 232 receives an output from the USB 260, which defines a polar pattern for the microphone 232. For example, the passive audio device receives the output from the USB 260 as a fully processed output and no additional processing is performed on the output from the USB 260 by the passive audio device.

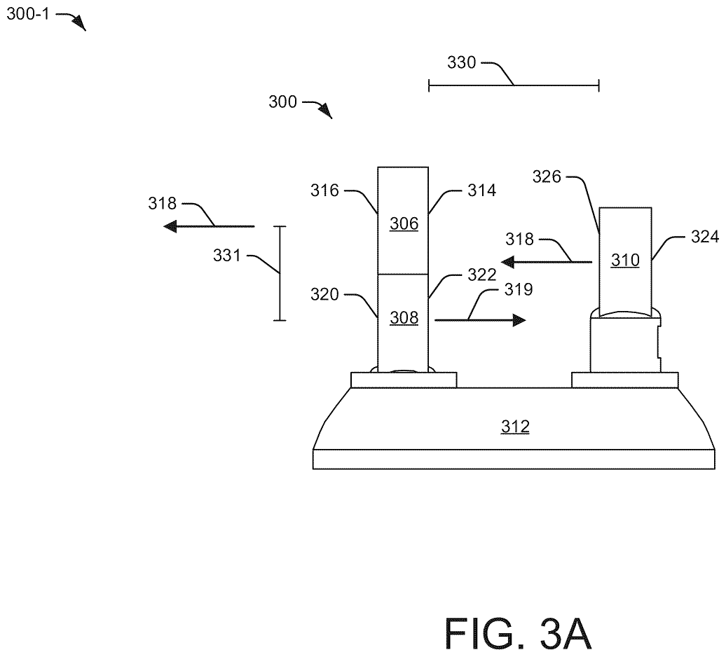

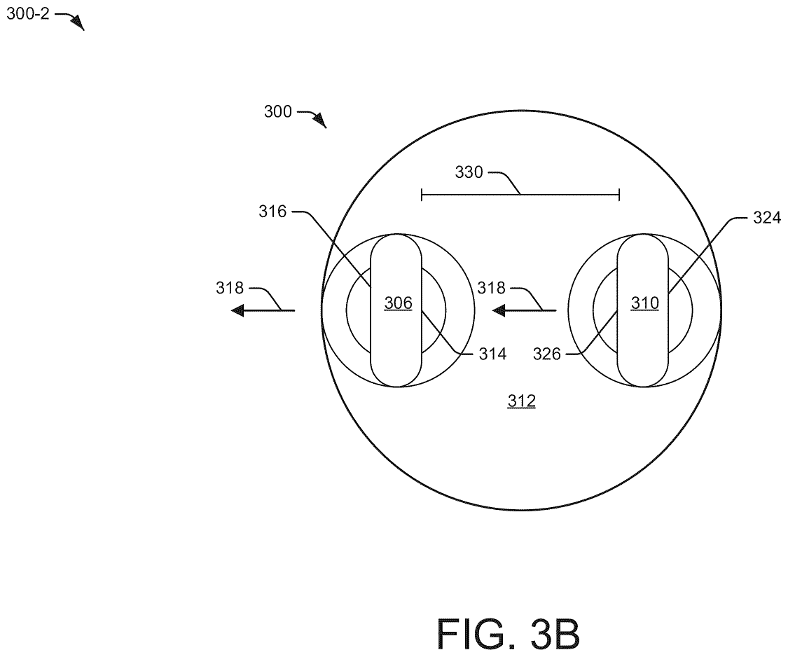

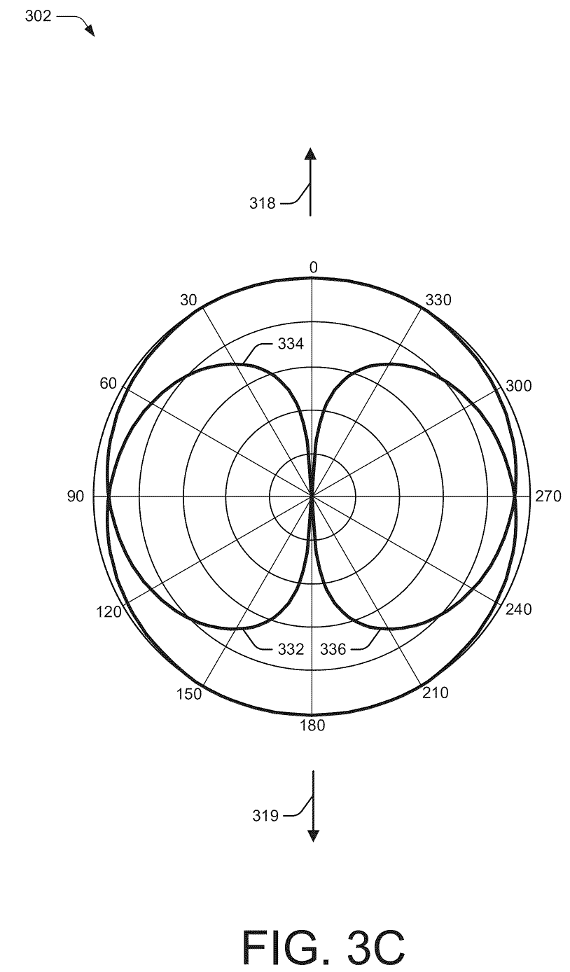

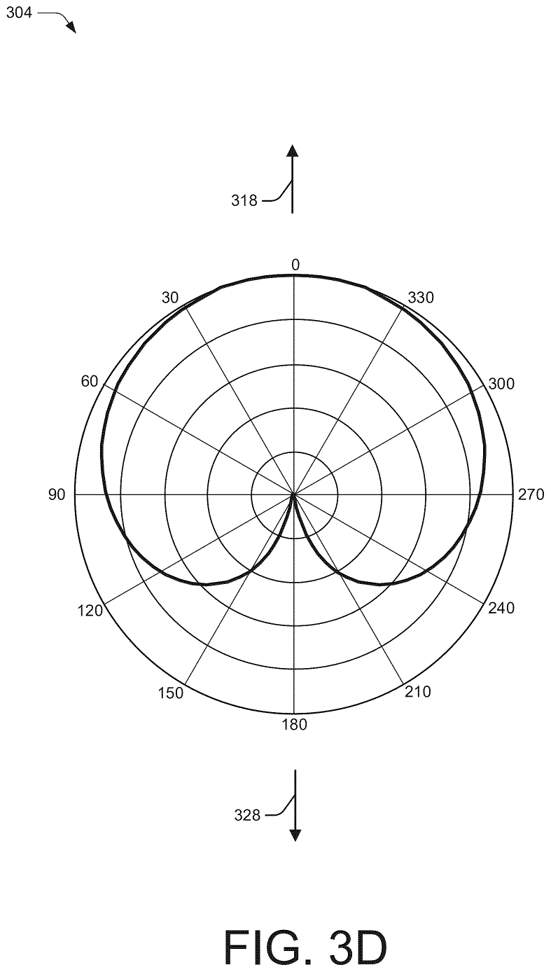

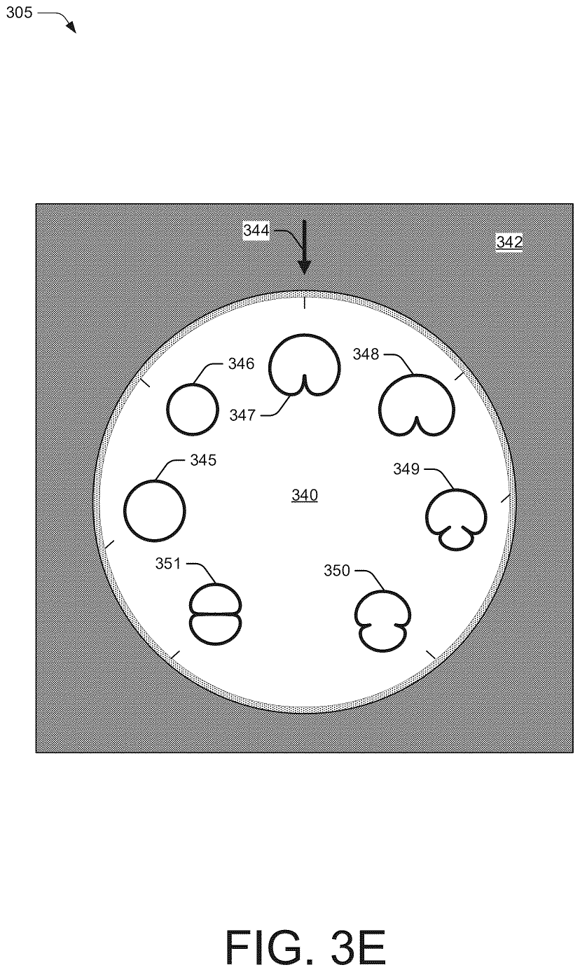

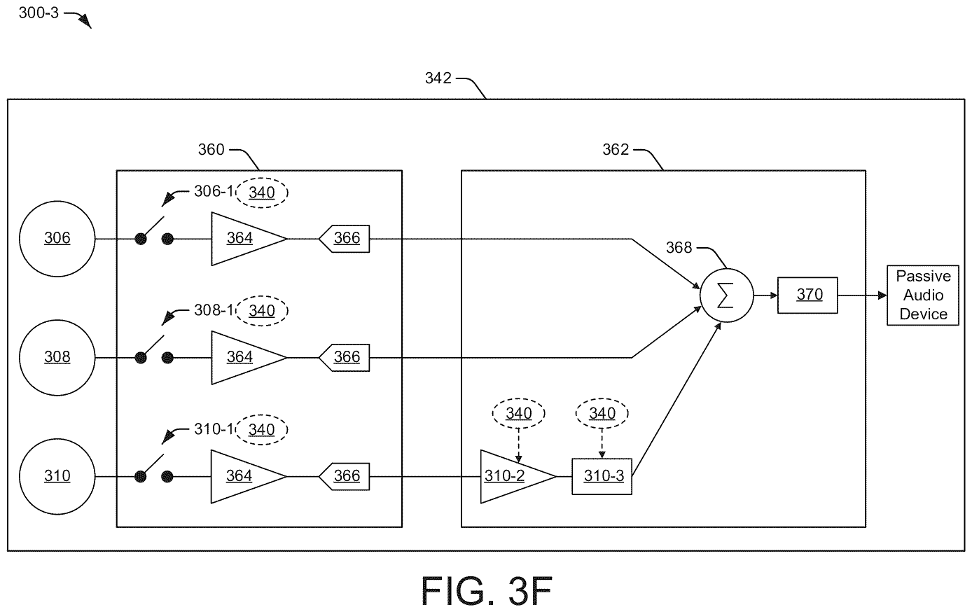

FIG. 3A illustrates a side view 300-1 of a microphone assembly 300 with a pair of opposite facing cardioid microphone capsules 306, 308 and an additional cardioid microphone capsule 310 according to one or more embodiments. FIG. 3B illustrates a plan view 300-2 of the microphone assembly 300 with the pair of opposite facing cardioid microphone capsules 306, 308 and the additional cardioid microphone capsule 310 according to one or more embodiments. In one embodiment, the microphone assembly 300 includes a first cardioid microphone capsule 306, a second cardioid microphone capsule 308, a third cardioid microphone capsule 310, and a base 312. Similar to the microphone assembly 200, since the first, second, and third cardioid microphone capsules 306, 308, 310 are the same type of microphone capsule, the first, second, and third cardioid microphone capsules 306, 308, 310 can be matched more closely and require less compensation than a group of different microphone capsules such as two cardioid microphone capsules and a non-cardioid microphone capsule. In some embodiments, the first cardioid microphone capsule 306 is disposed on the second cardioid microphone capsule 308, and the second cardioid microphone capsule 308 is disposed on the base 312. The third cardioid microphone capsule 310 is also disposed on the base 312 in some examples.

The first cardioid microphone capsule 306 has a backside 314 and a front face 316, and the first cardioid microphone capsule 306 is oriented to face in a first direction 318. In one or more embodiments, the second cardioid microphone capsule 308 includes a backside 320 and a front face 322. In various embodiments, the second cardioid microphone capsule 308 is oriented to face in a second direction 319 that is opposite the first direction 318. The third cardioid microphone capsule 310 has a backside 324 and a front face 326. In some embodiments, the third cardioid microphone capsule 310 is oriented to face in the first direction 318. In this configuration, the first cardioid microphone capsule 306 and second cardioid microphone capsule 308 can be combined, as described above, to form the first order patterns, and the first cardioid microphone capsule 306 and the third cardioid microphone capsule 310 can be used to form a second order cardioid pattern, by use of at least the distance 330 between them to create the a difference between the signals received from the capsules. If the first cardioid microphone capsule 306 and the third cardioid microphone capsule 310 were positioned in a coplanar orientation, the generated signals would be same for both capsules, so the difference would be zero.

The first and second cardioid microphone capsules 306, 308 are separated from the third cardioid microphone capsule 310 by a distance 330. In some examples, the distance 330 is equal to the distance 222. In other examples, the distance 330 is greater or less than the distance 222. The center of the first cardioid microphone capsule 306 is separated from the center of the second cardioid microphone capsule 308 by a vertical distance 331. In some embodiments, the center of the third cardioid microphone capsule 310 is disposed at a vertical position that is about the mid-point of the vertical distance 331 formed between the first cardioid microphone capsule 306 and the second cardioid microphone capsule 308.

FIG. 3C illustrates an overlapping polar pattern 302 generated by and overlay of the cardioid patterns generated by each of the pair of opposite facing cardioid microphone capsules 306, 308 and the cardioid pattern generated by the additional cardioid microphone capsule 310 according to one or more embodiments. The overlapping polar pattern 302 includes a first cardioid polar pattern 332, a second cardioid polar pattern 334, and a third cardioid polar pattern 336. In some embodiments, the first cardioid polar pattern 332 corresponds to the polar pattern formed by the first cardioid microphone capsule 306 and is similar to the cardioid polar pattern 104. The second cardioid polar pattern 334 corresponds to the polar pattern formed by the second cardioid microphone capsule 308 and is also similar to the cardioid polar pattern 104 rotated by 180 degrees. The third cardioid polar pattern 336 corresponds to the polar pattern generated by the third cardioid microphone capsule 310 and is similar to the cardioid polar pattern 104.

In various embodiments, by applying weights to (e.g., scaling) and/or inverting audio signals generated by the first, second, and third cardioid microphone capsules 306, 308, 310 based on the first, second, and third cardioid polar patterns 332, 334, 336, respectively, the weighted and/or inverted audio signals are combinable (e.g., summed) in a channel such that a desired polar pattern can be generated for the microphone assembly 300. An example of combining the audio signals generated by the first, second, and third cardioid microphone capsules 306, 308, 310 in a channel can include the following:

$$Microphone Assembly Polar Pattern 2 ( MAPP 2 ) = X * C 1 + Y * C 2 + Z * C 3 ,$$

where: C1 represents the audio signal generated by the first cardioid microphone capsule 306 based on the first cardioid polar pattern 332; C2 represents the audio signal generated by the second cardioid microphone capsule 308 based on the second cardioid polar pattern 334; C3 represents the audio signal generated by the third cardioid microphone capsule 310 based on the third cardioid polar pattern 336; X represents a first weight; Y represents a second weight; and Z represents a third weight, where X, Y, and Z vary from −1.0 to 1.0. In some embodiments, the first weight X, the second weight Y, and/or the third weight Z can be less than zero or greater than zero.

In one or more examples, an omnidirectional polar pattern can be formed for the microphone assembly 300 by making the first weight X equal to 1.0; making the second weight Y equal to 1.0; and making the third weight Z equal to zero (e.g., MAPP2=1.0*C1+1.0*C2). Additionally, a cardioid polar pattern can be formed by making the first weight X equal to 1.0; making the second weight Y equal to zero; and making the third weight Z equal to zero (e.g., MAPP2=1.0*C1). In some embodiments, a supercardioid polar pattern can be formed by making the first weight X equal to 1.0; making the second weight Y a negative (inverted) fraction; and making the third weight Z equal to zero (e.g., MAPP2=1.0*C1−0.25*C2). In various embodiments, a supercardioid polar pattern can be formed when −1<Y<0. In some examples, a subcardioid polar pattern can be formed when 0<Y<1.

In one or more embodiments, a hypercardioid polar pattern can be formed by making the first weight X equal to 1.0; making the second weight Y a negative (inverted) fraction; and making the third weight Z equal to zero (e.g., MAPP2=1.0*C1−0.63*C2). In one example, a figure eight polar pattern can be formed by making the first weight X equal to 1.0; making the second weight Y a negative (inverted) 1.0; and making the third weight Z equal to zero (e.g., MAPP2=1.0*C1−1.0*C2). Similar to the example described above, by applying weights to and/or inverting the audio signals generated by the first, second, and third cardioid microphone capsules 306, 308, 310, it is possible to generate any of the omnidirectional polar pattern 100, the figure eight polar pattern 102, the cardioid polar pattern 104, the hypercardioid polar pattern 106, the supercardioid polar pattern 108, and/or the subcardioid polar pattern 110.

FIG. 3D illustrates a second order cardioid polar pattern 304 according to one or more embodiments. In certain embodiments, because the microphone assembly 300 includes three cardioid microphone capsules, the second order cardioid polar pattern 304 can be generated in addition to generating the polar patterns noted above. In various embodiments, the second order cardioid polar pattern 304 can be formed by making the first weight X equal to 1.0 and making the third weight Z equal to a negative (inverted) 1.0 (e.g., MAPP2=1.0*C1−1.0*C3). In some embodiments, forming the second order cardioid polar pattern 304 may include adding delays and/or phase shifting.

Notably, in various embodiments, the second order cardioid polar pattern 304 can be generated using two cardioid microphone capsules that are separated by the distance 330 such as the first and third cardioid microphone capsules 306, 310. As the distance 330 increases, a difference between the first cardioid microphone capsule 306 and the third cardioid microphone capsule 310 also increases which generally improves performance of the microphone assembly 300 at relatively low frequencies. However, if a length of a wavelength at a particular frequency is about the same as the distance 330 (e.g., on the same order), then the performance of the microphone assembly 300 degrades substantially in some examples. In one or more embodiments, an ideal length of the distance 330 may be in a range of about 0.1 to 4 centimeters (cm) such as a range of about 1 to 2 cm.

FIG. 3E illustrates a user interface 305 for a microphone having the opposite facing pair of cardioid microphone capsules 306, 308 and the additional cardioid microphone capsule 310 according to one or more embodiments. The user interface 305 includes an input device 340 of a microphone 342, which includes the microphone assembly 300. In various embodiments, the input device 340 is rotatable relative to an indicator 344 in both a clockwise direction and a counterclockwise direction. The input device 340 includes user interface elements 345-351 which each correspond to a polar pattern for the microphone 342.

In some embodiments, the user interface element 345 corresponds to the omnidirectional polar pattern 100; the user interface element 346 corresponds to the subcardioid polar pattern 110; the user interface element 347 corresponds to the cardioid polar pattern 104; the user interface element 348 corresponds to the second order cardioid polar pattern 304; the user interface element 349 corresponds to the supercardioid polar pattern 108; the user interface element 350 corresponds to the hypercardioid polar pattern 106; and the user interface element 351 corresponds to the figure eight polar pattern 102. In one or more embodiments, aligning the indicator 344 with an alignment mark of a particular one of the user interface elements 345-351 causes the microphone 342 to generate a polar pattern corresponding the particular one of the user interface elements 345-351. In various embodiments, rotating the input device 340 such that an alignment of the indicator 344 is positioned between alignment marks of first and second ones of the user interface elements 345-351 causes the polar pattern of the microphone 342 to gradually vary between a first polar pattern corresponding to the first one of the user interface elements 345-351 and a second polar pattern corresponding to the second one of the user interface elements 345-351 by varying the weights X, Y, Z.

FIG. 3F is a schematic view of a microphone control system 300-3 for a microphone having the pair of opposite facing cardioid microphone capsules 306, 308 and the additional cardioid microphone capsule 310 according to one or more embodiments. The microphone control system 300-3 is included in the microphone 342, and the microphone control system 300-3 receives inputs from the first cardioid microphone capsule 306, the second cardioid microphone capsule 308, and the third cardioid microphone capsule 310. As shown, a passive audio device (such as a recording device) coupled to the microphone 342 receives an output based on the inputs. The passive audio device may or may not be capable of performing additional processing on the output; however, regardless of the capabilities of the passive audio device, no additional processing of the output is necessary. For example, no additional processing of the output is needed because the microphone control system 300-3 generates the output as a fully processed output. In some examples, the passive audio device is included in the microphone 342. In other examples, the passive audio device is external to the microphone 342.

The microphone control system 300-3 is illustrated to include a codec 360 and a microcontroller unit (MCU) 362. In some embodiments, the codec 360 may be implemented in hardware, software, firmware, or a combination thereof. The MCU 362 can include one or more memories, one or more processors, and one or more input/output interfaces. In the illustrated example, the codec 360 includes a first switch 306-1, a second switch 308-1, and a third switch 310-1. In one or more embodiments, the first, second, and third switches 306-1, 308-1, 310-1 may be opened/closed in response to user inputs received via the input device 340.

Opening the first switch 306-1 decouples the first cardioid microphone capsule 306 from a programmable gain amplifier (PGA) 364, and would be effectively seen at the summation process as making the first weight equal to zero. Closing the first switch 306-1 couples the first cardioid microphone capsule 306 to the PGA 364. In certain embodiments, the PGA 364 is configured to amplify an input audio signal received from a microphone capsule such as the first cardioid microphone capsule 306.

Opening the second and third switches 308-1, 310-1 decouple the second and third cardioid microphone capsules 308, 310 from PGAs 364, respectively, and each would be effectively seen at the summation process as making the second weight Y and the third weight Z to be equal to zero. Closing the second and third switches 308-1, 310-1 couple the second and third cardioid microphone capsules 308, 310 to the PGAs 364, respectively. In some embodiments, the PGA 364 coupled to the second cardioid microphone capsule 308 and the PGA 364 coupled to the third cardioid microphone capsule 310 are configured to amplify corresponding input audio signals received from the first and second cardioid microphone capsules 306, 308, respectively.

Within the codec 360, amplified analog outputs from the PGAs 364 are input to analog-to-digital converters (ADCs) 366, and digital outputs from the ADCs 366 are inputs to the MCU 362. In one or more embodiments, in a coupled path that includes the first cardioid microphone capsule 306, a digital output from the ADC 366 is input to the MCU 362. In some embodiments, in a coupled path that includes the second cardioid microphone capsule 308, a digital output from the ADC 366 is input to the MCU 362. In various examples, in a coupled path that includes the third cardioid microphone capsule 310, a digital output from the ADC 366 is input to the MCU 362.

The MCU 362 passes the digital output from the coupled path that includes the first cardioid microphone capsule 306 and the digital output from the coupled path that includes the second cardioid microphone capsule 308 to a digital adder 368, and the output from the coupled path that includes the third cardioid microphone capsule 310 is input to a polar pattern level 310-2. In some embodiments, the polar pattern level 310-2 is configured to apply a weight to the digital output from the coupled path that includes the third cardioid microphone capsule 310 based on user inputs received via the input device 340. In one or more embodiments, the weight applied to the digital output from the coupled path that includes the third cardioid microphone capsule 310 can be any value such as a value corresponding to one of the user interface elements 345-351 or between ones of the user interface elements 345-351.

In certain embodiments, an output of the polar pattern level 310-2 is input to a digital inverter 310-3. Like the digital inverter 206-3, the digital inverter 310-3 is configured to apply a negative or a positive sign to the output of the polar pattern level 310-2 based on user inputs received via the input device 340. As shown an output of the digital inverter 310-3 is input to the digital adder 368. The digital adder 368 sums received inputs and outputs a result of summing the inputs to a Universal Serial Bus (USB) 370 in some examples. In some embodiments, the passive audio device communicatively coupled to the microphone 342 receives an output from the USB 370 which defines a polar pattern for the microphone 342 (e.g., based on user inputs received via the input device 340). In one or more embodiments, the passive audio device coupled to the microphone 342 includes a recording device which passively receives the output from the USB 370.

In some embodiments, a user input is received via the input device 340 specifying a characteristic of a polar pattern for the microphone 342. The digital output from the coupled path that includes the third cardioid microphone capsule 310 is modified based on the characteristic by the polar pattern level 310-2 and/or the digital inverter 310-3. In some examples, the modified digital output from the coupled path that includes the third cardioid microphone capsule 310 is combined with at least one of the digital output from the coupled path that includes the first cardioid microphone capsule 306 or the digital output from the coupled path that includes the second cardioid microphone capsule 308 as a combined audio signal by the digital adder 368. In various examples, the microphone control system 300-3 generates the polar pattern for the microphone 342 having the characteristic based on the combined audio signal.

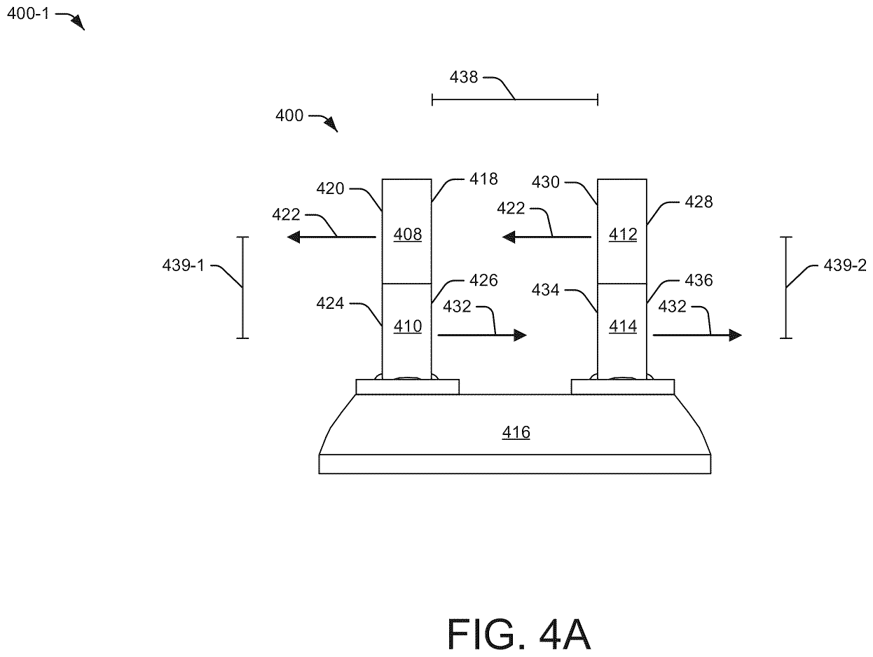

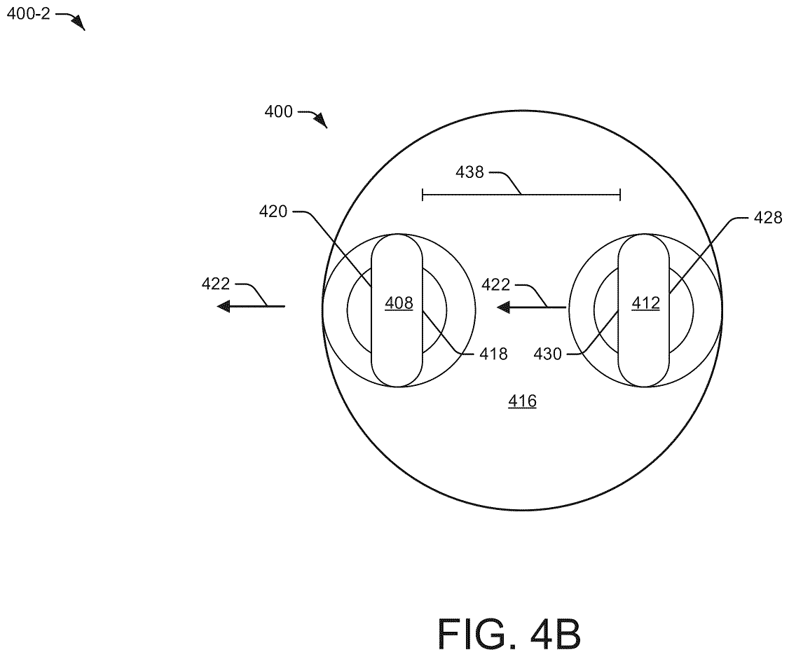

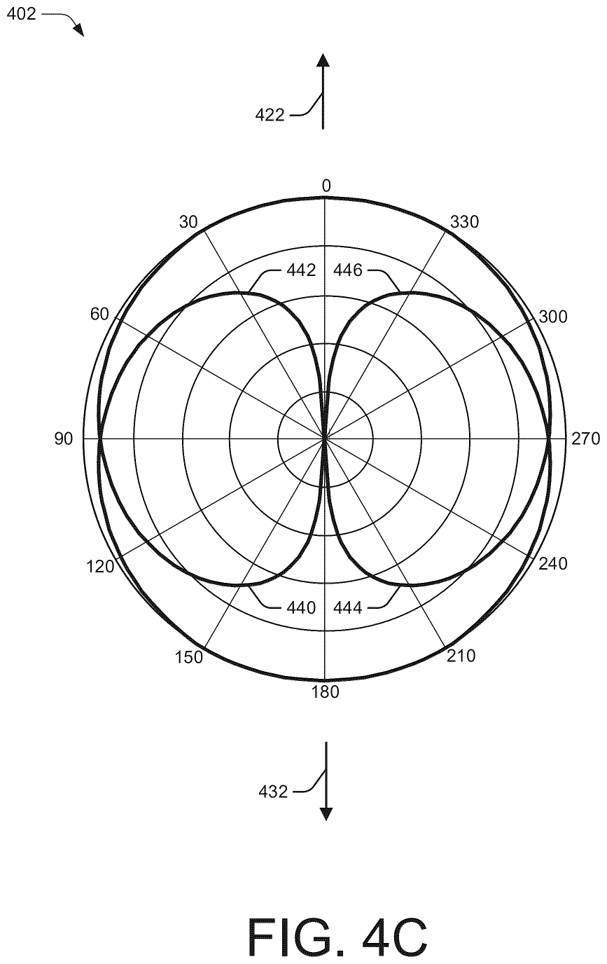

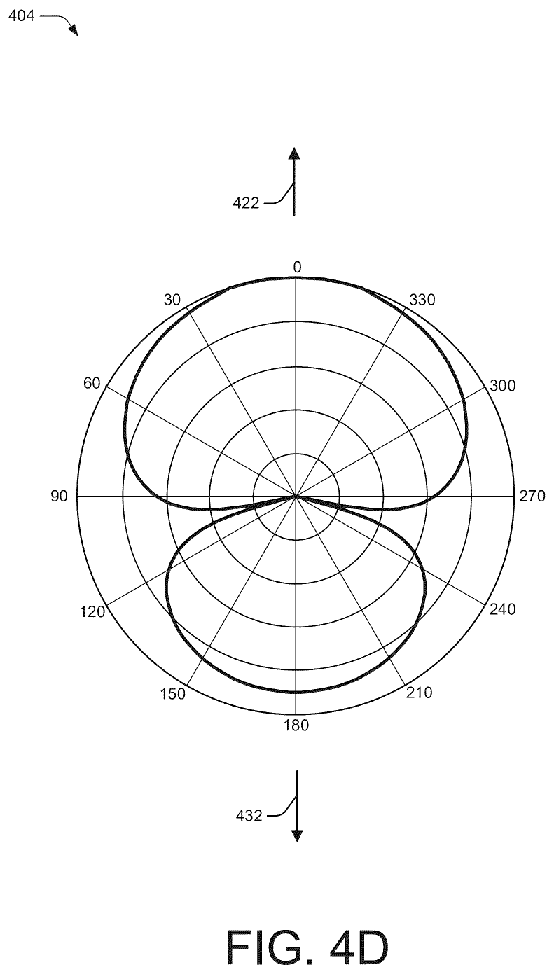

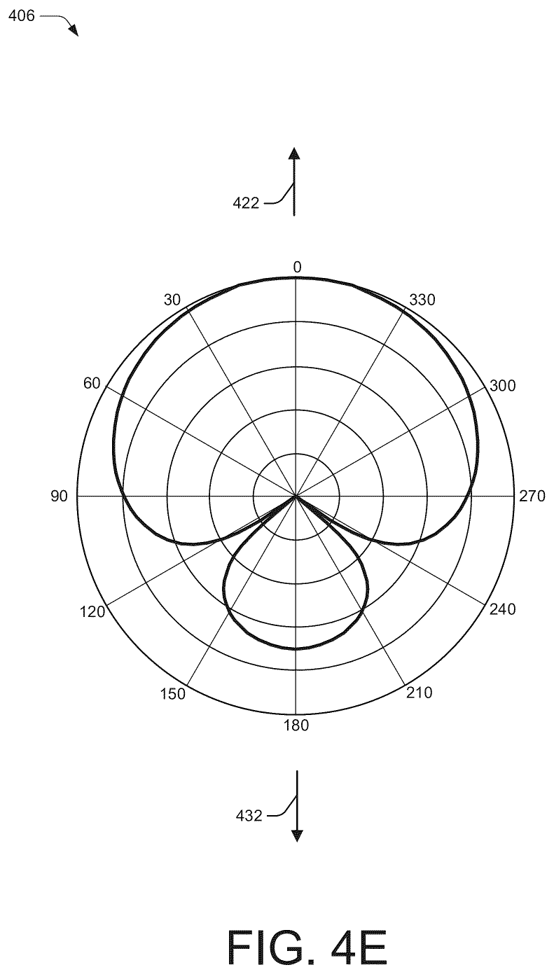

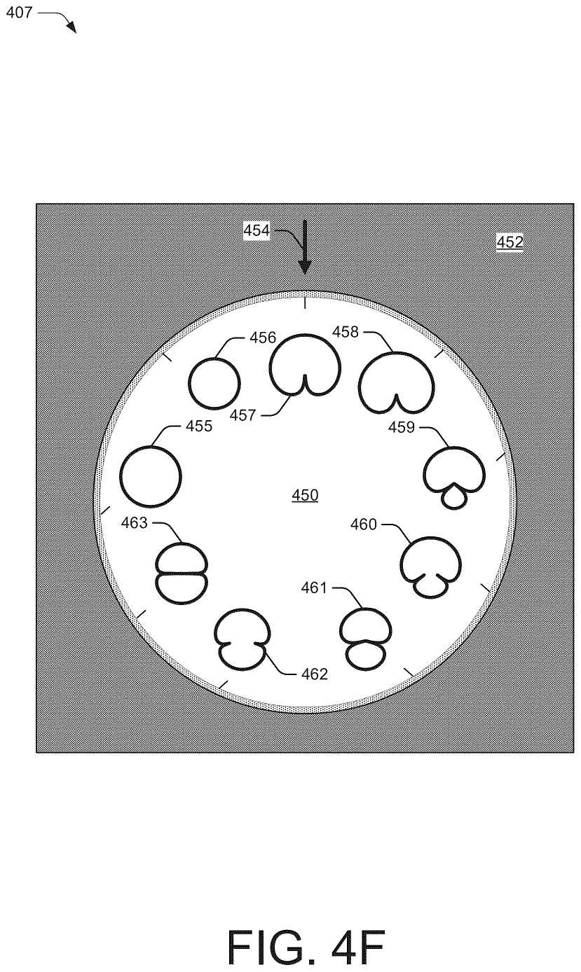

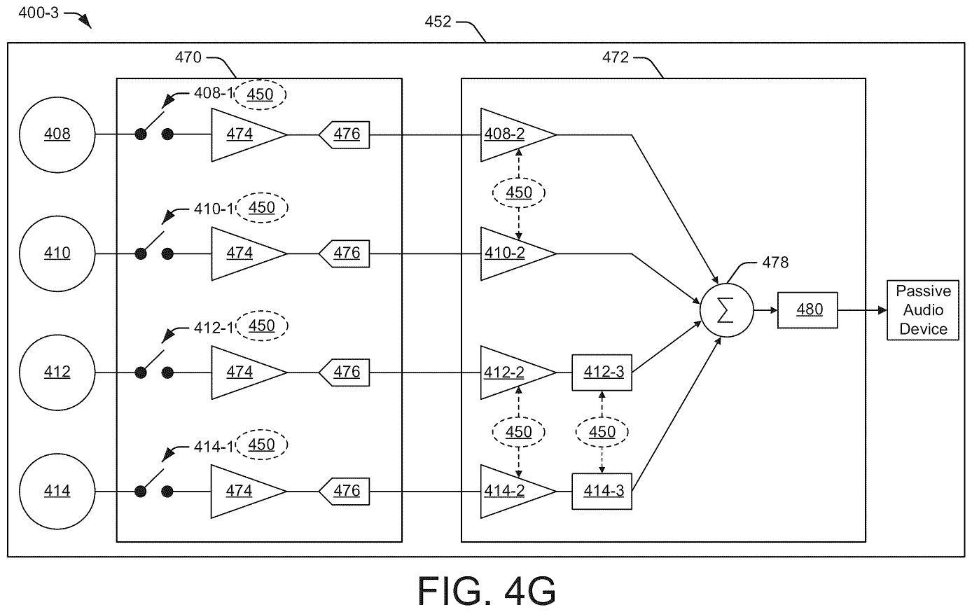

FIG. 4A illustrates a side view 400-1 of a microphone assembly 400 with a first pair of opposite facing cardioid microphone capsules 408, 410 and a second pair of opposite facing cardioid microphone capsules 412, 414 according to one or more embodiments. FIG. 4B illustrates a plan view 400-2 of a microphone assembly 400 with the first pair of opposite facing cardioid microphone capsules 408, 410 and the second pair of opposite facing cardioid microphone capsules 412, 414 according to one or more embodiments. The microphone assembly 400 is illustrated to include a first cardioid microphone capsule 408, a second cardioid microphone capsule 410, a third cardioid microphone capsule 412, a fourth cardioid microphone capsule 414, and a base 416. In various embodiments, the first cardioid microphone capsule 408 is disposed on the second cardioid microphone capsule 410, and the second cardioid microphone capsule 414 is disposed on the base 416. In the illustrated example, the fourth cardioid microphone capsule 414 is disposed on the base 416, and the third cardioid microphone capsule 412 is disposed on the fourth cardioid microphone capsule 414. Similar to the microphone assemblies 200, 300, since the first, second, third, and fourth cardioid microphone capsules 408, 410, 412, 414 are the same type of microphone capsule, the first, second, third, and fourth cardioid microphone capsules 408, 410, 412, 414 can be matched more closely and require less signal compensation than a group of different microphone capsules such as two cardioid microphone capsules and two non-cardioid microphone capsules.

The first cardioid microphone capsule 408 includes a backside 418 and a front face 420. In some embodiments, the first cardioid microphone capsule 408 is oriented to face in a first direction 422. The second cardioid microphone capsule 410 includes a backside 424 and a front face 426. In one or more embodiments, the second cardioid microphone capsule 410 is oriented to face in a second direction 432 that is opposite the first direction 422.

The third cardioid microphone capsule 412 includes a backside 428 and a front face 430. In certain embodiments, the third cardioid microphone capsule 412 is oriented to face in the first direction 422. The fourth cardioid microphone capsule 414 includes a backside 434 and a front face 436. In some embodiments, the fourth cardioid microphone capsule 414 is oriented to face in the second direction 432 that is opposite the first direction 422.

The first and second cardioid microphone capsules 408, 410 are separated from the third and fourth cardioid microphone capsules 412, 414 by a distance 438. In some embodiments, the distance 438 is the same as the distance 222 and/or the distance 330. In other embodiments, the distance 438 is different from the distance 222 and/or the distance 330. The center of the first cardioid microphone capsule 408 is separated from the center of the second cardioid microphone capsule 410 by a vertical distance 439-1. Similarly, the center of the third cardioid microphone capsule 412 is separated from the center of the fourth cardioid microphone capsule 414 by a vertical distance 439-2. In some embodiments, the vertical distances 439-1, 439-2 are the same distance. In other embodiments, the vertical distances 439-1, 439-2 are different distances.

FIG. 4C illustrates an overlapping polar pattern 402 generated by an overlay of the cardioid polar pattern generated by each of the first pair of opposite facing cardioid microphone capsules 408, 410 and each of the second pair of opposite facing cardioid microphone capsules 412, 414 according to one or more embodiments. The overlapping polar pattern 402 includes a first cardioid polar pattern 440, a second cardioid polar pattern 442, a third cardioid polar pattern 444, and a fourth cardioid polar pattern 446. In various embodiments, the first cardioid polar pattern 440 corresponds to the polar pattern formed by the first cardioid microphone capsule 408; the second cardioid polar pattern 442 corresponds to the polar pattern formed by the second cardioid microphone capsule 410; the third cardioid polar pattern 444 corresponds to the polar pattern formed by the third cardioid microphone capsule 412; and the fourth cardioid polar pattern 446 corresponds to the polar pattern formed by the fourth cardioid microphone capsule 414.

In some embodiments, by applying weights to (e.g., scaling) and/or inverting audio signals generated by the first, second, third, and fourth cardioid microphone capsules 408, 410, 412, 414 based on the first, second, third, and fourth cardioid polar patterns 440, 442, 444, 446, respectively, the weighted and/or inverted audio signals are combinable (e.g., summed) in a channel such that a desired polar pattern can be generated for the microphone assembly 400. An example of combining the audio signals generated by the first, second, third, and fourth cardioid microphone capsules 408, 410, 412, 414 in a channel can include the following:

$$Microphone Assembly Polar Pattern 3 ( MAPP 3 ) = X * C 1 + Y * C 2 + Z * C 3 + W * C 4 ,$$

where: C1 represents the audio signal generated by the first cardioid microphone capsule 408 based on the first cardioid polar pattern 440; C2 represents the audio signal generated by the fourth cardioid microphone capsule 414 based on the fourth cardioid polar pattern 446; C3 represents the audio signal generated by the second cardioid microphone capsule 410 based on the second cardioid polar pattern 442; C4 represents the audio signal generated by the third cardioid microphone capsule 412 based on the third cardioid polar pattern 444; X represents a first weight; Y represents a second weight; Z represents a third weight; and W represents a fourth weight, where X, Y, Z, and W vary from −1.0 to 1.0. In some embodiments, the first weight X, the second weight Y, the third weight Z, and/or the fourth weight W can be less than zero or greater than zero.

An omnidirectional polar pattern can be formed for the microphone assembly 400 by making the first weight X equal to 1.0; making the second weight Y equal to 1.0; making the third weight Z equal to zero; and making the fourth weight W equal to zero (e.g., MAPP3=1.0*C1+1.0*C2). A cardioid polar pattern can be formed by making the first weight X equal to 1.0; making the second weight Y equal to zero; making the third weight Z equal to zero; and making the fourth weight W equal to zero (e.g., MAPP3=1.0*C1). In certain embodiments, a supercardioid polar pattern can be formed by making the first weight X equal to 1.0; making the second weight Y a negative (inverted) fraction; making the third weight Z equal to zero; and making the fourth weight W equal to zero (e.g., MAPP3=1.0*C1−0.25*C2). In various embodiments, a supercardioid polar pattern can be formed when −1<Y<0. In some examples, a subcardioid polar pattern can be formed when 0<Y<1.

In one or more embodiments, a hypercardioid polar pattern can be formed by making the first weight X equal to 1.0; making the second weight Y a negative (inverted) fraction; making the third weight Z equal to zero; and making the fourth weight W equal to zero (e.g., MAPP3=1.0*C1−0.63*C2). In one example, a figure eight polar pattern can be formed by making the first weight X equal to 1.0; making the second weight Y a negative (inverted) 1.0; making the third weight Z equal to zero; and making the fourth weight W equal to zero (e.g., MAPP2=1.0*C1−1.0*C2). By applying weights to and/or inverting the audio signals generated by the first, second, third, and fourth cardioid microphone capsules 408, 410, 412, 414, it is possible to generate any of the omnidirectional polar pattern 100, the figure eight polar pattern 102, the cardioid polar pattern 104, the hypercardioid polar pattern 106, the supercardioid polar pattern 108, and/or the subcardioid polar pattern 110. In some embodiments, the second order cardioid polar pattern 304 may be formed by making the first weight X equal to 1.0, the second weight Y equal to 1.0, and the third weight Z and the fourth weight W equal to zero (e.g., MAPP3=1.0*C1+1.0*C2). In one or more embodiments, a second order subcardioid polar pattern is generated when 0<Z, W<1.

FIG. 4D illustrates a second order hypercardioid polar pattern 404 according to one or more embodiments. FIG. 4E illustrates a second order supercardioid polar pattern 406 according to one or more embodiments. In some embodiments, the second order hypercardioid polar pattern 404 or the second order supercardioid polar pattern 406 can be generated by computing channel 1 out=X*C1+Y*C2 and channel 2out=Z*C3+W*C4. Once computed, channel 1 out is subtracted from channel 2out and channel 2out is subtracted from channel 1 out and X, Y, Z, and W are varied in order to form second order polar patterns. In some embodiments, forming the second order polar patterns includes adding delays and/or phase shifting.

FIG. 4F illustrates a user interface 407 for a microphone having the first pair of opposite facing cardioid microphone capsules 408, 410 and the second pair of opposite facing cardioid microphone capsules 412, 414 according to one or more embodiments. The user interface 407 is illustrated to include an input device 450 of a microphone 452 which includes the microphone assembly 400. In one or more embodiments, the input device 450 is rotatable relative to an indicator 454 in both a clockwise direction and a counterclockwise direction. As shown, the input device 450 includes user interface elements 455-463 which each correspond to a polar pattern for the microphone 452.

In certain embodiments, the user interface element 455 corresponds to the omnidirectional polar pattern 100; the user interface element 456 corresponds to the subcardioid polar pattern 110; the user interface element 457 corresponds to the cardioid polar pattern 104; the user interface element 458 corresponds to the second order cardioid polar pattern 304; the user interface element 459 corresponds to the second order supercardioid polar pattern 406; the user interface element 460 corresponds to the supercardioid polar pattern 108; the user interface element 461 corresponds to the second order hypercardioid polar pattern 404; the user interface element 462 corresponds to the hypercardioid polar pattern 106; and the user interface element 463 corresponds to the figure eight polar pattern 102. In some embodiments, aligning the indicator 454 with an alignment mark of a particular one of the user interface elements 455-463 causes the microphone 452 to generate a polar pattern corresponding the particular one of the user interface elements 455-463. In one or more embodiments, rotating the input device 450 such that an alignment of the indicator 454 is positioned between alignment marks of first and second ones of the user interface elements 455-463 causes the polar pattern of the microphone 452 to gradually vary between a first polar pattern corresponding to the first one of the user interface elements 455-463 and a second polar pattern corresponding to the second one of the user interface elements 455-463.

FIG. 4G is a schematic view of a microphone control system 400-3 for a microphone having the first pair of opposite facing cardioid microphone capsules 408, 410 and the second pair of opposite facing cardioid microphone capsules 412, 414 according to one or more embodiments. The microphone control system 400-3 can be included in the microphone 452. The microphone control system 400-3 receives inputs from the first, second, third, and fourth cardioid microphone capsules 408, 410, 412, 414. As shown, a passive audio device coupled to the microphone 452 receives an output based on the inputs. The passive audio device can include a computing device, a speaker, or another type of audio device. Notably, the passive audio device does not need to perform any digital signal processing relative to the received output because the passive audio device receives the output from the microphone control system 400-3 as a fully processed output. In one example, the passive audio device is included in the microphone 452. In another example, the passive audio device may be external to the microphone 452.

The microphone control system 400-3 includes a codec 470 and a microcontroller unit (MCU) 472. In various embodiments, the codec 470 may be implemented in hardware, software, firmware, or a combination thereof. In various embodiments, the MCU 472 includes one or more memories, one or more processors, and one or more input/output interfaces. As shown, the codec 470 includes a first switch 408-1, a second switch 410-1, a third switch 412-1, and a fourth switch 414-1. In some embodiments, the first, second, third, and fourth switches 408-1, 410-1, 412-1, 414-1 may be opened/closed in response to user inputs received via the input device 450.

Opening the first, second, third, and fourth switches 408-1, 410-1, 412-1, 414-1 decouple the first, second, third, and fourth cardioid microphone capsules 408, 410, 412, 414 from programmable gain amplifiers (PGAs) 474, respectively, and each would be effectively seen at the summation process as making first weight X, the second weight Y, the third weight Z, and the fourth weight W to be equal to zero. Closing the first, second, third, and fourth switches 408-1, 410-1, 412-1, 414-1 couple the first, second, third, and fourth cardioid microphone capsules 408, 410, 412, 414 to the PGAs 474, respectively. In some embodiments, the PGA 474 coupled to the first cardioid microphone capsule 408, the PGA 474 coupled to the second cardioid microphone capsule 410, the PGA 474 coupled to the third cardioid microphone capsule 412, and the PGA 474 coupled to the fourth cardioid microphone capsule 414 amplify input audio signals received from the first, second, third, and fourth cardioid microphone capsules 408, 410, 412, 414, respectfully.

In some embodiments, within the codec 470, amplified analog outputs from the PGAs 474 are input to analog-to-digital converters (ADCs) 476, and digital outputs from the ADCs 476 are inputs to the MCU 472. In various embodiments, in a coupled path that includes the first cardioid microphone capsule 408, a digital output from the ADC 476 is input to the MCU 472. In one or more embodiments, in a coupled path that includes the second cardioid microphone capsule 410, a digital output from the ADC 476 is input to the MCU 472. In certain embodiments, in a coupled path that includes the third cardioid microphone capsule 412, a digital output from the ADC 476 is input to the MCU 472. In some examples, in a coupled path that includes the fourth cardioid microphone capsule 414 a digital output from the ADC 476 is input to the MCU 472.

In the illustrated example, the digital output from the coupled path that includes the first cardioid microphone capsule 408 is input to a polar pattern level 408-2 which applies a weight to the digital output from the coupled path that includes the first cardioid microphone capsule 408 based on user inputs received from the input device 450. An output of the polar pattern level 408-2 is input to a digital adder 478. In one or more embodiments, the digital output from the coupled path that includes the second cardioid microphone capsule 410 is input to a polar pattern level 410-2 which is configured to apply a weight to the digital output from the coupled path that includes the second cardioid microphone capsule 410. An output of the polar pattern level 410-2 is input to the digital adder 478.

In various embodiments, the digital output from the coupled path that includes the third cardioid microphone capsule 412 is input to a polar pattern level 412-2 which applies a weight to the digital output from the coupled path that includes the third cardioid microphone capsule 412 based on user inputs received via the input device 450. An output of the polar pattern level 412-2 is input to a digital inverter 412-3. The digital inverter 412-3 is configured to apply a negative or a positive sign to the output of the polar pattern level 412-2. In the illustrated example, an output of the digital inverter 412-3 is input to the digital adder 478.

In some embodiments, the digital output from the coupled path that includes the fourth cardioid microphone capsule 414 is input to a polar pattern level 414-2. The polar pattern level 414-2 is configured to apply a weight to the digital output from the coupled path that includes the fourth cardioid microphone capsule 414. An output of the polar pattern level 414-2 is input to a digital inverter 414-3 which is configured to apply a negative or a positive sign to the output of the polar pattern level 414-2.

In some examples, an output of the digital inverter 414-3 is input to the digital adder 478. The digital adder 478 sums received inputs and outputs a result of summing the inputs to a Universal Serial Bus (USB) 480 or another input/output interface. In some embodiments, the passive audio device coupled to the microphone 452 receives an output (e.g., a fully processed output) from the USB 480 which defines a polar pattern for the microphone 452. For example, the passive audio device coupled to the microphone 452 may include a recording device and the passive audio device can be wirelessly coupled to the microphone 452.

FIG. 5A illustrates a side view 500-1 of a microphone assembly 500 with a forward facing stacked pair of capsules 504, 506 according to one or more embodiments. FIG. 5B illustrates a plan view 500-2 of the microphone assembly 500 with the forward facing stacked pair of capsules 504, 506 according to one or more embodiments. The microphone assembly 500 is illustrated to include a first microphone capsule 504, a second microphone capsule 506, and a base 508. As shown, the first microphone capsule 504 is disposed on the second microphone capsule 506, and the second microphone capsule 506 is disposed on the base 508. In some embodiments, the first and second microphone capsules 504, 506 are different types of microphone capsules. In one example, one of the first and second microphone capsules 504, 506 is a figure eight microphone capsule and the other one of the first and second microphone capsules 504, 506 is an omnidirectional microphone capsule. In a first example, the first microphone capsule 504 is the figure eight microphone capsule and the second microphone capsule 506 is the omnidirectional microphone capsule. In a second example, the first microphone capsule 504 is the omnidirectional microphone capsule and the second microphone capsule 506 is the figure eight microphone capsule.

The first microphone capsule 504 includes a backside 510 and a front face 512. In one or more embodiments, the first microphone capsule 504 is oriented to face in a first direction 514. The second microphone capsule 506 includes a backside 516 and a front face 518. In various embodiments, the second microphone capsule 506 is oriented to face in the first direction 514. The center of the first microphone capsule 504 is separated from the center of the second microphone capsule 506 by a vertical distance 517. In some embodiments, the vertical distance 517 is the same or similar to the vertical distance 331. In other embodiments, the vertical distance 517 is different from the vertical distance 331.

FIG. 5C illustrates an overlapping polar pattern 502 generated by an overlay of a polar pattern generated by each capsule of the forward facing stacked pair of capsules 504, 506 according to one or more embodiments. The overlapping polar pattern 502 includes a figure eight polar pattern 520 and an omnidirectional polar pattern 522. The figure eight polar pattern 520 corresponds to a polar pattern generated by whichever one of first microphone capsule 504 or the second microphone capsule 506 is the figure eight microphone capsule. Similarly, the omnidirectional polar pattern 522 corresponds to a polar pattern generated by whichever one of first microphone capsule 504 or the second microphone capsule 506 is the omnidirectional microphone capsule.

In various embodiments, by applying weights to (e.g., scaling) and/or inverting audio signals generated by the first and second microphone capsules 504, 506 based a difference in the type of microphone capsule (e.g., figure eight polar pattern 520 and the omnidirectional polar pattern 522, respectively), the weighted and/or inverted audio signals are combinable (e.g., summed) in a channel such that a desired polar pattern can be generated for the microphone assembly 500. An example of combining the audio signals generated by the first and second microphone capsules 504, 506 in a channel may include the following:

$$Microphone Assembly Polar Pattern 4 ( MAPP 4 ) = X * F 1 + Y * O 1 ,$$

where: F1 represents the audio signal generated by the first microphone capsule 504 based on the figure eight polar pattern 520; O1 represents the audio signal generated by the second microphone capsule 506 based on the omnidirectional polar pattern 522; X represents a first weight; and Y represents a second weight, where X and Y vary from −1.0 to 1.0. In some embodiments, the first weight X and/or the second weight Y can be less than zero or greater than zero.

In one or more embodiments, a figure eight polar pattern can be formed for the microphone assembly 500 by making the first weight X equal to 1.0 and making the second weight Y equal to zero (e.g., MAPP4=1.0*F1). In certain embodiments, an omnidirectional polar pattern may be formed for the microphone assembly by making the first weight X equal to zero and making the second weight Y equal to 1.0 (e.g., MAPP4=1.0*O1). In some embodiments, a cardioid polar pattern can be formed by making the first weight X equal to 0.5 and making the second weight Y equal to 0.5 (e.g., MAPP4=0.5*F1+0.5*O1). In one or more embodiments, a supercardioid polar pattern may be formed by making the first weight X equal to a positive fraction and by making the second weight Y equal to a positive fraction that is less than X (e.g. MAPP4=0.63*F1+0.37*O1). In various embodiments, a hypercardioid polar pattern can be formed by making the first weight X equal to a positive fraction and by making the second weight Y equal to a positive fraction that is less than X (e.g., MAPP4=0.75*F1+0.25*O1).

FIG. 5D illustrates a user interface 503 for a microphone having the forward facing stacked pair of capsules 504, 506 according to one or more embodiments. As shown, the user interface 503 includes an input device 530 of a microphone 532 which includes the microphone assembly 500. In some embodiments, the input device 530 is rotatable relative to an indicator 534 in both a clockwise direction and a counterclockwise direction. The input device 530 includes user interface elements 535-540 which each correspond to a polar pattern for the microphone 532.

In various embodiments, the user interface element 535 corresponds to the omnidirectional polar pattern 100; the user interface element 536 corresponds to the subcardioid polar pattern 110; the user interface element 537 corresponds to the cardioid polar pattern 104; the user interface element 538 corresponds to the supercardioid polar pattern 108; the user interface element 539 corresponds to the hypercardioid polar pattern 106; and the user interface element 540 corresponds to the figure eight polar pattern 102. In some embodiments, aligning the indicator 534 with an alignment mark of a particular one of the user interface elements 535-540 causes the microphone 532 to utilize or generate a polar pattern corresponding the particular one of the user interface elements 535-540. In one or more embodiments, rotating the input device 530 such that an alignment of the indicator 534 is positioned between alignment marks of first and second ones of the user interface elements 535-540 causes the polar pattern of the microphone 532 to gradually vary between a first polar pattern corresponding to the first one of the user interface elements 535-540 and a second polar pattern corresponding to the second one of the user interface elements 535-540.

FIG. 5E is a schematic view of a microphone control system 500-3 for a microphone having the forward facing stacked pair of capsules 504, 506 according to one or more embodiments. The microphone control system 500-3 is included in the microphone 532 and receives inputs from the first and second microphone capsules 504, 506. A passive audio device (e.g., a recording device) coupled to the microphone 532 receives an output based on the inputs. In some embodiments, the passive audio device can be included in the microphone 532 or the passive audio device can be external to the microphone 532. Regardless of whether the passive audio device is included in the microphone 532 or external to the microphone 532, no additional processing of the output needs to be performed by the passive audio device. For example, the passive audio device can include a speaker with no audio processing resources. As shown, the microphone control system 500-3 includes a codec 550 and a microcontroller unit (MCU) 552. In various embodiments, the codec 550 may be implemented in hardware, software, firmware, or a combination thereof. The MCU 552 can include one or more memories, one or more processors, and one or more input/output interfaces.

The codec 550 is illustrated to include a first switch 504-1 and a second switch 506-1. In some embodiments, the first and second switches 504-1, 506-1 can be opened/closed in response to user inputs received via the input device 530. Opening the first and second switches 504-1, 506-1 decouple the first and second microphone capsules 504, 506 from programmable gain amplifiers (PGA) 554, respectively, and would be effectively seen at the summation process as making the first weight X and the second weight Y equal to zero. Closing the first and second switches 504-1, 506-1 couple the first and second microphone capsules 504, 506 to the PGAs 554, respectively. In various embodiments, the PGA 554 coupled to the first microphone capsule 504 amplifies an input audio signal received from the first microphone capsule 504 and the PGA 554 coupled to the second microphone capsule 506 amplifies an input audio signal received from the second microphone capsule 506. In some examples, the input audio signal received from the first microphone capsule 504 is captured using the omnidirectional polar pattern 100 and the input audio signal received from the second microphone capsule 506 is captured using the figure eight polar pattern 102.

As shown in FIG. 5E, amplified analog outputs from the PGAs 554 are input to analog-to-digital converters (ADCs) 556, and digital outputs from the ADCs 556 are inputs to the MCU 552. In some embodiments, in a coupled path that includes the first microphone capsule 504, a digital output from the ADC 556 is input to the MCU 552. In one or more embodiments, in a coupled path that includes the second microphone capsule 506, a digital output from the ADC 556 is input to the MCU 552.

In the MCU 552, the digital output from the coupled path that includes the first microphone capsule 504 is input to a polar pattern level 504-2. The polar pattern level 504-2 is configured to apply a weight to the digital output from the coupled path that includes the first microphone capsule 504 based on user inputs received via the input device 530. An output of the polar pattern level 504-2 is input to a digital adder 558.

In some embodiments, the digital output from the coupled path that includes the second microphone capsule 506 is input to a polar pattern level 506-2 which is configured to apply a weight to the digital output from the coupled path that includes the second microphone capsule 506. An output of the polar pattern level 506-2 is input to the digital adder 558. The digital adder 558 is configured to sum received inputs and output a result of summing the inputs to a Universal Serial Bus (USB) 560 in some examples. The passive audio device coupled to the microphone 532 receives an output from the USB 560 which defines a polar pattern for the microphone 532 based on user inputs received via the input device 530. In various embodiments, the passive audio device coupled to the microphone 532 includes a recording device and does not include a digital signal processor (DSP).

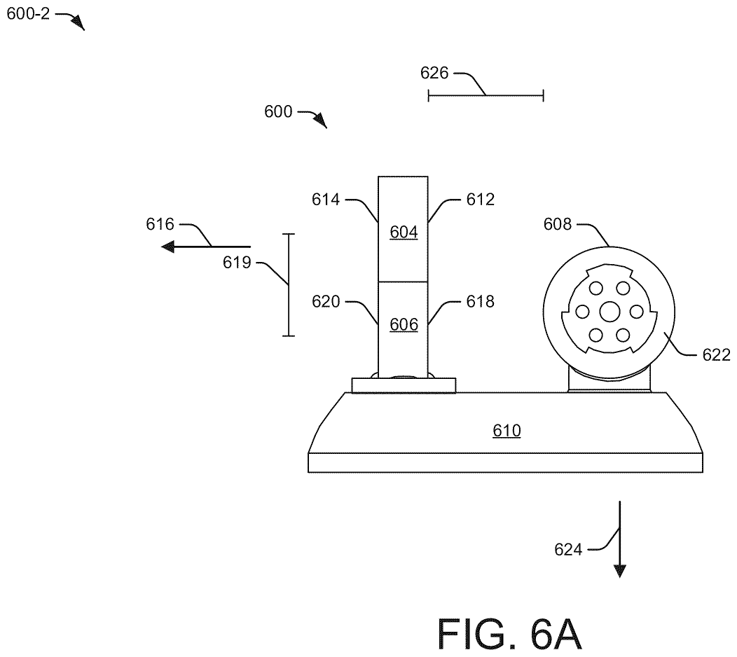

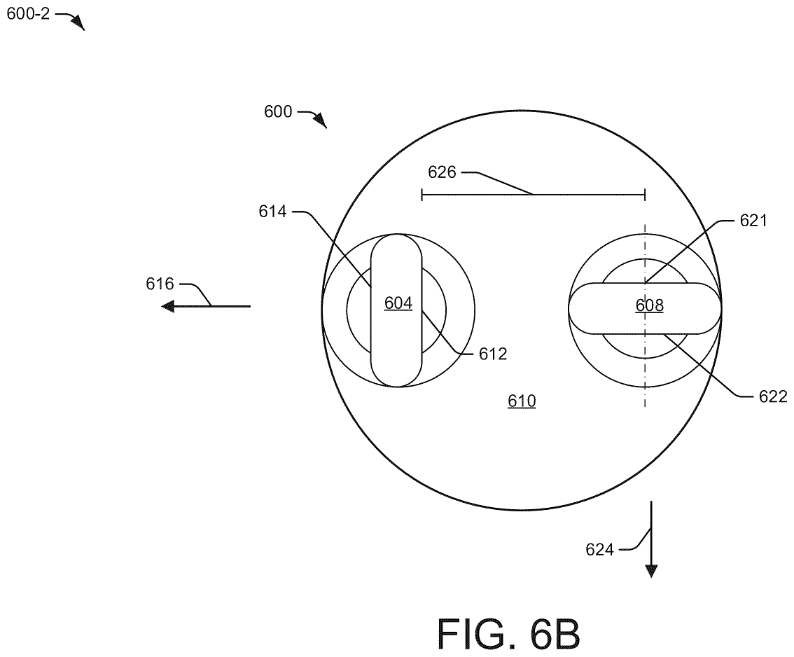

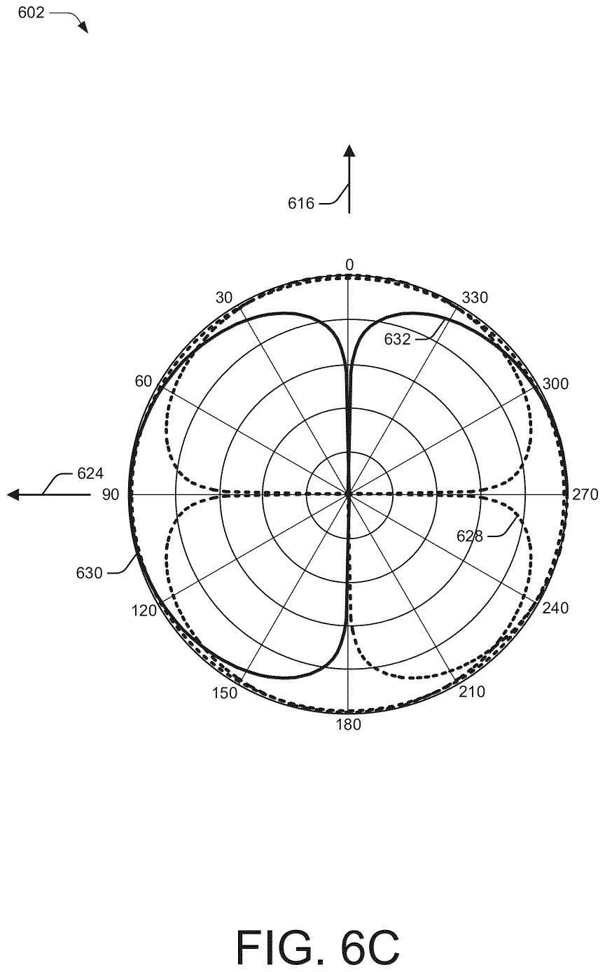

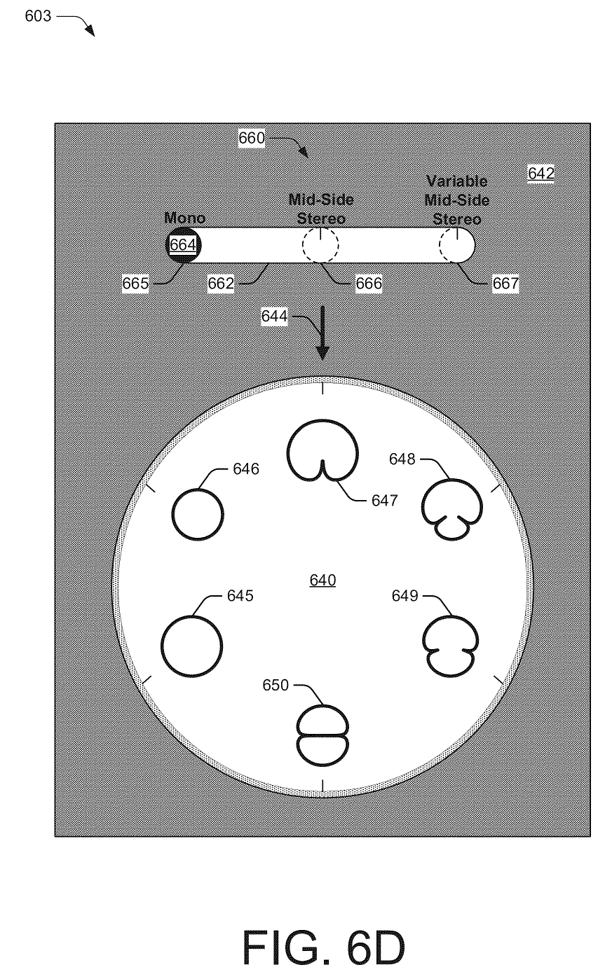

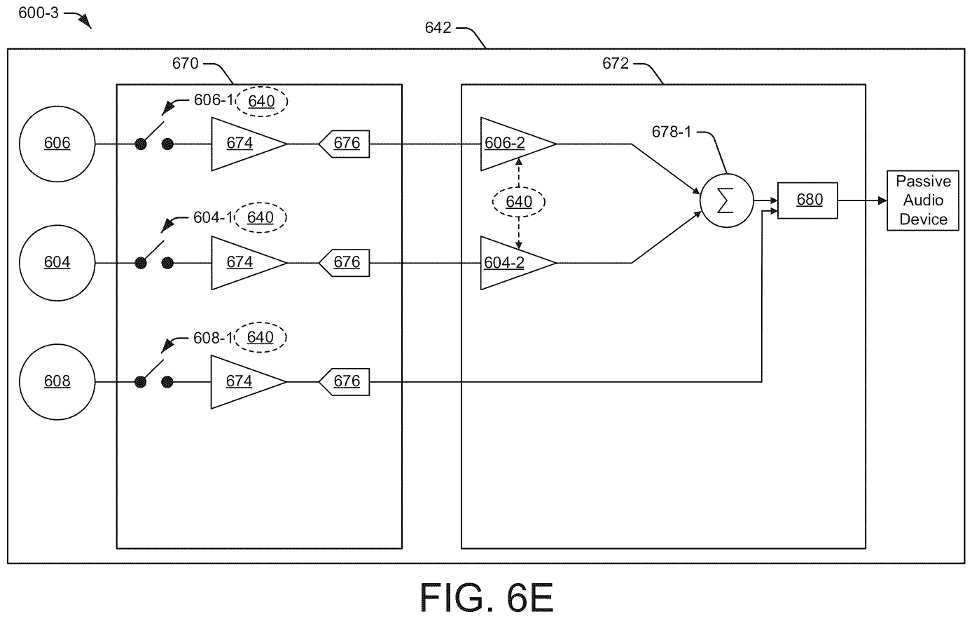

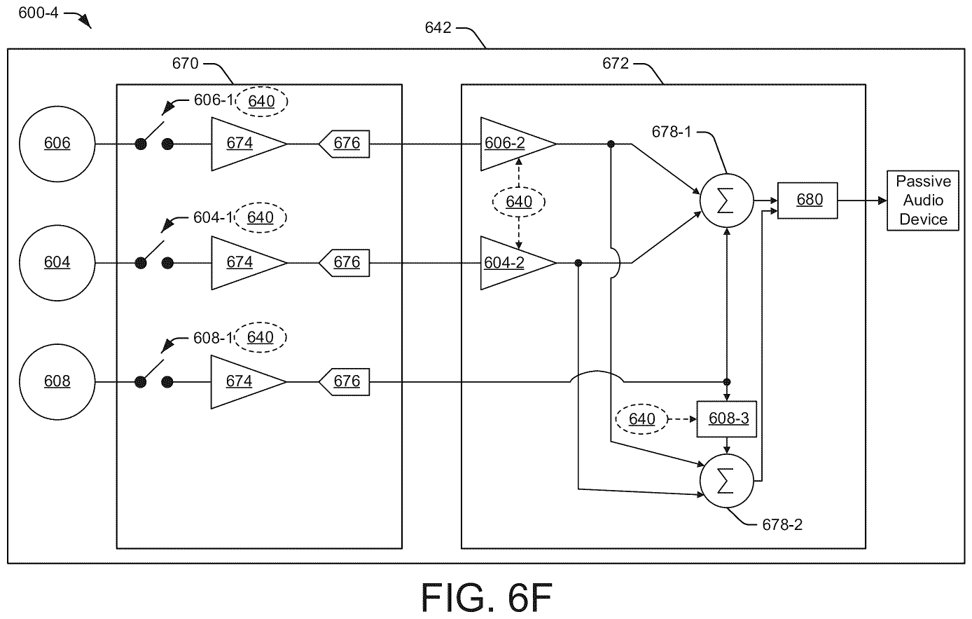

FIG. 6A illustrates a side view 600-1 of a microphone assembly 600 with a forward facing stacked pair of capsules 604, 606 and a side facing capsule 608 according to one or more embodiments. FIG. 6B illustrates a plan view 600-2 of the microphone assembly 600 with the forward facing stacked pair of capsules 604, 606 and the side-facing capsule 608 according to one or more embodiments. The microphone assembly 600 is illustrated to include a first microphone capsule 604, a second microphone capsule 606, a third microphone capsule 608, and a base 610. The first microphone capsule 604 is disposed on the second microphone capsule 606, and the second microphone capsule 606 is disposed on the base 610. The third microphone capsule 608 is illustrated to be disposed on the base 610. In some embodiments, one of the first microphone capsule 604 or the second microphone capsule 606 is a first figure eight microphone capsule and the other one of the first microphone capsule 604 or the second microphone capsule 606 is an omnidirectional microphone capsule. For ease of description, the first microphone capsule 604 may be the first figure eight microphone capsule and the second microphone capsule 606 can be the omnidirectional microphone capsule. In one or more embodiments, the third microphone capsule 608 is a second figure eight microphone capsule. However, one skilled in the art will appreciate that in some embodiments, the first microphone capsule 604, the second microphone capsule 606 and the third microphone capsule 608 microphone capsule may all include the same type of capsule, such as a cardioid microphone capsule.

The first microphone capsule 604 includes a backside 612 and a front face 614, and the first microphone capsule 604 is oriented to face in a first direction 616. The second microphone capsule 606 includes a backside 618 and a front face 620. In some examples, the second microphone capsule 606 is also oriented to face in the first direction 616. In an alternative example in which the first and second microphone capsules 604, 606 include cardioid microphone capsules, then the second microphone capsule 606 is oriented to face in a direction opposite to the first direction 616. The third microphone capsule 608 includes a backside 621 and a front face 622. In various embodiments, the third microphone capsule 608 is oriented to face in a second direction 624. In some examples, the first direction 616 and the second direction 624 are perpendicular or approximately perpendicular (e.g., separated by about 90 degrees). An advantage of the microphone assembly 600 with the forward facing stacked pair of capsules 604, 606 and the side facing capsule 608 is that the first and second directions 616, 624 facilitate multi-channel (e.g., stereo or quasi-stereo) recoding functionality. For example, differences in arrival directions/times of sound recorded with respect to the first and second directions 616, 624 can be leveraged to implement the multi-channel recording functionality. In some embodiments, the microphone assembly 600 can include an output on a single channel that is a blend of outputs of the first and second microphone capsules 604, 606. In other embodiments, the microphone assembly 600 can include multi-channel outputs such as an output via a first channel of an addition of the outputs of the first and second microphone capsules 604, 606 and an output via a second channel of the third microphone capsule 608.

The first and second microphone capsules 604, 606 are separated from the third microphone capsule 608 by a distance 626, which can be measured from the backside 612 to the centerline of the side-facing capsule 608. In some embodiments, the distance 626 is the same as one or more of the distances 222, 330, 438. In other embodiments, the distance 626 is different from one or more of the distances 222, 330, 438. The center of the first microphone capsule 604 is separated from the center of the second microphone capsule 606 by a vertical distance 619. In some embodiments, the center (e.g., centerline) of the third microphone capsule 608 is disposed at a vertical position that is about the mid-point of the vertical distance 619 formed between the first microphone capsule 604 and the second microphone capsule 606.

FIG. 6C illustrates a representation 602 of combinable polar patterns of each capsule in a forward facing stacked pair of capsules 604, 606 and a polar pattern generated by a side facing capsule 608 according to one or more embodiments. As shown, the representation 602 includes a first figure eight polar pattern 628 and an omnidirectional polar pattern 630 which are combinable as variable polar patterns. The combinable polar patterns 628, 630 are depicted using dashed lines to indicate that the first figure eight polar pattern 628 and the omnidirectional polar pattern 630 can be weighted/combined as many different polar patterns which can be output by a first channel of the microphone assembly 600. The representation also includes a second figure eight polar pattern 632 which may be output by a second channel of the microphone assembly 600. In some embodiments, the first figure eight polar pattern 628 corresponds to the polar pattern formed by the first microphone capsule 604, the omnidirectional polar pattern 630 corresponds to the polar pattern formed by the second microphone capsule 606, and the second figure eight polar pattern 632 corresponds to the polar pattern formed by the third microphone capsule 608. The second figure eight polar pattern 632 is rotated 90 degrees relative to the first figure eight polar pattern 628 because the second direction 624 is rotated 90 degrees relative to the first direction 616.

In some embodiments, by applying weights to (e.g., scaling) and/or inverting audio signals generated by the first and second microphone capsules 604, 606, the weighted and/or inverted audio signals are combinable (e.g., summed) in a channel of the microphone assembly 600. For example, the first figure eight polar pattern 628 and the omnidirectional polar pattern 630 can be weighted/combined for output by the first channel of the microphone assembly 600 and the second figure eight polar pattern 632 can be output by the second channel of the microphone assembly 600. An example of combining the audio signals generated by the first and second microphone capsules 604, 606 (and optionally by the third microphone capsule 608) can include the following:

$$Microphone Assembly Polar Pattern 5 ( MAPP 5 ) = X * F 1 + Y * O 1 + Z * F 2 ,$$

where: F1 represents the audio signal generated by the first microphone capsule 604 based on the first figure eight polar pattern 628; O1 represents the audio signal generated by the second microphone capsule 606 based on the omnidirectional polar pattern 630; F2 represents the audio signal generated by the third microphone capsule 608 based on the second figure eight polar pattern 632 which may be output on the first or second channel (e.g., not be summed with the audio signals generated by the first and second microphone capsules 604, 606) in some embodiments; X represents a first weight; Y represents a second weight; and Z represents a third weight, where X, Y, and Z vary from −1.0 to 1.0. In some embodiments, the first weight X, the second weight Y, and/or the third weight Z can be less than zero or greater than zero. In some cases, since the third microphone capsule 608 is optionally required the (Z*F2) term is optionally required.

In one or more embodiments, a figure eight polar pattern may be formed by making the first weight X equal to 1.0 and making the second weight Y and the third weight Z equal to zero (e.g., MAPP5=1.0*F1). In some examples, an omnidirectional polar pattern can be formed by making the second weight Y equal to 1.0 and making the first weight X and the third weight Z equal to zero (e.g., MAPP5=1.0*O1). In some embodiments, a cardioid polar pattern can be formed by making the first weight X and the second weight Y equal to 0.5 and making the third weight Z equal to zero (e.g., MAPP5=0.5*F1+0.5*O1). In certain embodiments, a supercardioid polar pattern may be formed by making the first weight X equal to a positive fraction, making the second weight Y equal to a positive fraction that is less than X, and making the third weight Z equal to zero (e.g., MAPP5=0.63*F1+0.37*O1) In one example, a hypercardioid polar pattern can be formed by making the first weight X equal to a positive fraction, making the second weight Y equal to a positive fraction that is less than X, and making the third weight Z equal to zero (e.g., MAPP5=0.75*F1+0.25*O1). In various embodiments, the addition of the third microphone capsule 608 enables stereo functionality for the microphone assembly 600. In some embodiments, traditional mid-side stereo may be formed for a first channel by making the first weight X and the second weight Y equal to zero and making the third weight Z equal to 1.0 (e.g., MAPP5 C1=1.0*F2). In some examples, traditional mid-side stereo may be formed for a second channel by making the first weigh X and the second weight Y equal to 0.5 and making the third weight Z equal to zero (e.g., MAPP5 C2=(0.5*F1+0.5*O1). In some embodiments, variable mid-side stereo for a first channel may be formed by making the first weight X and the second weight Y equal to zero and making the third weight Z equal to 1.0 (e.g., MAPP5 C1=1.0*F2). In various embodiments, variable mid-side for a second channel may be formed by making the first weight X equal to 1.0 and making the second weight Y and the third weigh Z equal to zero; or by making the second weight Y equal to 1.0 and making the first weight X and the third weight Z equal to zero; or by making the first weight X equal to a positive fraction, making the second weight Y equal to a positive fraction that is less than X, and making the third weight Z equal to zero; or by making the first weight X equal to a positive fraction, making the second weight Y equal to a positive fraction that is less than X, and making the third weight Z equal to zero (e.g., MAPP5 C2=(1.0*F1) or (1.0*O1) or (0.63*F1+0.37*O1) or (0.75*F1+0.25*O1), respectively).

FIG. 6D illustrates a user interface 603 for a microphone having the forward facing stacked pair of capsules 604, 606 and the side-facing capsule 608 according to one or more embodiments. In the illustrated example, the user interface 603 includes an input device 640 of a microphone 642 which includes the microphone assembly 600. In one or more embodiments, the input device 640 is rotatable relative to an indicator 644 in both a clockwise direction and a counterclockwise direction. The input device 640 includes user interface elements 645-650 which each correspond to a polar pattern for the microphone 642.

In various embodiments, the user interface element 645 corresponds to the omnidirectional polar pattern 100; the user interface element 646 corresponds to the subcardioid polar pattern 110; the user interface element 647 corresponds to the cardioid polar pattern 104; the user interface element 648 corresponds to the supercardioid polar pattern 108; the user interface element 649 corresponds to the hypercardioid polar pattern 106; and the user interface element 650 corresponds to the figure eight polar pattern 102. In some embodiments, aligning the indicator 644 with an alignment mark of a particular one of the user interface elements 645-650 causes the microphone 642 to utilize or generate a polar pattern corresponding the particular one of the user interface elements 645-650. In one or more embodiments, rotating the input device 640 such that an alignment of the indicator 644 is positioned between alignment marks of first and second ones of the user interface elements 645-650 causes the polar pattern of the microphone 642 to gradually vary between a first polar pattern corresponding to the first one of the user interface elements 645-650 and a second polar pattern corresponding to the second one of the user interface elements 645-650.

In certain embodiments, the user interface 603 includes a slide bar 660 which is usable to select a recording mode for the microphone 642. As shown, the slide bar 660 includes a channel 662 and a slider 664. The slider 664 actuates within the channel 662 between input zones 665-667 which each correspond to a different recording mode for the microphone 642. In the illustrated example, the slider 664 is disposed in the input zone 665 which selects a mono recording mode (e.g., one channel) for the microphone 642. In some examples, actuating the slider 664 into the input zone 666 selects a mid-side stereo recording mode (e.g., two channels) for the microphone 642. For example, the microphone 642 may be a stereo microphone. In other examples, actuating the slider 664 into the input zone 667 selects a variable mid-side stereo recording mode (e.g., two channels) for the microphone 642.

FIG. 6E is a schematic view of a microphone control system 600-3 for a microphone having the forward facing stacked pair of capsules 604, 606 and the side-facing capsule 608 according to one or more embodiments. The microphone control system 600-3 is included in the microphone 642. The microphone control system 600-3 receives inputs from the first, second, and third microphone capsules 604, 606, 608. As shown, a passive audio device coupled to the microphone 642 receives an output based on the inputs. For example, the passive audio device receives the output passively without processing the output. The passive audio device can include a computing device, a standalone recording device, a speaker, or another type of audio device. In some examples, the passive audio device is included in the microphone 642. In other examples, the passive audio device is external to the microphone 642.

The microphone control system 600-3 is illustrated to include a codec 670 and a microcontroller unit (MCU) 672. In some embodiments, the codec 670 may be implemented in hardware, software, firmware, or a combination thereof. The MCU 362 includes one or more memories, one or more processors, and one or more input/output interfaces. In the illustrated example, the codec 670 includes a first switch 604-1, a second switch 606-1, and a third switch 608-1.

In one or more embodiments, the first, second, and third switches 604-1, 606-1, 608-1 may be opened/closed in response to user inputs received via the input device 640. Opening the first, second, and third switches 604-1, 606-1, 608-1 decouple the first, second, and third microphone capsules 604, 606, 608 from programmable gain amplifiers (PGAs) 674, respectively, and would be effectively seen at the summation process as making the first weight X, the second weight Y, and the third weight Z equal to zero. Closing the first, second, and third switches 604-1, 606-1, 608-1 couple the first, second, and third microphone capsules 604, 606, 608 to the PGAs 674, respectively.

Within the codec 670, amplified analog outputs from the PGAs 674 are input to analog-to-digital converters (ADCs) 676, and digital outputs from the ADCs 676 are inputs to the MCU 672. In one or more embodiments, in a coupled path that includes the first microphone capsule 604, a digital output from the ADC 676 is input to the MCU 672. In some embodiments, in a coupled path that includes the second microphone capsule 606, a digital output from the ADC 676 is input to the MCU 672. In various examples, in a coupled path that includes the third microphone capsule 608, a digital output from the ADC 676 is input to the MCU 672.

In some embodiments, the digital output from the coupled path that includes the first microphone capsule 604 is input to a polar pattern level 604-2. The polar pattern level 604-2 is configured to apply a weight to the digital output from the coupled path that includes the first microphone capsule 604. An output of the first polar pattern level 604-2 is input to a first digital adder 678-1 and input to a second digital adder 678-2. In various embodiments, the digital output from the coupled path that includes the second microphone capsule 606 is input to a polar pattern level 606-2 which applies a weight to the digital output from the coupled path that includes the second microphone capsule 606. An output of the polar pattern level 606-2 is input to the first digital adder 678-1 and input to the second digital adder 678-2. In certain embodiments, the digital output from the coupled path that includes the third microphone capsule 608 is input to a Universal Serial Bus (USB) 680. The first digital adder 678-1 sums received inputs and outputs a result of summing the inputs to the USB 680. The output of the first digital adder 678-1 corresponds to a first channel and the output from the coupled path that includes the third microphone capsule 608 corresponds to a second channel. In some embodiments, the passive audio device coupled to the microphone 642 passively receives an output from the USB 680 which defines a polar pattern for the microphone 642. For example, the passive audio device coupled to the microphone 642 may include a recording device.

FIG. 6F is a schematic view an alternative configuration of a microphone control system 600-4 for a microphone having the forward facing stacked pair of capsules 604, 606 and the side-facing capsule 608 according to one or more embodiments. Unlike the microphone control system 600-3 illustrated in FIG. 6E in which the digital output from the coupled path that includes the third microphone capsule 608 has a direct path to the USB 680, in the alternative configuration of the microphone control system 600-4, the digital output from the coupled path that includes the third microphone capsule 608 is input to the first digital adder 678-1 and a digital inverter 608-3. The digital inverter 608-3 is configured to apply a negative or a positive sign to the digital output from the coupled path that includes the third microphone capsule 608.

An output of the digital inverter 608-3 is input to the second digital adder 678-2. The first digital adder 678-1 sums received inputs and outputs a result of summing the inputs to the USB 680. The second digital adder 678-2 sums received inputs and outputs a result of summing the inputs to the USB 680. In one or more embodiments, the output of the first digital adder 678-1 corresponds to a first channel and the output of the second digital adder 678-2 corresponds to a second channel. In some embodiments, the passive audio device coupled to the microphone 642 passively receives an output from the USB 680 which defines a polar pattern for the microphone 642. In one or more examples, the passive audio device coupled to the microphone 642 may include a recording device.

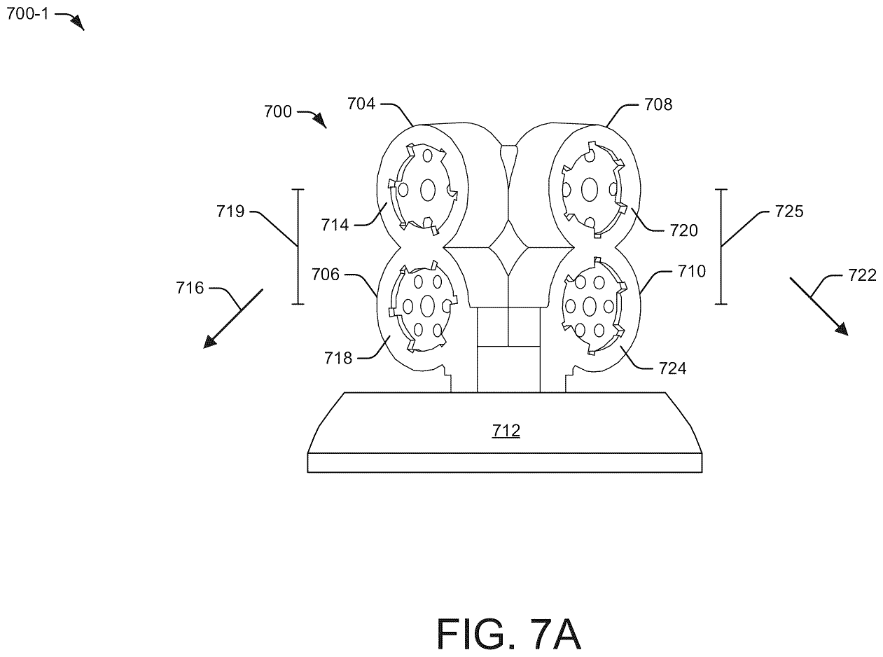

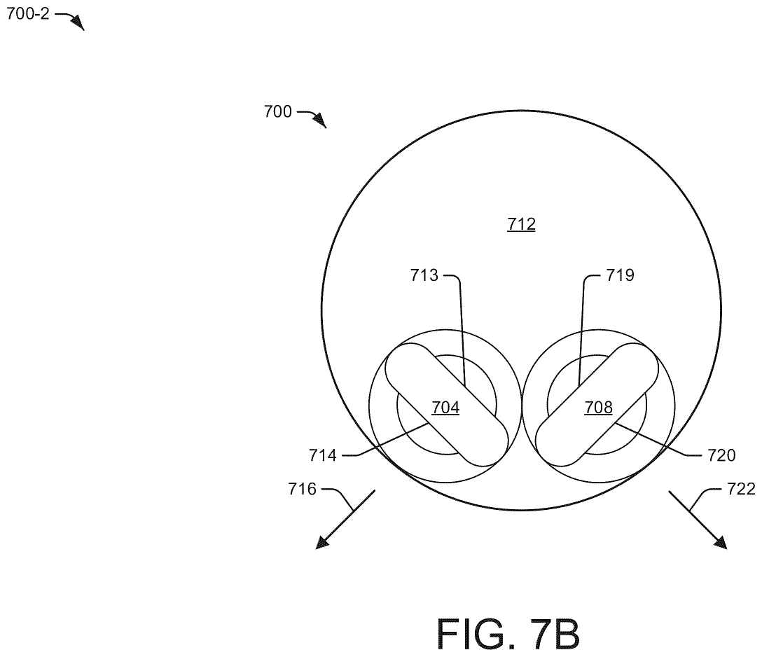

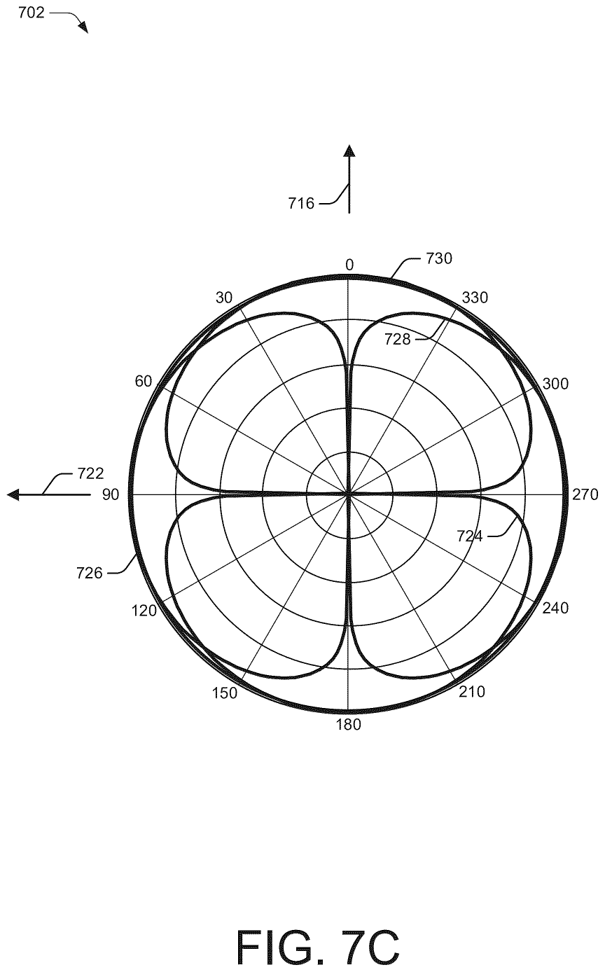

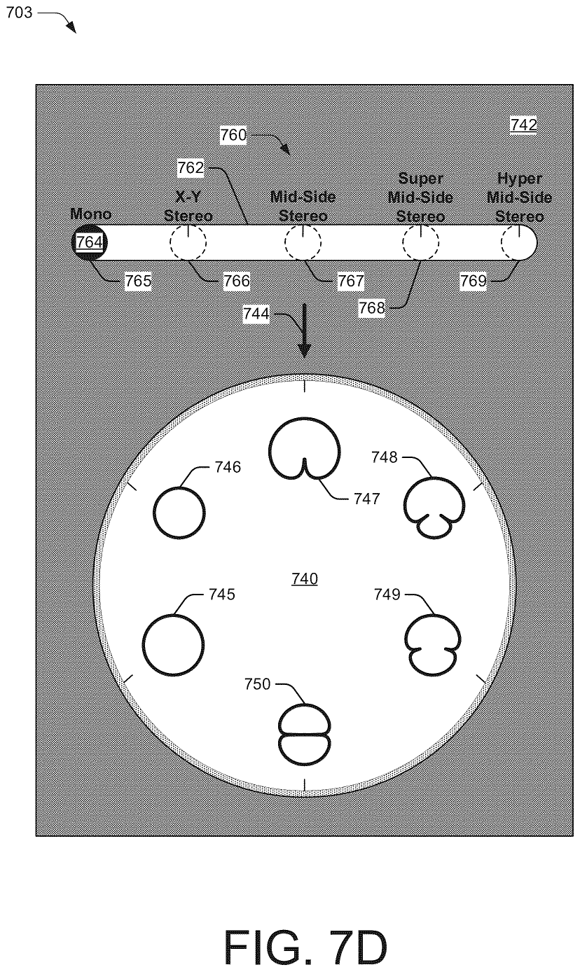

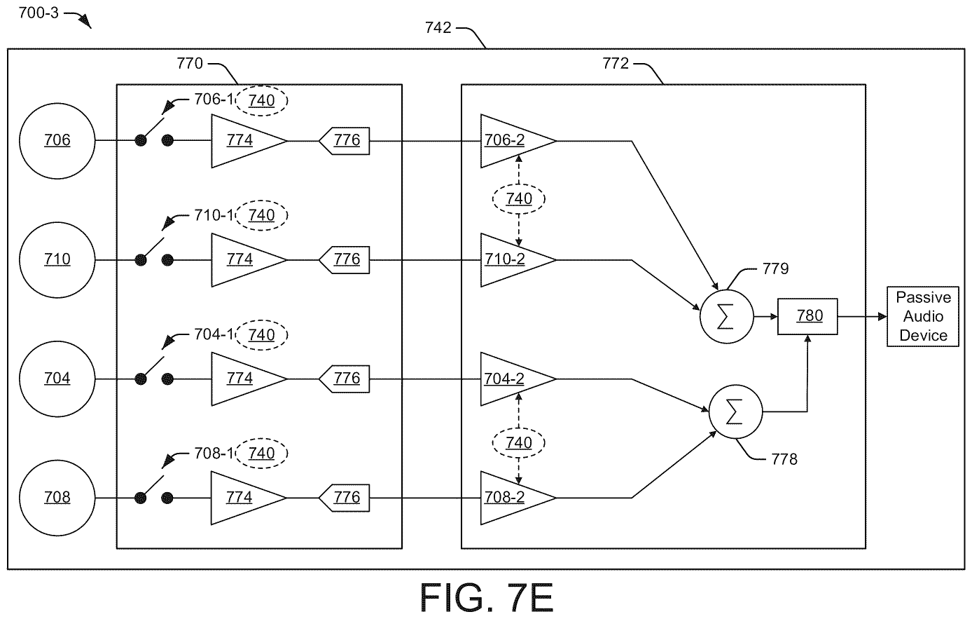

FIG. 7A illustrates a front view 700-1 of a microphone assembly 700 with a first stacked pair of capsules 704, 706 and a second stacked pair of capsules 708, 710 according to one or more embodiments. FIG. 7B illustrates a plan view 700-2 of the microphone assembly 700 with the first stacked pair of capsules 704, 706 and the second stacked pair of capsules 708, 710 according to one or more embodiments. The microphone assembly 700 can include a first figure eight microphone capsule 704, a first omnidirectional microphone capsule 706, a second figure eight microphone capsule 708, a second omnidirectional microphone capsule 710, and a base 712. The first figure eight microphone capsule 704 is disposed on the first omnidirectional microphone capsule 706. As shown, the first omnidirectional microphone capsule 706 is disposed on the base 712. Similarly, the second figure eight microphone capsule 708 is disposed on the second omnidirectional microphone capsule 710, and the second omnidirectional microphone capsule 710 is disposed on the base 712. In some embodiments, a relative order of the first and second figure eight microphone capsules 704, 708 and the first and second omnidirectional microphone capsules 706, 710 may be reversed such that the first and second omnidirectional microphone capsules 706, 710 are disposed on the first and second figure eight microphone capsules 704, 708, respectively, which are disposed on the base 712.

The first figure eight microphone capsule 704 includes a backside 713 and a front face 714. In some embodiments, the first figure eight microphone capsule 704 is oriented to face in a first direction 716. The first omnidirectional microphone capsule 706 includes a backside (not shown) and a front face 718, and the first omnidirectional microphone capsule 706 may be oriented to face in the first direction 716. The second figure eight microphone capsule 708 includes a backside 719 and a front face 720. In the illustrated example, the second figure eight microphone capsule 708 is oriented to face in a second direction 722. Like the microphone assembly 600, an advantage of the microphone assembly 700 with the first stacked pair of capsules 704, 706 and the second stacked pair of capsules 708, 710 is that the first and second directions 716, 722 facilitate multi-channel (e.g., stereo) recoding functionality. Differences in arrival directions/times of sound recorded with respect to the first and second directions 716, 722 can be leveraged to implement stereo recording functionality.

In some embodiments, the first direction 716 and the second direction 722 are perpendicular or approximately perpendicular (e.g., separated by about 90 degrees). The second omnidirectional microphone capsule 710 includes a backside (not shown) and a front face 724. In various embodiments, the second omnidirectional microphone capsule 710 is oriented to face in the second direction 722. The center of the first figure eight microphone capsule 704 is separated from the center of the first omnidirectional microphone capsule 706 by a vertical distance 719. Similarly, the center of the second figure eight microphone capsule 708 is separated from the center of the second omnidirectional microphone capsule 710 by a vertical distance 725. In some embodiments, the vertical distances 719, 725 are the same distance. In other embodiments, the vertical distances 719, 725 are different distances.

FIG. 7C illustrates an overlapping polar pattern 702 generated by an overlay of a polar pattern generated by each of the first stacked pair of capsules 704, 706 and a polar pattern generated by each of the second stacked pair of capsules 708, 710 according to one or more embodiments. The overlapping polar pattern 702 includes a first figure eight polar pattern 724, a first omnidirectional polar pattern 726, a second figure eight polar pattern 728, and a second omnidirectional polar pattern 730. In some embodiments, the first figure eight polar pattern 724 corresponds to the polar pattern formed by the first figure eight microphone capsule 704; the first omnidirectional polar pattern 726 corresponds to the polar pattern formed by the first omnidirectional microphone capsule 706; the second figure eight polar pattern 728 corresponds to the polar pattern formed by the second figure eight microphone capsule 708; and the second omnidirectional polar pattern 730 corresponds to the polar pattern formed by the second omnidirectional microphone capsule 710.

The second figure eight polar pattern 728 is rotated 90 degrees relative to the first figure eight polar pattern 724 because the second direction 722 is rotated 90 degrees relative to the first direction 716. Similarly, the second omnidirectional polar pattern 730 is rotated 90 degrees relative to the first omnidirectional polar pattern 726 because the second direction 722 is rotated 90 degrees relative to the first direction 716. In one or more embodiments, by applying weights to (e.g., scaling) and/or inverting audio signals generated by the first figure eight, first omnidirectional, second figure eight, and second omnidirectional microphone capsules 704, 706, 708, 710 based on the first figure eight polar pattern 724, the first omnidirectional polar pattern 726, the second figure eight polar pattern 728, and the second omnidirectional polar pattern 730, respectively, the weighted and/or inverted audio signals are combinable (e.g., summed) in a channel such that a desired polar pattern can be generated for the microphone assembly 700. An example of combining the audio signals generated by the first figure eight, first omnidirectional, second figure eight, and second omnidirectional microphone capsules 704, 706, 708, 710 in a channel may include the following:

$$Microphone Assembly Polar Pattern 6 ( MAPP 6 ) = X * F 1 + Y * O 1 + Z * F 2 + W * O 2 ,$$

where: F1 represents the audio signal generated by the first figure eight microphone capsule 704 based on the first figure eight polar pattern 724; O1 represents the audio signal generated by the first omnidirectional microphone capsule 706 based on the first omnidirectional polar pattern 726; F2 represents the audio signal generated by the second figure eight microphone capsule 708 based on the second figure eight polar pattern 728; O2 represents the audio signal generated by the second omnidirectional microphone capsule 710 based on the second omnidirectional polar pattern 730; X represents a first weight; Y represents a second weight; Z represents a third weight; and W represents a fourth weight, where X, Y, Z, and W vary from −1.0 to 1.0. In some embodiments, the first weight X, the second weight Y, the third weight Z, and/or the fourth weight can be less than zero or greater than zero.

In one or more embodiments, a mono omnidirectional polar pattern may be formed by making the second weight Y equal to 1.0 and making the first weight X, the third weight Z, and the fourth weight W equal to zero; or by making the second weight Y and the fourth weight W equal to 0.5 and making the first weight X and the third weight Z equal to zero (e.g., MAPP6=(1.0*O1) or (0.5*O1+0.5*O2), respectively). In some embodiments, a mono cardioid polar pattern for the microphone assembly 700 can be formed by making the first weight X, the second weight Y, the third weight Z, and the fourth weight W equal to a positive fraction such as 0.25 (e.g., MAPP6=0.25*F1+0.25*F2+0.25*O1+0.25*O2). With a 45 degree rotation of the microphone assembly 700, a mono cardioid polar pattern can be formed by making the first weight X and the second weight Y equal to 0.5 and making the third weight Z and the fourth weight Z equal to zero (e.g., MAPP6=0.5*F1+0.5*O1). In some examples, a mono supercardioid polar pattern may be formed by making the first weight X equal a positive fraction, making the second weight Y a positive fraction that is less than X, making the third weight Z a positive fraction, and making the fourth weight W a positive fraction that is less than Z; or by making the first weight X a positive fraction, making the third weight Z a positive fraction that is less than X, and making the second weight Y and the fourth weight Z equal to zero (e.g., MAPP6=(0.32*F1+0.32*F2+0.18*O1+0.18*O2) or (0.63*F1+0.37*F2), respectively), various embodiments, a mono hypercardioid polar pattern can be formed for the microphone assembly 700 by making the first weight X a positive fraction, making the second weight Y a positive fraction that is less than X, making the third weight Z a positive fraction, and making the fourth weight W a positive fraction that is less than Z; or by making the first weight X a positive fraction, making the third weight Z a positive fraction that is less than X, and making the second weight Y and the fourth weight W equal to zero (e.g., MAPP6=(0.38*F1+0.38*F2+0.12*O1+0.12*O2) or (0.75*F1+0.25*F2), respectively). In one or more embodiments, a mono figure eight polar pattern may be formed by making the first weight X equal to 0.5, making the third weight Z equal to 0.5, and making the second weight Y and the fourth weight W equal to zero; or by making the first weight X equal to 1.0 and making the second weight Y, the third weight Z, and the fourth weight W equal to zero (e.g., MAPP6=(0.5*F1+0.5*F2) or (1.0*F1), respectively).

In some examples, an X-Y stereo cardioid polar pattern for a first channel may be formed by making the first weight X equal to 0.5, making the second weight Y equal to 0.5, and making the third weight Z and the fourth weight W equal to zero (e.g., MAPP6 C1=(0.5*F1+0.5*O1)). In one or more examples, an X-Y stereo cardioid polar pattern for a second channel may be formed by making the third weight Z equal to 0.5, making the fourth weight W equal to 0.5, and making the first weight X and the second weight Y equal to zero (e.g., MAPP6 C2=(0.5*F2+0.5*O2)). For example, an X-Y stereo supercardioid polar pattern for a first channel may be formed by making the first weight X a positive fraction, making the second weight Y a positive fraction that is less than X, and making the third weight Z and the fourth weight W equal to zero (e.g., MAPP6 C1=(0.63*F1+0.37*O1)). In certain embodiments, an X-Y stereo supercardioid polar pattern for a second channel may be formed by making the third weight Z equal to a positive fraction, making the fourth weight W a positive fraction that is less than Z, and making the first weight X and the second weight Y equal to zero (e.g., MAPP6 C2=(0.63*F2+0.37*O2)).

In some embodiments, an X-Y stereo hypercardioid polar pattern for a first channel can be formed by making the first weight X a positive fraction, making the second weight Y a positive fraction that is less than X, and making the third weight Z and the fourth weight W equal to zero (e.g., MAPP6 C1=(0.75*F1+0.25*O1)). In one or more embodiments, an X-Y stereo hypercardioid polar pattern for a second channel can be formed by making the third weight Z a positive fraction, making the fourth weight W a positive fraction that is less than Z, and making the first weight X and the second weight Y equal to zero (e.g., MAPP6 C2=(0.75*F2+0.25*O2)). In various examples, an X-Y stereo figure eight (Blumlein) polar pattern for a first channel may be formed by making the first weight X equal to 1.0 and making the second weight Y, the third weight Z, and the fourth weight W equal to zero (e.g., MAPP6 C1=(1.0*F1)). In one or more embodiments, an X-Y stereo figure eight (Blumlein) polar pattern for a second channel may be formed by making the third weight Z equal to 1.0 and making the first weight X, the second weight Y, and the fourth weight W equal to zero (e.g., MAPP6 C2=(1.0*F2)).

In some embodiments, a traditional mid-side stereo polar pattern for a first channel may be formed by making the first weight X equal to 0.5, making the second weight Y equal to 0.5, and making the third weight Z and the fourth weight W equal to zero (e.g., MAPP6 C1=(0.5*F1+0.5*O1)). In various embodiments, a traditional mid-side stereo polar pattern for a second channel may be formed by making the third weight Z equal to 1.0 and making the first weight X, the second weight Y, and the fourth weight W equal to zero (e.g., MAPP6 C2=(1.0*F2)). In certain embodiments, a super mid-side stereo polar pattern for a first channel can be formed by making the first weight X a positive fraction, making the second weight Y a positive fraction that is less than X, and making the third weight Z and the fourth weight W equal to zero (e.g., MAPP6 C1=(0.63*F1+0.37*O1)). In some examples, a super mid-side stereo polar pattern for a second channel can be formed by making the third weight Z equal to 1.0 and making the first weight X, the second weight Y, and the fourth weight W equal to zero (e.g., MAPP6 C2=(1.0*F2)). In one or more embodiments, a hyper mid-side stereo polar pattern for a first channel can be formed by making the first weight X a positive fraction, making the second weight Y a positive fraction that is less than X, and making the third weight Z and the fourth weight W equal to zero (e.g., MAPP6 C1=(0.75*F1+0.25*O1)). In some embodiments, a hyper mid-side stereo polar pattern for a second channel can be formed by making the third weight Z equal to 1.0 and making the first weight Z, the second weight Y, and the fourth weight W equal to zero (e.g., MAPP6 C2=(1.0*F2)).

FIG. 7D illustrates a user interface 703 for a microphone having the first stacked pair of capsules 704, 706 and the second stacked pair of capsules 708, 710 according to one or more embodiments. As shown, the user interface 703 includes an input device 740 of a microphone 742, which includes the microphone assembly 700. In some embodiments, the input device 740 is rotatable relative to an indicator 744 in both a clockwise direction and a counterclockwise direction. The input device 740 includes user interface elements 745-750 which each correspond to a polar pattern for the microphone 742.

In one or more embodiments, the user interface element 745 corresponds to the omnidirectional polar pattern 100; the user interface element 746 corresponds to the subcardioid polar pattern 110; the user interface element 747 corresponds to the cardioid polar pattern 104; the user interface element 748 corresponds to the supercardioid polar pattern 108; the user interface element 749 corresponds to the hypercardioid polar pattern 106; and the user interface element 750 corresponds to the figure eight polar pattern 102. In some embodiments, aligning the indicator 744 with an alignment mark of a particular one of the user interface elements 745-750 causes the microphone 742 to utilize or generate a polar pattern corresponding the particular one of the user interface elements 745-750. In one or more embodiments, rotating the input device 740 such that an alignment of the indicator 744 is positioned between alignment marks of first and second ones of the user interface elements 745-750 causes the polar pattern of the microphone 742 to gradually vary between a first polar pattern corresponding to the first one of the user interface elements 745-750 and a second polar pattern corresponding to the second one of the user interface elements 745-750.

In certain embodiments, the user interface 703 includes a slide bar 760, which is usable to select a recording mode for the microphone 742. As shown, the slide bar 760 includes a channel 762 and a slider 764. The slider 764 actuates within the channel 762 between input zones 765-769 which each correspond to a different recording mode for the microphone 742. In the illustrated example, the slider 764 is disposed in the input zone 765, which selects a mono recording mode (e.g., one channel) for the microphone 742. In various embodiments, actuating the slider 764 into the input zone 766 selects an X-Y stereo recording mode (e.g., two channels) for the microphone 742. In one or more embodiments, the microphone 742 is a stereo microphone. In some embodiments, actuating the slider 764 into the input zone 767 selects a mid-side stereo recording mode (e.g., two channels) for the microphone 742. For example, actuating the slider 764 into the input zone 768 selects a super mid-side stereo recording mode (e.g., two channels) for the microphone 742. In one or more embodiments, actuating the slider 764 into the input zone 769 selects a hyper mid-side stereo recording mode (e.g., two channels) for the microphone 742.

FIG. 7E is a schematic view of a microphone control system 700-3 for a microphone having the first stacked pair of capsules 704, 706 and the second stacked pair of capsules 708, 710 according to one or more embodiments. The microphone control system 700-3 is included in the microphone 742, and the microphone control system 700-3 receives inputs from the first figure eight microphone capsule 704, the first omnidirectional microphone capsule 706, the second figure eight microphone capsule 708, and the second omnidirectional microphone capsule 710. In the illustrated example, a passive audio device (e.g., a recording device) coupled to the microphone 742 receives an output based on the inputs. The passive audio device is “passive” because the passive audio device passively receives the output without performing digital signal processing on the received output. The passive audio device can be included in the microphone 742 (as shown in FIG. 7E) or the passive audio device may be external to the microphone 742.

The microphone control system 700-3 includes a codec 770 and a microcontroller unit (MCU) 772. In various embodiments, the codec 770 may be implemented in hardware, software, firmware, or a combination thereof. The MCU 772 includes one or more memories, one or more processors, and one or more input/output interfaces. As shown, the codec 470 includes a first switch 704-1, a second switch 706-1, a third switch 708-1, and a fourth switch 710-1. In some embodiments, the first, second, third, and fourth switches 704-1, 706-1, 708-1, 710-1 can be opened/closed in response to user inputs received via the input device 740.

Opening the first switch 704-1 decouples the first figure eight microphone capsule 704 from a programmable gain amplifier (PGA) 774, and closing the first switch 704-1 couples the first figure eight microphone capsule 704 to the PGA 774. In some embodiments, the PGA 774 amplifies an input audio signal received from the first figure eight microphone capsule 704. Opening the second switch 706-1 decouples the first omnidirectional microphone capsule 706 from a PGA 774, and closing the second switch 706-1 couples the first omnidirectional microphone capsule 706 to the PGA 774. In one or more embodiments, the PGA 774 amplifies an input audio signal received from the first omnidirectional microphone capsule 706.

Opening the third switch 708-1 decouples the second figure eight microphone capsule 708 from a PGA 774, and closing the third switch 708-1 couples the second figure eight microphone capsule 708 to the PGA 774. In certain embodiments, the PGA 774 amplifies an input audio signal received from the second figure eight microphone capsule 708. Opening the fourth switch 710-1 decouples the second omnidirectional microphone capsule 710 from a PGA 774, and closing the fourth switch 710-1 couples the second omnidirectional microphone capsule 710 to the PGA 774. In some embodiments, the PGA 774 amplifies an input audio signal received from the second omnidirectional microphone capsule 710.

In some embodiments, within the codec 770, amplified analog outputs from the PGAs 774 are input to analog-to-digital converters (ADCs) 776, and digital outputs from the ADCs 776 are inputs to the MCU 772. In various embodiments, in a coupled path that includes the first figure eight microphone capsule 704, a digital output from the ADC 676 is input to the MCU 772. In one or more embodiments, in a coupled path that includes the first omnidirectional microphone capsule 706, a digital output from the ADC 776 is input to the MCU 772. In some embodiments, in a coupled path that includes the second figure eight microphone capsule 708, a digital output from the ADC 776 is input to the MCU 772. In various examples, in a coupled path that includes the second omnidirectional microphone capsule 710, a digital output from the ADC 776 is input to the MCU 772.

In one or more embodiments, the digital output from the coupled path that includes the first figure eight microphone capsule 704 is input to a polar pattern level 704-2 which is configured to apply a weight to the digital output from the coupled path that includes the first figure eight microphone capsule 704. An output of the polar pattern level 704-2 is input to a digital adder 778 of a first channel (e.g., the first channel can include a first variable polar pattern). In some embodiments, the digital output from the coupled path that includes the first omnidirectional microphone capsule 706 is input to a polar pattern level 706-2. The polar pattern level 706-2 applies a weight to the digital output from the coupled path that includes the first omnidirectional microphone capsule 706. An output of the polar pattern level 706-2 is input to a digital adder 779 of a second channel (e.g., the second channel may include a second variable polar pattern).

In various embodiments, the digital output from the coupled path that includes the second figure eight microphone capsule 708 is input to a polar pattern level 708-2, which applies a weight to the digital output from the coupled path that includes the second figure eight microphone capsule 708. An output of the polar pattern level 708-2 is input to the digital adder 778 of the first channel. In certain embodiments, the digital output from the coupled path that includes the second omnidirectional microphone capsule 710 is input to a polar pattern level 710-2. The polar pattern level 710-2 applies a weight to the digital output from the coupled path that includes the second omnidirectional microphone capsule 710 (e.g., based on user inputs received via the input device 740). An output of the polar pattern level 710-2 is input to the digital adder 779 of the second channel. The first and second channels may have outputs based on the same type of polar pattern, for example, the first channel has an output based on an omnidirectional polar pattern formed by the first stacked pair of capsules 704, 706 and the second channel has an output based on an omnidirectional polar pattern formed by the second stacked pair of capsules 708, 710. The digital adders 778, 779 sum received inputs and output results of summing the inputs to a Universal Serial Bus (USB) 780 or another input/output interface. In some embodiments, the passive audio device coupled to the microphone 742 receives an output from the USB 780 which defines a polar pattern for the microphone 742. Notably, the passive audio device receives the output from the USB 780 as a fully processed output. In one or more embodiments, the passive audio device coupled to the microphone includes a recording device.

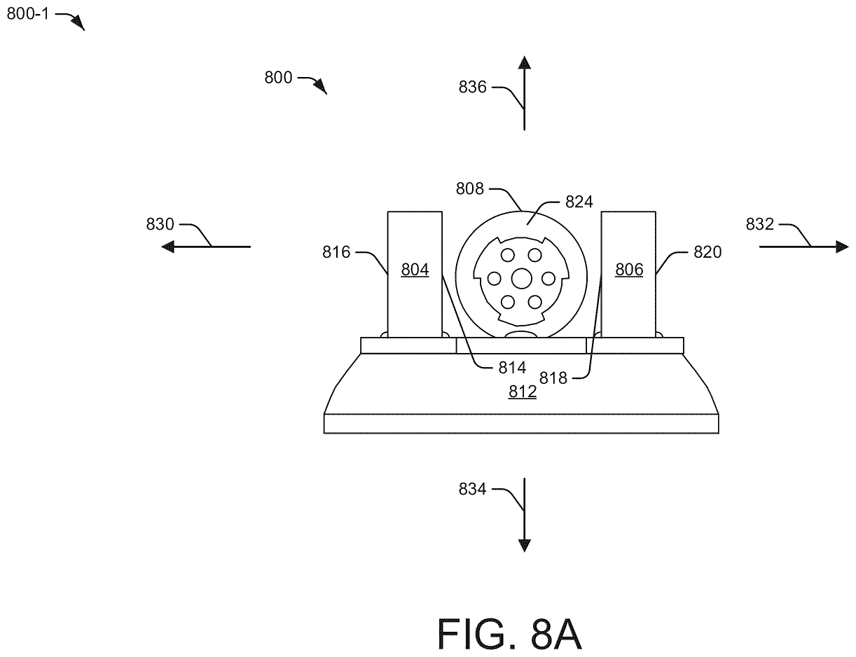

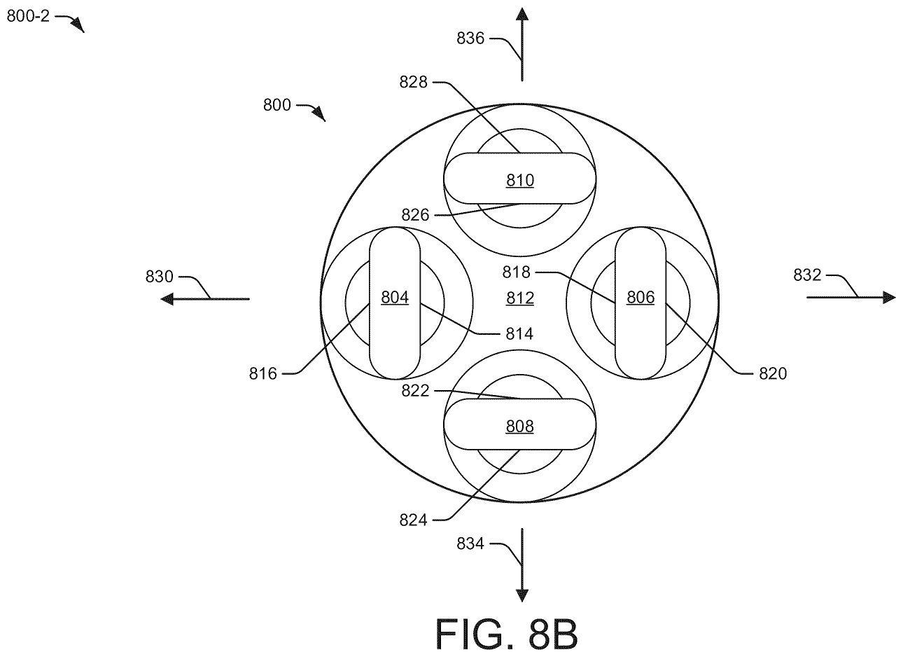

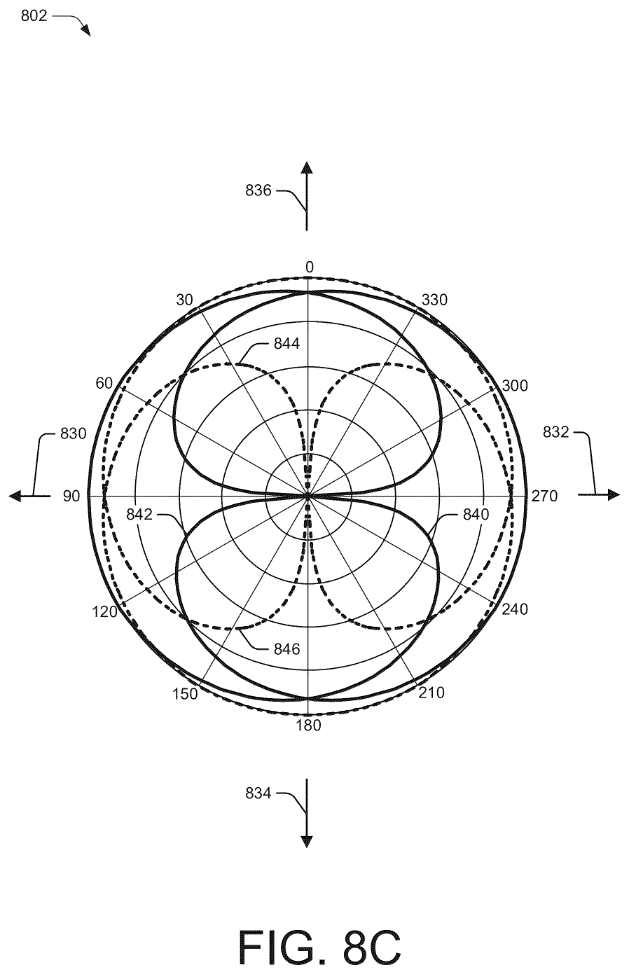

FIG. 8A illustrates a side view 800-1 of a microphone assembly 800 with two pairs of opposite facing cardioid microphone capsules and a base 812 according to one or more embodiments. FIG. 8B illustrates a plan view 800-2 of a microphone assembly 800 with two pairs of opposite facing cardioid microphone capsules according to one or more embodiments. Each pair of the two pairs of opposite facing cardioid microphone capsules is associated with an output channel of the microphone assembly 800. The first pair includes a first channel front cardioid microphone capsule 804 and a first channel back cardioid microphone capsule 806. The second pair includes a second channel left cardioid microphone capsule 808 and a second channel right cardioid microphone capsule 810.

As shown in FIG. 8A, the first channel front cardioid microphone capsule 804 includes a backside 814 and a front face 816. In some embodiments, the first channel front cardioid microphone capsule 804 is oriented to face in a first direction 830. The first channel back cardioid microphone capsule 806 includes a backside 818 and a front face 812, and the first channel back cardioid microphone capsule 806 is oriented to face in a second direction 832 that is opposite the first direction 830. As shown in FIG. 8B, the second channel left cardioid microphone capsule 808 includes a backside 822 and a front face 824. In one or more embodiments, the second channel left cardioid microphone capsule 808 is oriented to face in a third direction 834 which is perpendicular to the first direction 830 and the second direction 832. The second channel right cardioid microphone capsule 810 includes a backside 826 and a front face 828. In some examples, the second channel right cardioid microphone capsule 810 is oriented to face in a fourth direction 836 that is opposite the third direction 834.

FIG. 8C illustrates a representation 802 of polar patterns of two pairs of opposite facing cardioid microphone capsules according to one or more embodiments. The representation 802 includes a first cardioid polar pattern 840 corresponding the first channel front cardioid microphone capsule 804 and a second cardioid polar pattern 842 corresponding to the first channel back cardioid microphone capsule 806. The representation 802 also includes a third cardioid polar pattern 844 that corresponds to the second channel left cardioid microphone capsule 808 and a fourth cardioid polar pattern 846 that corresponds to the second channel right cardioid microphone capsule 810. The third and fourth cardioid polar patterns 844, 846 are illustrated in dashed lines to indicate that third and fourth cardioid polar patterns 844, 846 are output by the second channel of the microphone assembly 800. Similarly, the first and second cardioid polar patterns 840, 842 are illustrated in solid lines to indicate that first and second cardioid polar patterns 840, 842 are output by the first channel of the microphone assembly 800.

In some embodiments, by applying weights to (e.g., scaling) and/or inverting audio signals generated by the first channel front cardioid microphone capsule 804, the first channel back cardioid microphone capsule 806, the second channel left cardioid microphone capsule 808, and the second channel right cardioid microphone capsule 810 based on the first, second, third, and fourth cardioid polar patterns 840, 842, 844, 846, respectively, the weighted and/or inverted audio signals are combinable (e.g., summed) in a channel such that a desired polar pattern can be generated for the microphone assembly 800. An example of combining the audio signals generated by the first channel front cardioid microphone capsule 804, the first channel back cardioid microphone capsule 806, the second channel left cardioid microphone capsule 808, and the second channel right cardioid microphone capsule 810 in the first and second channels can include the following:

$$Microphone Assembly Polar Pattern 7 ( MAPP 7 ) = X * C 1 + Y * C 2 + Z * C 3 + W * C 4 ,$$

where: C1 represents the audio signal generated by the first channel front cardioid microphone capsule 804 based on the first cardioid polar pattern 840; C2 represents the audio signal generated by the first channel back cardioid microphone capsule 806 based on the second cardioid polar pattern 842; C3 represents the audio signal generated by the second channel left cardioid microphone capsule 808 based on the third cardioid polar pattern 844; C4 represents the audio signal generated by the second channel right cardioid microphone capsule 810 based on the fourth cardioid polar pattern 846; X represents a first weight; Y represents a second weight; Z represents a third weight; and W represents a fourth weight, where X, Y, Z, and W vary from −1.0 to 1.0. In some embodiments, the first weight X, the second weight Y, the third weight Z, and/or the fourth weight W can be less than zero or greater than zero.

In some embodiments, second order polar patterns such as the second order hypercardioid polar pattern 404 or the second order supercardioid polar pattern 406 can be generated by computing channel 1 out=X*C1+Y*C2 and channel 2out=Z*C3+W*C4. Once computed, channel 1 out is subtracted from channel 2out and channel 2out is subtracted from channel 1 out and X, Y, Z, and W are varied in order to form the second order polar patterns. In one or more embodiments, forming the second order polar patterns includes adding delays and/or phase shifting.

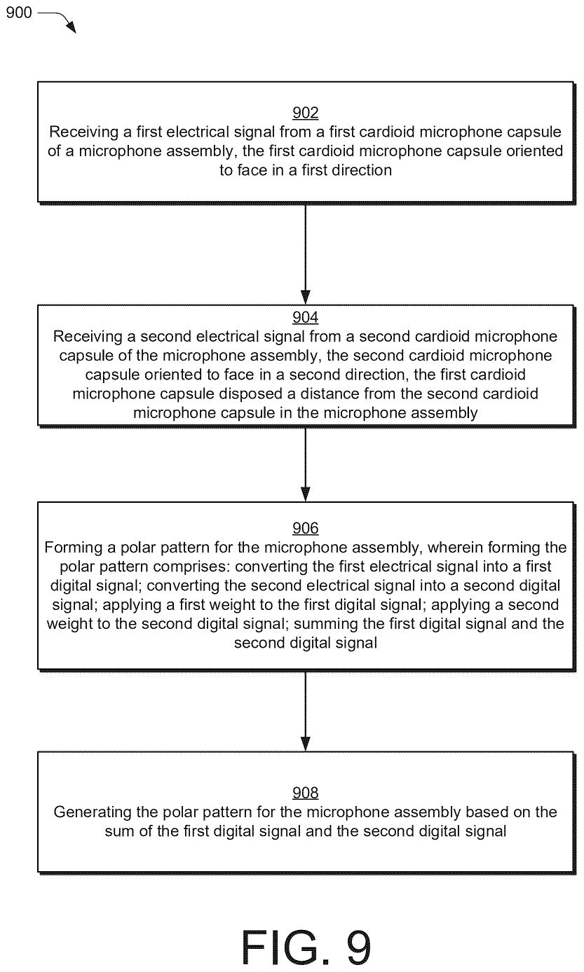

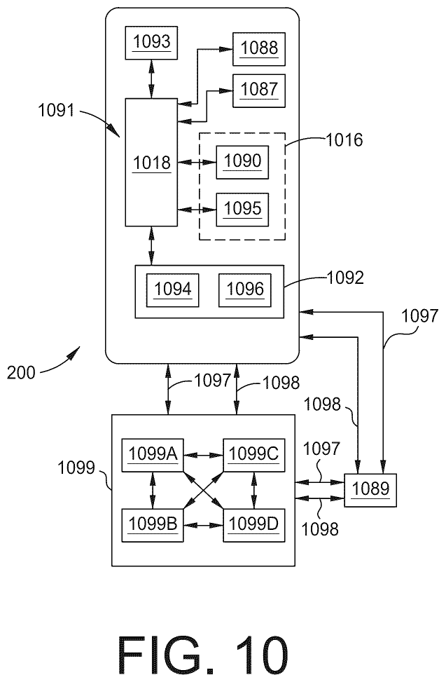

FIG. 9 is a process flow diagram illustrating a method 900 for generating a polar pattern for a microphone assembly according to one or more embodiments. FIG. 10 is a schematic diagram illustrating a microphone control system that includes a microphone assembly 1091 that is in communication with a passive audio device 1089. In some embodiments, the microphone control system can further include at least one of an external electronic device 1099 and the passive audio device 1089. While the discussion provided in relation to FIGS. 9 and 10 describes the performance of method 900 in conjunction with a type of microphone assembly, this microphone assembly configuration example, which includes two microphone capsules 1087 and 1088 that are oriented in a first configuration similar to the configuration shown in FIGS. 2A-2B, is not intended to be limiting as to the scope of the disclosure provided herein.

At operation 902 of method 900, a first electrical signal is received from a first cardioid microphone capsule of a microphone assembly, the first cardioid microphone capsule 1087 oriented to face in a first direction. In some embodiments, a first electrical signal is received from the first cardioid microphone capsules 204, 306, 408 as describing the first cardioid polar patterns 224, 332, 440, respectively.

At operation 904, a second electrical signal is received from a second cardioid microphone capsule 1088 of the microphone assembly, the second cardioid microphone capsule oriented to face in a second direction that is opposite the first direction, the first cardioid microphone capsule disposed a distance from the second cardioid microphone capsule in the microphone assembly. In one or more embodiments, the second electrical signal is received from the second cardioid microphone capsule 206 as describing the second cardioid polar pattern 226; received from the third cardioid microphone capsule 310 as describing the third cardioid polar pattern 336; and/or received from the fourth cardioid microphone capsule 414 as describing the fourth cardioid polar pattern 446.

At operation 906, a polar pattern is formed for the microphone assembly, wherein generating the polar pattern comprises: converting the first electrical signal into a first digital signal by use, for example, of an analog-to-digital converter (ADC); converting the second electrical signal into a second digital signal by use, for example, of an analog-to-digital converter (ADC); applying a first weight in a first range of −1.0 to +1.0 to the first digital signal; applying a second weight in a second range of −1.0 to +1.0 to the second digital signal; summing the first digital signal and the second digital signal. In some embodiments, first and second electrical signals are converted into the first and second digital signals in the codecs 250, 360, 470. As noted above, in one example, the conversion of the first and second electrical signals into the first and second digital signals is performed within the microphone assembly. In one or more embodiments, the first weight is applied to the first digital signal and the second weight is applied to the second digital signal in the microcontroller units 252, 362, 472. As noted above, in one example, the microcontroller units 252, 362, 472 are disposed within the microphone assembly. At operation 908, the polar pattern for the microphone assembly is generated based on the sum of the first digital signal and the second digital signal. The microphone control system of the microphone assembly receives inputs from the first cardioid microphone capsule 204 and from the second cardioid microphone capsule 206, and a passive audio device connected to the microphone assembly receives an output based on the received inputs.

As noted above, in one or more embodiments of the disclosure, a similar method, as described in method 900, can be used to selectively generate a desired polar pattern based on the configuration of the microphone assembly 200, 300, 400, 500, 600 or 700, selection of a desired interface element on a respective input device of the microphone assembly, and applying the requisite weights, signal processing, and summation techniques described in relation to the microphone control systems 200-3, 300-3, 400-3, 500-3, 600-3 or 700-3. The formed desired polar pattern can then be used by one or more external electronic devices.

In some alternate embodiments, operations 906 and 908 of method 900 are at least partially performed by use of processing capabilities provided by an external electronic device 1089 (FIG. 10). The external electronic device 1099 (FIG. 10) can include a device that is capable of performing computing functions, such as a personal computer (PC), laptop, tablet, personal digital assistant (PDA), video conferencing equipment, smartphone or other useful electronic device. In general, the electronic device 1089 can include a hardware unit or combination of hardware units capable of executing software applications and processing data including audio data. For example, a processor 1099A may be a central processing unit (CPU), a digital signal processor (DSP), an application-specific integrated circuit (ASIC), a combination of such units, or the like. The processor 1099A is configured to execute software applications 1099D, process audio data, and communicate with I/O devices 1099B among other operations. The I/O devices 1099B include devices capable of receiving input(s) and/or devices capable of providing one or more outputs, such as, for example, ADCs, PGAs, polar pattern levelers, digital inverters, digital adders, or other useful devices. The I/O devices 1099B may also include one or more wireless transceivers that are configured to establish one or more different types of wired or wireless communication links with other transceivers residing within the microphone assembly. The memory 1099C may be any technically feasible type of hardware unit configured to store data, such as a hard disk, a random access memory (RAM) module, a flash memory unit, or a combination of different hardware units configured to store data. Software application(s) 1099D within the memory 1099C may include program code (e.g., instructions) that may be executed by the processor in order to perform various functionalities and methods associated with the microphone assembly.

Referring to FIG. 10, a microphone assembly 1091 may include the processor 1018 that is coupled to input/output (I/O) devices 1016, a power source 1093, and the non-volatile memory unit 1092. Memory unit 1092 may include one or more software applications 1094, such as the controlling software program (i.e., algorithm). The memory unit 1092 may also include stored media data 1096 that is used by the processor 1018 to perform various parts of the methods described herein. The processor 1018 may be a hardware unit or combination of hardware units capable of executing software applications and processing data. In some configurations, the processor 1018 includes a central processing unit (CPU), a digital signal processor (DSP), an application-specific integrated circuit (ASIC), and/or a combination of such units. The processor 1018 is generally configured to execute the one or more software applications 1094 and process the stored media data 1096, which may be each included within the memory unit 1092. The I/O devices 1016 are coupled to memory unit 1092 and processor 1018, and may include devices capable of receiving input and/or devices capable of providing an output. The I/O devices 1016 can include one or more components within the codecs 250, 360, or 470 (e.g., ADCs, PGAs, etc.) and the microcontroller units 252, 362, or 472, which are discussed above. The I/O devices 1016 may also include one or more wireless transceivers 1090 that are configured to establish one or more different types of wired or wireless communication links with other transceivers residing within other computing devices (e.g., external electronic device 1099). A given transceiver within the I/O devices 1016 could establish, for example, a Wi-Fi communication link, near field communication (NFC) link or a Bluetooth® communication link (e.g., BTLE, Bluetooth classic), among other types of communication links with similar components in an external electronic device. In some embodiments, the I/O devices 1016 include at least one of an XLR communication link and a USB communication link, or both, that is used to communicate with various electrical components coupled to the microphone assembly 1091, such as a passive audio device 1089 and external electronic device 1099. In some embodiments, the microphone system 1091 is configured to output a processed audio signal in a digital format via a digital communication link 1098 (e.g., USB, wireless, etc.) and/or via an analog format over the XLR communication link 1097.

Referring back to FIG. 9, in one alternate embodiment of method 900, during operation 906, the process of generating the polar pattern includes converting the first electrical signal into a first digital signal by use of a first set of components (e.g., a first pair of items 254 and 256) within the microphone assembly and converting the second electrical signal into a second digital signal by use of a second set of components (e.g., a second pair of items 254 and 256) within the microphone assembly. Then providing the first and second digital signals to the external electronic device by use of a wired or wireless communication link. However, in some embodiments, during operation 906, the process of generating the polar pattern includes providing the first and second electrical signals to the external electronic device and then converting the first electrical signal into a first digital signal by use of a first set of components (e.g., PGAs and ADCs) within the external electronic device and converting the second electrical signal into a second digital signal by use of a second set of components (e.g., PGAs and ADCs) within the external electronic device. Then, during operation 906, by use of the processing capabilities provided by the external electronic device a first weight in a first range of −1.0 to +1.0 is applied to the first digital signal and a second weight in a second range of −1.0 to +1.0 is applied to the second digital signal, and then the processor in the external electronic device sums the weighted first digital signal and the weighted second digital signal. In some embodiments, first and second electrical signals are converted into the first and second digital signals in codecs 250, 360, 470 within the microphone. In one or more embodiments, the first weight is applied to the first digital signal and the second weight is applied to the second digital signal in the external electronic device.

In the alternate embodiment of method 900, at operation 908, the polar pattern for the microphone assembly is generated based on the sum of the first digital signal and the second digital signal generated by use of the external electronic device. A microphone control system formed by the combination of the external electronic device 1099 and the microphone assembly 1091 utilizes the inputs received from the first cardioid microphone capsule 1087 and from the second cardioid microphone capsule 1088 to generate an output that is provided to a passive audio device 1089 connected to the microphone assembly 1091, connected to the external electronic device 1099, or disposed within the external device (not shown).

Referring back to FIGS. 2A-2B, 3A-3B, 4A-4B, 5A-5B, 6A-6B, 7A-7B, and 8A-8B, in some embodiments, each of the microphone assemblies include one or more support elements that are configured to support and retain the microphone capsules in the desired configuration, orientation, and alignment relative to each other and are coupled to a portion of the base as described above in relation to these figures. The support element is positioned between the microphone capsules and the base, and can be used to structurally isolate the microphone capsules from the base. The support element can include a supporting pocket that includes a support portion that is configured to at least partially surround and capture the outer edge of the microphone capsules. The support element can be formed from a polymer material, such as silicone rubber material that has a durometer of between about 20 and 60 on a Shore A scale, such as between about 20 and 30 on a Shore A scale.

In some aspects, a method includes: receiving a first electrical signal from a first cardioid microphone capsule of a microphone assembly; the first cardioid microphone capsule oriented to face in a first direction; receiving a second electrical signal from a second cardioid microphone capsule of the microphone assembly, the second cardioid microphone capsule oriented to face in a second direction that is opposite the first direction; and generating, within the microphone assembly, a polar pattern, wherein generating the polar pattern includes: converting the first electrical signal into a first digital signal; converting the second electrical signal into a second digital signal; applying a first weight to the first digital signal to form a first weighted signal; applying a second weight to the second digital signal to form a second weighted signal; and summing the first weighted signal and the second weighted signal to form the polar pattern.

In some aspects, a microphone control system includes: a codec of a microphone assembly, wherein the codec is configured to: receive a first input audio signal from a first cardioid microphone capsule of the microphone assembly oriented to face in a first direction; convert the first input audio signal into a first digital signal; receive a second input audio signal from a second cardioid microphone capsule of the microphone assembly oriented to face in a second direction that is opposite the first direction; and convert the second input audio signal into a second digital signal; and a microcontroller unit (MCU) of the microphone assembly, wherein the MCU is configured to: receive the first digital signal; receive the second digital signal; receive a user input specifying a characteristic of a polar pattern for a microphone; modify at least one of the first digital signal or the second digital signal based on the characteristic; and generate the polar pattern for the microphone as having the characteristic.

In some aspects, a microphone assembly includes: a first microphone capsule oriented to face in a first direction within a first plane and configured to generate a first audio signal; a second microphone capsule oriented to face in a second direction that is opposite the first direction in a second plane and configured to generate a second audio signal; a third microphone capsule oriented to face in the first direction within the first plane and configured to generate a third audio signal; and a microphone control system configured to generate multiple polar patterns for the microphone assembly based on at least one of the first audio signal, the second audio signal, or the third audio signal.

In some aspects, a method includes: receiving a first input audio signal from a first microphone capsule oriented to face in a first direction; receiving a second input audio signal from a second microphone capsule oriented to face in a second direction that is opposite the first direction; receiving a third input audio signal from a third microphone capsule oriented to face in the first direction; receiving a user input specifying a characteristic of a polar pattern for a microphone; modifying the first input audio signal based on the characteristic; combining first input audio signal with at least one of the second input audio signal or the third input audio signal as a combined audio signal; and generating the polar pattern for the microphone having the characteristic based on the combined audio signal.

In some aspects, a microphone assembly includes: a first microphone capsule disposed in a first plane and oriented to face in a first direction; a second microphone capsule disposed in the first plane and oriented to face in the first direction; a third microphone capsule disposed in a second plane and oriented to face in a second direction that is opposite the first direction; a fourth microphone capsule disposed in the second plane and oriented to face in the second direction; and a microphone control system configured to: receive input audio signals from the first, second, third, and fourth microphone capsules; and vary a polar pattern of a microphone by weighting and summing the input audio signals from the first, second, third, and fourth microphone capsules.

In some aspects, a method includes: receiving a first input audio signal from a first microphone capsule oriented to face in a first direction; receiving a second input audio signal from a second microphone capsule oriented to face in the first direction; receiving a third input audio signal from a third microphone capsule oriented to face in a second direction that is opposite the first direction; receiving a fourth input audio signal from a fourth microphone capsule oriented to face in the second direction; weighting the third and fourth input audio signals with a negative fractional weight; and generating a polar pattern for a microphone by combining the first, second, third, and fourth input audio signals.

In some aspects, a microphone assembly includes: an omnidirectional microphone capsule disposed in a plane and oriented to face in a direction, the first microphone capsule configured to generate a first audio signal based on an omnidirectional polar pattern; a figure eight microphone capsule disposed in the plane and oriented to face in the direction, the second microphone capsule configured to generate a second audio signal based on a figure eight polar pattern; and a microphone control system configured to: receive the first audio signal; receive the second audio signal; and generate a cardioid polar pattern for a microphone by combining the first audio signal and the second audio signal.

In some aspects, a method includes: receiving a first audio signal captured using an omnidirectional polar pattern; receiving a second audio signal captured using a figure eight polar pattern; applying a weight to the first audio signal to generate a weighted first audio signal; applying the weight to the second audio signal to generate a weighted second audio signal; and generating a cardioid polar pattern for a microphone by summing the weighed first audio signal and the weighted second audio signal.

In some aspects, a microphone assembly includes: a first microphone capsule disposed in a first plane and oriented to face in a first direction, the first microphone capsule configured to generate a first audio signal based on a first type of polar pattern; a second microphone capsule disposed in the first plane and oriented to face in the first direction, the second microphone capsule configured to generate a second audio signal based on a second type of polar pattern; a third microphone capsule disposed in a second plane an oriented to face in a second direction that is perpendicular to the first direction, the third microphone capsule configured to generate a third audio signal based on the first type of polar pattern; and a microphone control system configured to: receive the first, second, and third audio signals; and generate a polar pattern for a stereo microphone by combining the first, second, and third audio signals.

In some aspects, a method includes: generating a first weighted audio signal by applying a first weight to a first audio signal captured using a first type of polar pattern; generating a second weighted audio signal by applying the first weight to a second audio signal captured using a second type of polar pattern; generating a third weighted audio signal by applying a second weight to a third audio signal captured using the first type of polar pattern; and generating a third type of polar pattern for a stereo microphone by combining the first, second, and third weighted audio signals.

In some aspects, a microphone assembly includes: a first microphone capsule disposed in a first plane and oriented in a first direction, the first microphone capsule configured to generate a first audio signal based on a first type of polar pattern; a second microphone capsule disposed in the first plane and oriented in the first direction, the second microphone capsule configured to generate a second audio signal based on a second type of polar pattern; a third microphone capsule disposed in a second plane and oriented in a second direction, the third microphone capsule configured to generate a third audio signal based on the first type of polar pattern; a fourth microphone capsule disposed in the second plane and oriented in the second direction, the fourth microphone capsule configured to generate a fourth audio signal based on the first type of polar pattern; and a microphone control system configured to generate a third type of polar pattern for a stereo microphone by combining the first, second, third, and fourth audio signals.

In some aspects, a method includes: receiving a first audio signal captured using a first omnidirectional microphone capsule; receiving a second audio signal captured using a first figure eight microphone capsule; receiving a third audio signal captured using a second omnidirectional microphone capsule; receiving a fourth audio signal captured using a second figure eight microphone capsule; and generating a polar pattern for a stereo microphone by combining the first, second, third, and fourth audio signals.

While the foregoing is directed to embodiments of the present disclosure, other and further embodiments of the disclosure may be devised without departing from the basic scope thereof, and the scope thereof is determined by the claims that follow.

What is claimed is:

1. A method comprising:
receiving a first electrical signal from a first cardioid microphone capsule of a microphone assembly, the first cardioid microphone capsule oriented to face in a first direction;
receiving a second electrical signal from a second cardioid microphone capsule of the microphone assembly, the second cardioid microphone capsule oriented to face in a second direction;
converting the first electrical signal into a first audio signal;
converting the second electrical signal into a second audio signal; and
generating, by use of an external electronic device, a polar pattern, wherein generating the polar pattern comprises:
applying a first weight to the first audio signal to form a first weighted signal;
applying a second weight to the second audio signal to form a second weighted signal; and
summing the first weighted signal and the second weighted signal to form the polar pattern.

2. The method of claim 1, wherein
the converting the first electrical signal into the first audio signal and the converting the second electrical signal into the second audio signal is performed by one or more electrical components within the microphone assembly,
the first audio signal comprises a first digital signal, and
the second audio signal comprises the second digital signal.

3. The method of claim 1, wherein
the converting the first electrical signal into the first audio signal and the converting the second electrical signal into the second audio signal is performed by one or more electrical components within the external electronic device,
the first audio signal comprises a first digital signal, and
the second audio signal comprises a second digital signal.

4. The method of claim 1, wherein the polar pattern includes at least one of an omnidirectional polar pattern, a cardioid polar pattern, a supercardioid polar pattern, a hypercardioid polar pattern, or a figure eight polar pattern.

5. The method of claim 1, wherein the first weight and the second weight are within a range of −1.0 to +1.0.

6. The method of claim 1, wherein the first weight and the second weight are less than zero or greater than zero.

7. The method of claim 1, further comprising:
receiving a third electrical signal from a third cardioid microphone capsule of the microphone assembly; and
converting the third electrical signal into a third audio signal,
wherein generating the polar pattern comprises:
applying a third weight to the third audio signal to form a third weighted signal, and
the summing of the first weighted signal and the second weighted signal further comprises summing the first weighted signal, the second weighted signal, and the third weighted signal, and
the generated polar pattern is based on the sum of the first weighted signal, the second weighted signal, and the third weighted signal.

8. The method of claim 7, further comprising:
receiving a fourth electrical signal from a fourth cardioid microphone capsule of the microphone assembly, wherein the polar pattern is generated based on the first electrical signal, the second electrical signal, the third electrical signal, and the fourth electrical signal.

9. The method of claim 1, wherein the first electrical signal is converted into the first audio signal in a codec of the microphone assembly.

10. The method of claim 9, wherein the first weight is applied to the first audio signal in a microcontroller unit of the microphone assembly.

11. The method of claim 1, wherein the polar pattern for the microphone assembly is formed based on a user input received relative to an input device.

12. A microphone system, comprising:
a first microphone capsule of a microphone assembly configured to generate a first electrical signal;
a second microphone capsule of the microphone assembly configured to generate a second electrical signal; and
a microphone control system that is configured to generate one or more polar patterns based on at least one of the first electrical signal or the second electrical signal,
wherein
a first portion of the microphone control system comprises one or more analog-to-digital converters (ADCs) disposed within the microphone assembly, wherein the one or more ADCs are configured to generate a first audio signal based on the first electrical signal and a second audio signal based on the second electrical signal; and
a second portion of the microphone control system comprises one or more components of an external electronic device configured to digitally add the first and second audio signals to generate the one or more polar patterns.

13. The microphone system of claim 12, wherein the first and second microphone capsules are cardioid microphone capsules.

14. The microphone system of claim 13, wherein
the first microphone capsule oriented to face in a first direction, and
the second microphone capsule is oriented to face in a second direction that is opposite the first direction.

15. The microphone system of claim 12, wherein the first portion of the microphone control system comprises one or more programmable-gain-amplifiers (PGAs) that are configured to receive the first electrical signal from the first microphone capsule or the second electrical signal from the second microphone capsule.

16. The microphone system of claim 15, wherein the first and second microphone capsules are cardioid microphone capsules.

17. The microphone system of claim 12, wherein the one or more polar patterns include at least one of an omnidirectional polar pattern, a cardioid polar pattern, a supercardioid polar pattern, a hypercardioid polar pattern, a figure eight polar pattern, or a second order cardioid polar pattern.

18. The microphone system of claim 12, wherein the second portion of the microphone control system is configured to apply a first weight in a first range of −1.0 to +1.0 to the first audio signal and apply a second weight in a second range of −1.0 to +1.0 to the second audio signal before digitally adding the first and second audio signals used to generate the one or more polar patterns.

19. A microphone system, comprising:
a first cardioid microphone capsule of a microphone assembly, wherein the first microphone capsule is oriented to face in a first direction and configured to generate a first electrical signal;
a second cardioid microphone capsule oriented to face in a second direction and is configured to generate a second electrical signal;
a third cardioid microphone capsule oriented to face in a third direction and is configured to generate a third electrical signal; and
a microphone control system that is configured to generate one or more polar patterns based on at least one of the first electrical signal, the second electrical signal, and the third electrical signal,
wherein
a first portion of the microphone control system comprises one or more analog-to-digital converters (ADCs) disposed within a microphone assembly, wherein the one or more ADCs are configured to generate a first audio signal based on the first electrical signal, a second audio signal based on the second electrical signal, and a third audio signal based on the third electrical signal; and
a second portion of the microphone control system comprises one or more components of an external electronic device configured to digitally add the first, second, and third audio signals to generate the one or more polar patterns.

20. The microphone system of claim 19, wherein the second portion of the microphone control system is configured to
apply a first weight in a first range of −1.0 to +1.0 to the first audio signal,
apply a second weight in a second range of −1.0 to +1.0 to the second audio signal, and
apply a third weight in a third range of −1.0 to +1.0 to the third audio signal,
wherein applying the first, second and third weights is performed before digitally adding the first, second, and third audio signals used to generate the one or more polar patterns.
